(19) United States
(12) Patent Application Publication
(10) Pub. No.: US 2021/0269244 A1
(43) Pub. Date: Sep. 2, 2021

(54) AUTOMATED WAREHOUSE SYSTEM AND METHOD FOR OPTIMIZED BATCH PICKING

(71) Applicant: Robert D. Ahmann, Rochester, MN (US)

(72) Inventor: Robert D. Ahmann, Rochester, MN (US)

(21) Appl. No.: 17/255,755

(22) PCT Filed: Jun. 25, 2019
(86) PCT No.: PCT/US2019/039087

§ 371 Date: Dec. 23, 2020

Related U.S. Application Data
(60) Provisional application No. 62/812,250, filed on Feb. 28, 2019.
(60) Provisional application No. 62/689,829, filed on Jun. 25, 2018.

(51) Int. Cl. B65G 1/137; G05B 19/042; B65G 1/04

(52) U.S. Cl. CPC B65G 1/1378; G05B 19/042; B65G 2209/02; B65G 1/0492; G05B 2219/2669; B65G 1/1371

(57) ABSTRACT

A computerized system and method use optimization after aggregation of orders over a Batch Window period of time to increase Pick Performance in the Fulfillment Center Automation (FCA) system that automates taking the picker to the goods; or an Automated Warehouse System (AWS) that automates the presentation of goods to a stationary picker. Batch Optimization improves pick performance for the FCA or AWS; using a closed-form algorithm, combinatorial optimization, or OOP to perform Batch Optimization, adapting to Picker Performance by automatically shifting certain orders to different aisles while stocking the same SKU items in multiple aisles. Programmable Capacity is optionally provided to allow the Fulfillment Center to easily adapt to varying order loads. Some embodiments selectively place orders into selected batches to maximize multi-picks of identical-SKU items at one time and maximize chain-picks of different-SKU items in sequential picks at one pick window.

### CROSS-REFERENCE TO RELATED APPLICATIONS

This application is related to

U.S. Provisional Patent Application No. 62/405,219, filed Oct. 6, 2016 by Robert D. Ahmann, titled “Automated warehouse fulfillment operations and system,”
U.S. patent application Ser. No. 16/339,471 filed Apr. 4, 2019 and titled “Automated warehouse fulfillment system and method of operation” and PCT Publication No. WO 2018/068024A1 by Ahmann et al., published Apr. 12, 2018 and titled “Automated warehouse fulfillment operations and system,”
U.S. patent application Ser. No. 16/339,473 filed Apr. 4, 2019 and titled “Automated warehouse fulfillment system and method of operation” and PCT Publication No. WO 2018/068026A1 by Ahmann et al., published Apr. 12, 2018 and titled “Automated warehouse fulfillment system and method of operation,”
U.S. Provisional Patent Application No. 62/689,829, filed Jun. 25, 2018 by Robert D. Ahmann titled “Optimized Batch Picking for Automated Warehouse Systems,” of which this application claims priority benefit, including under 35 U.S.C. § 119(e), and
U.S. Provisional Patent Application No. 62/812,250, filed Feb. 28, 2019 by Robert D. Ahmann titled “Extension of Optimized Batch Picking for Automated Warehouse Systems,” of which this application claims priority benefit, including under 35 U.S.C. § 119(e), each of which is incorporated herein by reference in its entirety.

In some embodiments, the present invention uses a combination of some or all features of these last two Provisional Applications 62/689,829 and 62/812,250. As such, the First and the Second Parts of the Invention described below share many common features. Therefore, their Field, Background, Definitions, Drawings and Conclusions will be shared while their individual Invention Summaries and Invention Descriptions will be addressed separately and be referred to as the First and Second Parts of the Invention, respectively. For any need to reference the applications listed above, an overview is shown in FIG. 10B and described in Section 5 of the Description of First Part of the Invention.

### FIELD OF THE INVENTION

The present inventions relate generally to warehouse automation, and more particularly to a computerized system, and associated computerized method, and computer-readable media having instructions thereon for optimization of “Picker-to-Goods” Order fulfilment and parts replenishment that includes conveying totes in horizontal and vertical directions to a picker on a moving cart, and Order Batching to optimize throughput of the system.

### COPYRIGHT NOTICE/PERMISSION

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings attached hereto: Copyright® 2016-2019, Robert D. Ahmann, All Rights Reserved.

### BACKGROUND OF THE INVENTION

Fulfillment of Orders for goods by customers using the internet has become a very important and cost-competitive business threatening the traditional retail space. This dramatic shift was initiated with the formation of Amazon Inc. in the 1990's. eCommerce as it has come to be known appears to be establishing itself as the primary mechanism for selling goods.

As a result, the cost associated to fulfill an Order has become a primary focus of companies practicing eCommerce from their Fulfillment Centers. The typical largest cost associated with these Fulfillment Centers is generally the cost of Order picking, essentially gathering the goods that comprise an Order. Historically, that cost can exceed 50% of the operational costs of the Fulfillment Centers.

That caused the company Amazon in 2012 to acquire the company Kiva for a sum of $775M, likely a price exceeding 20 times revenue. Their solution was a plurality of small robots that retrieve/present/return small storage towers to the Picker (i.e., a human who picks an item from the storage tower and places the item into a container that holds one or more items for a customer's Order). This intellectual property acquisition excluded that technology from all of Amazon's other competitors.

This caused the remainder of the growing industry to pursue other Automated Warehouse Systems (AWS's) in their efforts to reduce costs. Most current commercialized automated solutions (including Kiva), focus on automating the presentation of goods to a stationary Picker. Exceptions include the Fulfillment Center Automation (FCA) system described in U.S. patent application Ser. Nos. 16/339,471 and 16/339,473, which automates taking the Picker to the goods (so-called “Picker-to-Goods” systems).

The FCA system, when combined with the software, associated hardware, and processes described for the present invention, set a new (higher) level of potential performance in the industry. Today, the accepted prolonged level of performance for conventional AWS's is between 400 and 600 Picks per Hour (PPH). This document will demonstrate substantial improvements that are available for the FCA and other AWS's employing the Batch Optimization algorithm of the present invention.

Besides U.S. patent application Ser. Nos. 16/339,471 and 16/339,473 by Ahmann et al. listed above, other patents which describe background technology usable by the present invention include the following:

U.S. Pat. No. 3,351,219 to Ruderfer issued with the title “Warehousing order selection system” and is incorporated herein by reference. U.S. Pat. No. 3,351,219 describes a selective order selection system for removing individual articles from a pallet-type unit load, in which the actual condition of articles remaining at the desired unit load is sensed and a picker means is actuated to individually remove the next article. A warehousing system employing this system is described.

U.S. Pat. No. 6,602,037 to Winkler issued Aug. 5, 2003 with the title “System for picking articles situated in rack storage units” and is incorporated herein by reference. U.S. Pat. No. 6,602,037 describes a system for picking articles situated in a rack storage unit, which includes a plurality of parallel rack rows for the storage of articles situated on retrieval pallets and/or in containers, storage aisles and picking aisles formed alternately between the rack row, at least one storage vehicle in each storage aisle, which vehicle is designed to accommodate at least one retrieval pallet and/or container and is capable of travelling along each storage aisle to place the retrieval pallets and/or containers into storage in the pallet racks, at least one picker vehicle in each picking aisle for picking the articles to be picked, which is capable of travelling along in each case one of the two mutually opposing picking fronts forming the picking aisle, buffer locations, which are disposed in the picking aisles between the routes of the picker vehicles travelling along the two opposing picking fronts, for the intermediate storage and/or transfer of the pick articles from a picker vehicle at one side of the picking aisle to a picker vehicle at the other side of the picking aisle, and a system controller comprising a control computer. Besides the storage and retrieval of pallets, the system also allows the storage and retrieval of containers for smaller articles.

U.S. Pat. No. 8,718,815 to Shimamura issued on May 6, 2014 with the title “Automated warehouse system” (AWS), and is incorporated herein by reference. U.S. Pat. No. 8,718,815 describes an automated warehouse system asserted to have an improved cycle efficiency of storing and retrieving articles to and from the automated warehouse system includes a storage station, a retrieval station, a plurality of article storage shelves, a stacker crane, and a system controller. An article is brought to the storage station to be stored and retrieved from the retrieval station. The article storage shelves store articles. The stacker crane can move an article between the storage station, the retrieval station, and the article storage shelves. The system controller keeps track of the amount of storage time articles have been stored and, when it determines that an article has been stored on an article storage shelf in a buffer area for a first predetermined amount of time or longer, the system controller controls the stacker crane such that the stacker crane carries the article from an article storage shelf in the buffer area to an article storage shelf in the first storage area.

U.S. Pat. No. 8,790,061 to Yamashita issued Jan. 13, 2011 with the title “Transferring shuttle for three dimensional automated warehouse” and is incorporated herein by reference. U.S. Pat. No. 8,790,061 describes a transferring shuttle, which transfers package(s) between a pair of layered stacked racks in a three dimensional automated warehouse, includes a mobile platform which runs between the stacked racks; elastic mechanisms, which include telescoping rails that extend into the stacked racks and surround a package; and terminal fingers placed at the ends of the rails, which can move between an extended position, which allows the package to be engaged and a contracted position. The rails also contain inner fingers between the terminal fingers. The inner fingers can push the package further into the stacked rack than previously possible.

U.S. Pat. No. 9,950,863 to O'Brien, et al. issued on Apr. 24, 2018 with the title “Automated order fulfillment system and method,” and is incorporated herein by reference. U.S. Pat. No. 8,790,061 describes an automated order fulfillment system and automated method for fulfilling orders includes a donor-handling system having at least two donor buffers and a recipient-handling system having at least one recipient buffer. An item-handling system includes a vision system and an item manipulator. The vision system has a field of view encompassing the at least two donor receptacle buffers. A control causes the vision system to scan items in a donor receptacle at one of the donor buffers to obtain a pick list of location data of items in the scanned donor receptacle. The control causes the manipulator to pick an item from a donor receptacle at the other of the donor buffers under guidance of the vision system and place the picked item to a recipient receptacle at the at least one recipient buffer using the location data of items in that donor receptacle.

PCT Patent Application Publications WO2008085638 and WO2010110981 describe various aspects of a Kiva-type AWS, and are each incorporated herein by reference.

PCT Patent Application Publication WO2008085638, and U.S. Pat. No. 8,311,902 which issued to Mountz et al. on Nov. 13, 2012 with the title “System and method for filling an order” and which is incorporated herein by reference, each describe a method for fulfilling inventory requests that includes receiving an inventory request requesting an inventory item and selecting the requested inventory item from an inventory holder. The method further includes storing the requested inventory item in an order holder associated with the inventory request and moving the order holder to a storage space. In addition, the method includes detecting a triggering event and in response to detecting the triggering event, retrieving the order holder from the storage space.

PCT Patent Application Publication WO2010110981, and U.S. Pat. No. 8,483,869 which issued to Wurman et al. on Jul. 9, 2013 with the title “Method and system for fulfilling requests in an inventory system” and is incorporated herein by reference, each describe a method for fulfilling requests in an inventory system that includes receiving a request indicating an activity to be completed. The method also includes selecting a holder to fulfill the request and an inventory station at which to fulfill the request. The inventory station is associated with a queue that includes a plurality of queue spaces. The method further includes moving the selected holder from a first location to a second location remote from the selected inventory station. Additionally, the method also includes determining that a trigger event has occurred and, in response to determining that the trigger event has occurred, moving the selected holder from the second location to a queue space of a queue associated with the selected inventory station.

There remains a need for improved systems for inventory management and movement.

### DEFINITIONS USED IN THIS APPLICATION

Aisle—The space between two storage racks in which the picker operates. Two Aisle faces are exposed to the picker when the picker is within an Aisle.

Automated Guided Vehicles (AGV's)—Robotic driverless vehicles that can follow prescribed paths within a warehouse carrying goods from one point to another.

Automated Warehouse Systems (AWS's)—Mechanized systems used to increase the Pick Rate and the accuracy with which orders are fulfilled within a Fulfillment Center above and beyond which a manual operation can provide. These are currently in general Goods-to-Picker systems.

Batch—A group of Orders collected into one or more Totes and sent to Shipping where the Items from the Totes are segregated from the Totes and then aggregated back into individual Orders.

Batch Optimization—The assignment of the right Orders to the right Batches and the Orders' SKU's to the right Tote within the Batch to maximize Multi-Picks and Chain Picks.

Batch Window—The period of time Orders are aggregated to provide the plurality of Orders used to populate the optimized batches which constitute the basis of these patent claims.

Bin—Container that resides on the shelves within a warehouse Aisle. It contains individual SKU's available to be utilized by the Picker to fulfill individual orders. Some Bins contain only one SKU type while others may contain numerous types. Bins may be open faced to allow picking without withdrawing the container from the shelf.

Bin Data—Data managed by the FCA that identifies what SKU is associated with each Bin location. Bin Data includes the quantity of each SKU at each Bin location. In some embodiments, Bin Data also includes the Aisle, the Aisle face, Bin type, and the X, Z coordinates of the Bin within the Aisle face, with (0, 0), in some embodiments, being the bottom corner of the Aisle face nearest the Tote Storage.

Bin Wall—A collection of small cubicles (also called order-aggregation compartments or Bins (unrelated to those Bins in an Aisle)) where an order-aggregation operator (e.g., in some embodiments, a human operator) can segregate the multi-pick, chain pick, and ordinary pick SKU Items which are presented to the order-aggregation operator in a Tote or Totes and aggregate those SKU Items into their respective Orders. This segregation/aggregation process is generally accomplished with a bar-code scanner and the associated software that directs the order-aggregation operator which order-aggregation compartments the SKU Items should be placed into to ultimately constitute individual Orders, ready to ship. Bin Walls are also referred to as “Put Walls” commercially, such as described in U.S. Pat. No. 9,950,863. Herein, such a Bin Wall is also called an “order-aggregation” structure.”

Chain Pick—When multiple picks are performed one after another with no interruption to place the ensuing Items into the Tote accumulating the current Batch. This results from SKU's located in a common Pick Window being assigned to the same Tote.

Combinatorial Optimization (CO)—A Combinatorial Optimization problem is an optimization problem, where an optimal solution must be identified from a finite set of solutions. The solutions are normally discrete or can be formed into discrete. This is an important topic studied in operations research, software engineering, artificial intelligence, machine learning, and so on.

Conveyor—A common piece of mechanical material-handling equipment that moves materials from one location to another in an automated manner generally along some type of track.

Dynamic Slotting—The periodic planned movement of SKU placement locations in the Shelving Units to keep the overall placement optimized. This is monitored real time.

FCA (Fulfillment Center Automation (FCA) system)—The term FCA is used to refer to the Fulfillment Center Automation in its entirety (i.e., including all physical hardware) which is a newly invented automated Picker-to-Goods Automated Warehouse System.

FCA Control Software—Refers to the system that downloads Orders from the WMS, schedules fulfillment, tracks local Bin data & Tote data, keeps the WMS updated, and performs the optimization that is the basis of this invention. It also essentially acts as the communications hub between the PLC's, FCA database, and WMS.

Fulfillment Center—A distribution warehouse where orders are prepared for shipping to a customer.

Item—A single unit/piece of a given SKU.

Kiva—One type of a Goods-to-Picker AWS where small AGV's cycle small Shelving Units between their storage locations and a Picker presenting them in a sequence that allows the Picker to complete a Pick List. Refer to U.S. Pat. Nos. 8,483,869 and 8,311,902 for more detail.

Line Item—Every product on the order is referenced by a record that includes a SKU Identifier, a quantity and a reference to which order it belongs. This record is known as a Line Item.

Line Laser—A laser that displays an accurately horizontal or vertical illuminated line on a surface the Line Laser is laid against.

Linear Actuator—A mechanical device that converts energy (power from air, electricity or liquid) to create motion in a straight line.

Mini-ASRS (Automated Storage & Retrieval System)—Tote storage device that utilizes a gantry crane and load handling device to be able to automatically store and retrieve Totes from shelves.

Multi-Pick—When multiple Line Items of the same SKU from different Orders are picked at the same time to improve the Pick Rate.

Multi-Shuttle—One type of a Goods-to-Picker AWS where small automated carriages reside in a high precision Shelving Units allowing them to move both horizontally and vertically within the structure retrieving and restoring SKU Items for a Picker residing at the end of the Shelving Units. Refer to U.S. Pat. No. 8,790,061 for more detail.

OOP—Acronym for Object-Oriented Programming. It is a programming language model organized around objects rather than “actions” and data rather than logic.

Order—A Fulfillment Center customer generally creates an Order online to purchase Items from that company in exchange for payment. The WMS then breaks the Order into one or more Shipments. Either Orders or Shipments can be downloaded to the FCA dependent on the WMS.

OrderSKU—A concatenation of two pieces of information, the Order # and every SKU Identifier # within that Order. It provides the primary key (unique record identifier) for the Order information provided by the WMS to the Batch Optimization algorithm.

PAV—Picker Automated Vehicle—Picker ‘cab’ and its associated drive mechanism that transports and positions the operator within an Aisle.

Pick Action—All the various movements required to successfully perform a Pick. In a manual system that could entail the time required to walk from one Pick location to another. In more automated systems, that time is reduced. The reduction of this time is the goal of all Fulfillment Centers.

Pick Face—All the Shelving Units and their Bins constituting one side of a warehouse Aisle.

Pick List—A plurality of Pick Requests that constitute all the picks a Picker must perform during a Segment of a Batch Window.

Pick Rate/Performance—The average time required for a Picker to complete a single pick in a sequential series of continuous picks. This sequential series needs to be able to be replicated over a given time period such that the Pick Rate can be sustained. The Pick Rate then establishes the overall Pick Performance in Picks Per Hour ((PPH).

Pick Request—A request that specifies a number of Items of a particular SKU that are to be picked for a shipment.

Pick Station—A construct utilized in a Kiva type AWS consisting of the Picker, holders for Totes, a receiving area for the small AGV's holding the small Shelving Units, and miscellaneous hardware like bar code scanners required in the Pick implementation.

Pick Window—Segmentation of a Pick Face into smaller individual areas, each containing their own respective Bins. The size of a Pick Window corresponds to an area of the Pick Face serviceable by the Picker Platform in a static position.

Picker—Individual that retrieves items from storage locations to fulfill orders received by the Fulfillment Center.

Picker Platform—Platform on the PAV where the Picker resides. It can be extended vertically or moved horizontally by the PAV to give the Picker access to any storage location in a warehouse Aisle.

Prime Area—The central part of the Pick Face that contains the SKU's that account for approximately 90% of the Line Items in all Orders (24 of 108 Pick Windows).

Replenishment—The act of moving stock to the pick areas upon request from the WMS to restore the SKU reserves within the Shelving Units.

Segment—A portion of a Batch Window consisting of a group of Batches. The number and nature of those Batches is defined by the software described in these patent claims, the storage available to store totes, and the capacities of the available Bin Walls.

Segment Totes—These are the group of Totes that are used within a single Aisle while Orders are being fulfilled within that Aisle during a single Segment. Each Tote is generally assigned to a different Batch with a Batch spanning multiple Aisles.

Sequence—The process of placing Totes in the correct order for presentation to the Picker such that the Pick List can be performed accurately.

Shelving Unit—An assembly consisting of framework and shelves extending from the floor to the full rack height. Shelving units are placed side by side to form an Aisle face.

Shipment—One or more Pick Items that are intended to be placed into a single shipping box.

Shuttle Cart—The cart which contains Vertical Elevators and is towed by the PAV in the FCA system. It carries Totes to/from the Aisle Conveyors to/from the Picker Platform in the correct sequence to facilitate Order picking in an optimized manner.

SKU—An industry-standard acronym for Stock Keeping Unit which is a distinct type of item for sale, such as a product or service, and optionally some or all attributes associated with the Item type that distinguish it from other Item types.

SKU Identifier—A unique identifier or code that refers to the particular Stock Keeping Unit (SKU).

Storage—Locations where Totes can be stored while awaiting processing by an Automated Warehouse System or awaiting transfer to a Bin Wall by Conveyors. This can be short-term when specific totes will be required within a short time frame or long-term when cycle time is longer. Separating Storage into these two types defines where the storage must be located and how much used in some embodiments, subsequently allowing a lower overall amount of storage.

System as a Whole (SAAW)—In the First Part of the Invention documentation below, the general term ‘SAAW’ will be used to refer to the FCA system as a whole (i.e., PAV, Shuttle Cart, Tote Storage units, Conveyors, and FCA Control Software).

Tote—In some embodiments, a plastic tote is 600 mm long×400 mm wide×323 mm tall at the rim with a 505 m long×335 mm wide footprint. Tote capacity is 35 kg. Totes can be nested.

Velocity—The frequency with which any individual SKU is ordered.

Vertical Elevator—A mechanical device that can transport a load from one vertical position to another vertical position along a single vertical axis.

WMS (Warehouse Management System)—Refers to the system that manages shipments, maintains SKU definitions, handles restock and replenishment, and provides problem solving functionality.

### BRIEF DESCRIPTION OF THE COMBINED DRAWINGS

FIG. 1 is a front-view representation of a Bin Wall 100. A Bin Wall includes a multitude of small compartments 101.1, 101.2 . . . 101.n, 102.1, 102.2 . . . 102.n, etc. to hold the Items of an Order.

FIG. 2 is a timeline 200 representation of a 1-hour Batch Window and the corresponding Segments for that Batch Window. The length of the Batch Window is optionally variable, while the length of the Segments depends on certain system parameters.

FIG. 3 is a front-view representation of a Pick Face 300 showing the individual Bins in the Shelving Units. The darker shading in the center area 310 represents the various Velocity values of the corresponding SKUs with the darkest gray being the fastest moving SKU's.

FIG. 4 is a representation of a Pick Face divided into individual Pick Windows 400, each one having its own alphanumeric representation based on its column and row. It also shows the shaded Prime Area 402 where the highest Velocity SKU's are stored. In the forthcoming example, almost 90% of the picks originate in this area.

FIG. 5A is a front-view representation of a Picker Platform on a Pick Face utilizing a Pick-to-X system 500. The Pick-to-X system is comprised of the Picker Platform 501 where the Picker stands while performing picks, two linear actuators 512 (one vertical and one horizontal), and two line-lasers 511 mounted on those actuators. The line-lasers generate two laser lines 513 which cross at the Bin where the Picker is to perform their next pick.

FIG. 5B is the same front view representation of a Picker Platform on a Pick Face utilizing a Pick-to-X system 502 and a representation of two laser lines that, at their intersection, indicate for the picker where (from which bin) the next pick item is to be retrieved following the one picked in FIG. 5A.

FIG. 6A is a fundamental representation of the Batches in a hypothetical Batch Window 601. The Batches are comprised of Order SKU's carried in different numbered Totes (each number 1-5 is a different Batch) in each Aisle. While an Order must reside in total within a single Batch, its SKU's can be spread across any of the Totes within the Batch. Each Batch then includes one Tote 510 from every aisle. In summary, there are 5 Batches, each with 6 Totes for a total of 30 Totes. In this embodiment the 5 Batches are within one Segment.

FIG. 6B is a different representation of the Batches in a hypothetical Batch Window 602. In this case, the Batches are still comprised of different numbered Totes (each one is a different Batch) in each Aisle. However, each Batch is then comprised of a different number of Totes. In summary, there are nine (9) Batches, each having 2 to 6 Totes, for a total of 54 Totes.

FIG. 6C is yet another alternate representation of the Batches in a hypothetical Batch Window 603. The Batches are comprised of different numbered Totes (each number is a different Batch) in each Aisle. Each Batch then includes one or two Totes from every aisle. In summary, there are 5 Batches, 3 with 5 Totes and 2 with 6 Totes for a total of 32 Totes. In this embodiment there is only one Segment.

FIG. 7A is a block diagram of a system 701 including a plurality of cost-reduced Mini-ASRS's 713 providing Storage, a plurality of Bin Walls 711, a series of Conveyors, a replenishment area 714, and Automated Warehouse Systems 710 as shown in FIG. 10B and described in Section 5 of the Description of First Part of the Invention Preferred Embodiments.

FIG. 7B is a block diagram of another system 702 including where the plurality of cost-reduced Mini-ASRS's 713 are replaced with fewer larger Mini-ASRS's 715 to serve multiple aisles as a further cost reduction.

FIG. 7C is a block diagram of yet another system 703 including where the plurality of cost-reduced Mini-ASRS's 713 are used for short-term Storage and the larger Mini-ASRS's 715 are used as long-term Storage and Buffers to be used by other types of AWS's.

FIG. 8 is a table 800 showing the different access times for moving the Picker Platform different numbers of Pick Window increments (0-2) in both a horizontal and a vertical direction.

FIG. 9 shows the Pick Windows 900 and the different number of Picks that are required from each of them to perform the Batch Window example provided in this document.

FIG. 10A show the routes 1000 the Picker Platform must follow in each of the 3 Segments for the Batch Window example provided in this document.

FIG. 10B is a perspective view of the FCA system 1002 that is usable with some embodiments of the present invention.

FIG. 100 is a top view of a simulation 1003 of system 1002 at ten successive time periods 1030-1039 performing the tote movements and item picks, according to some embodiments of the present invention.

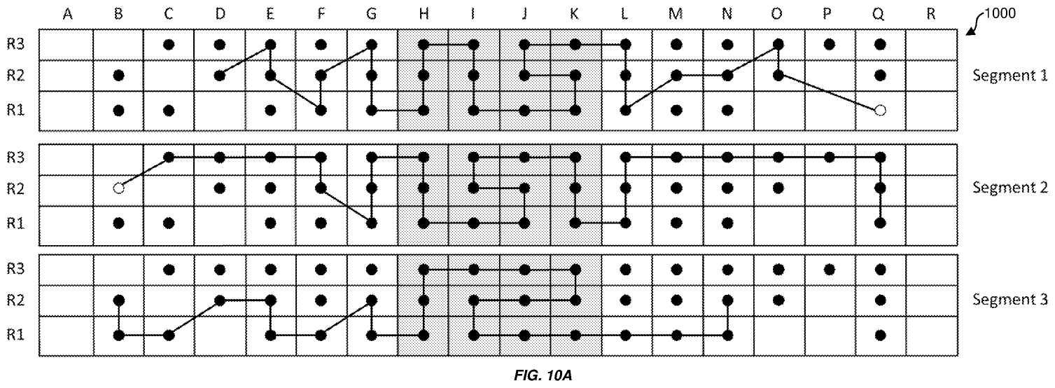

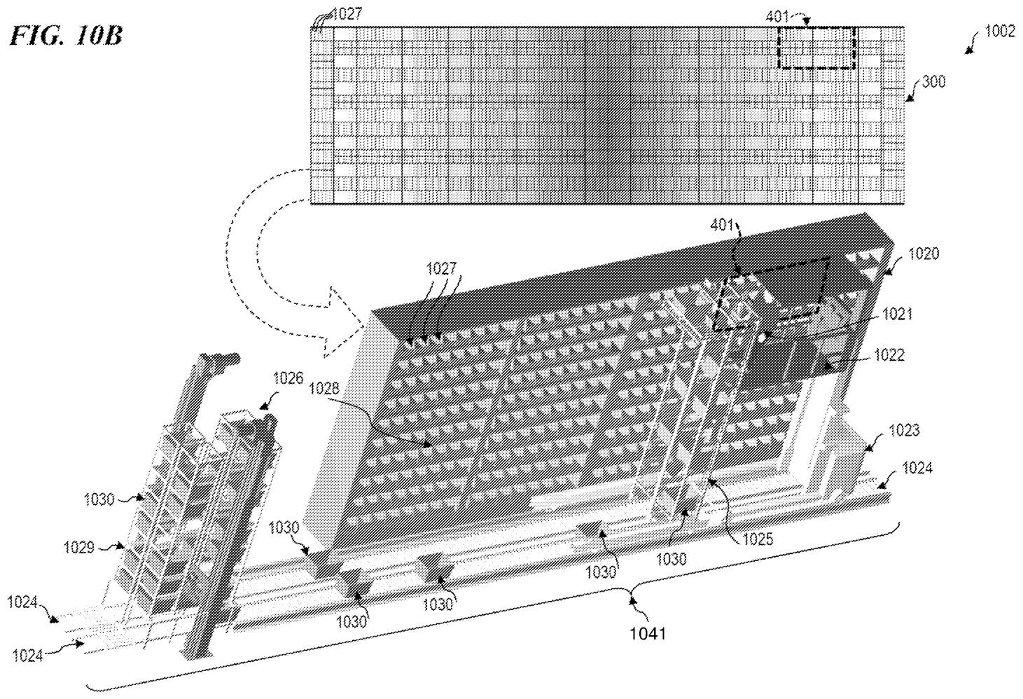

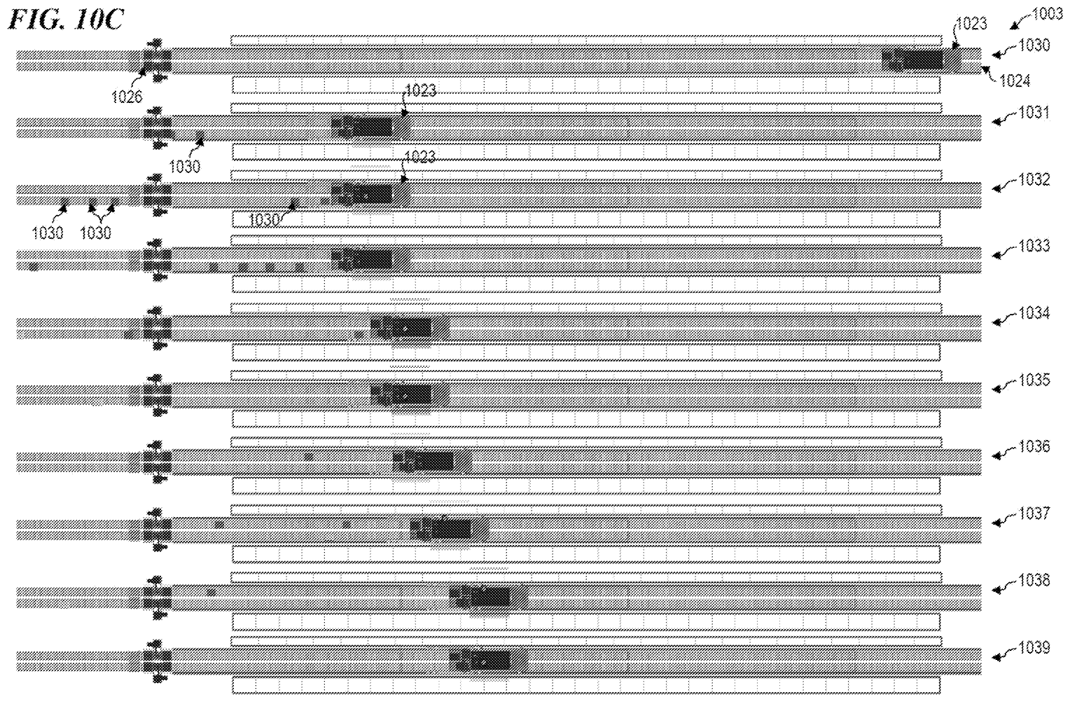

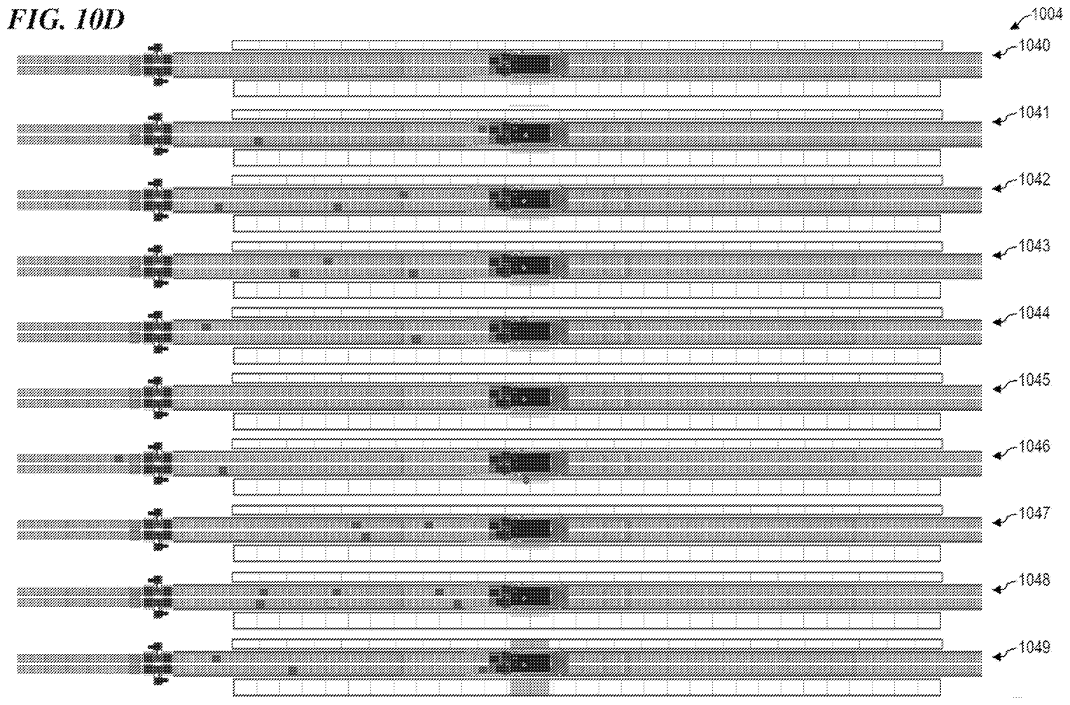

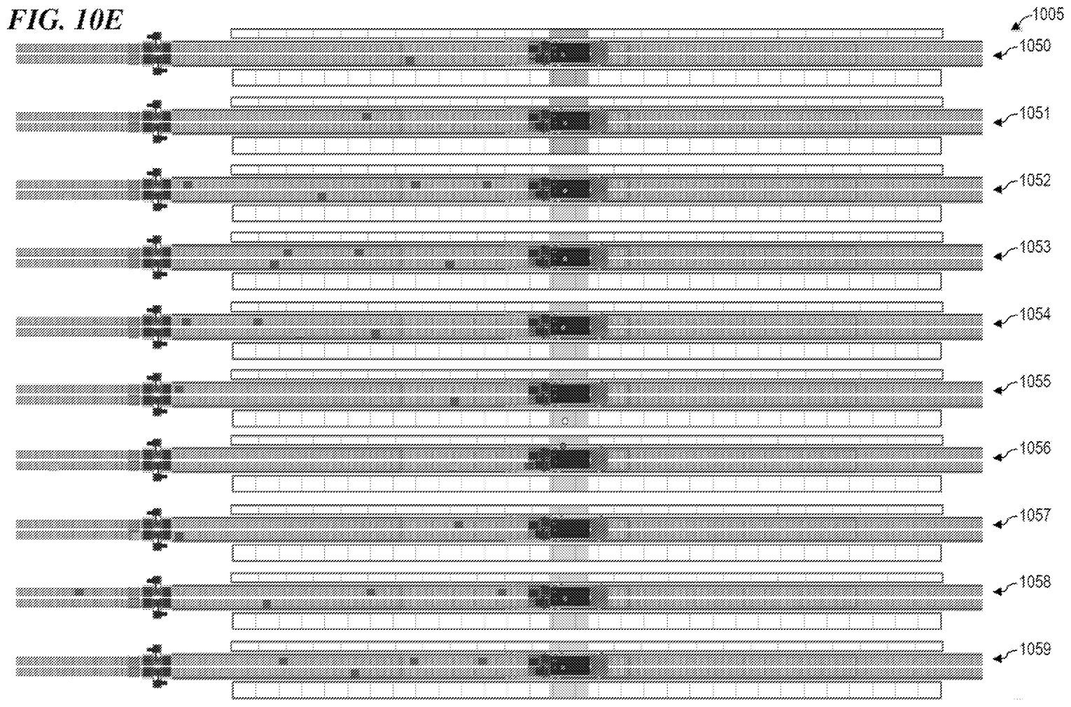

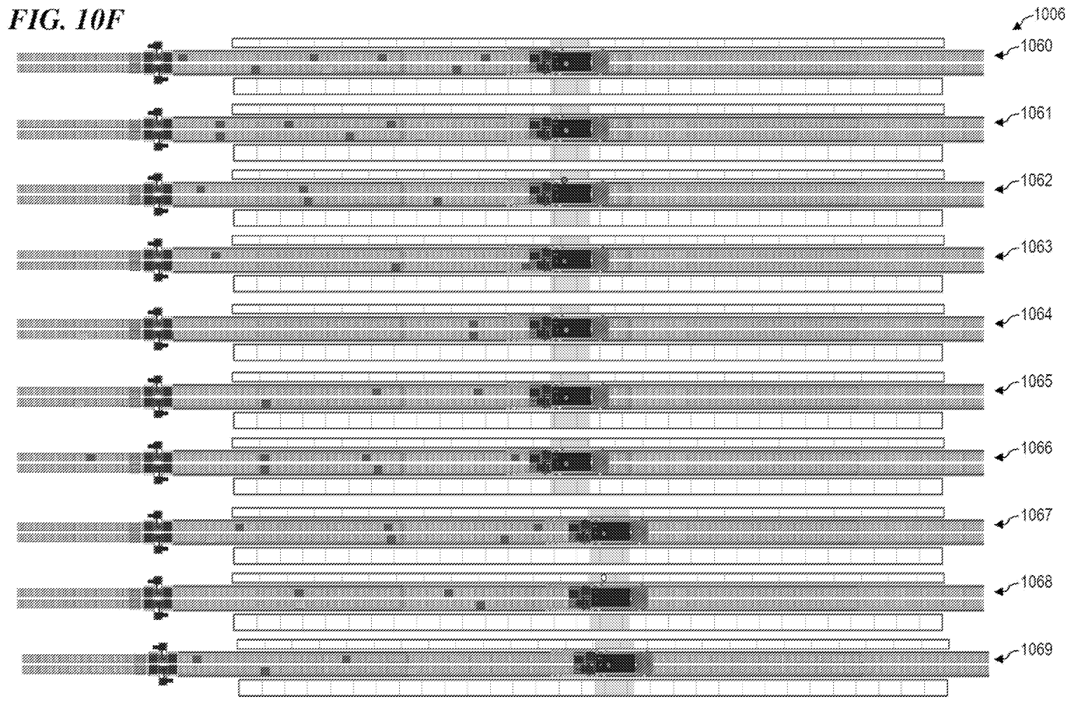

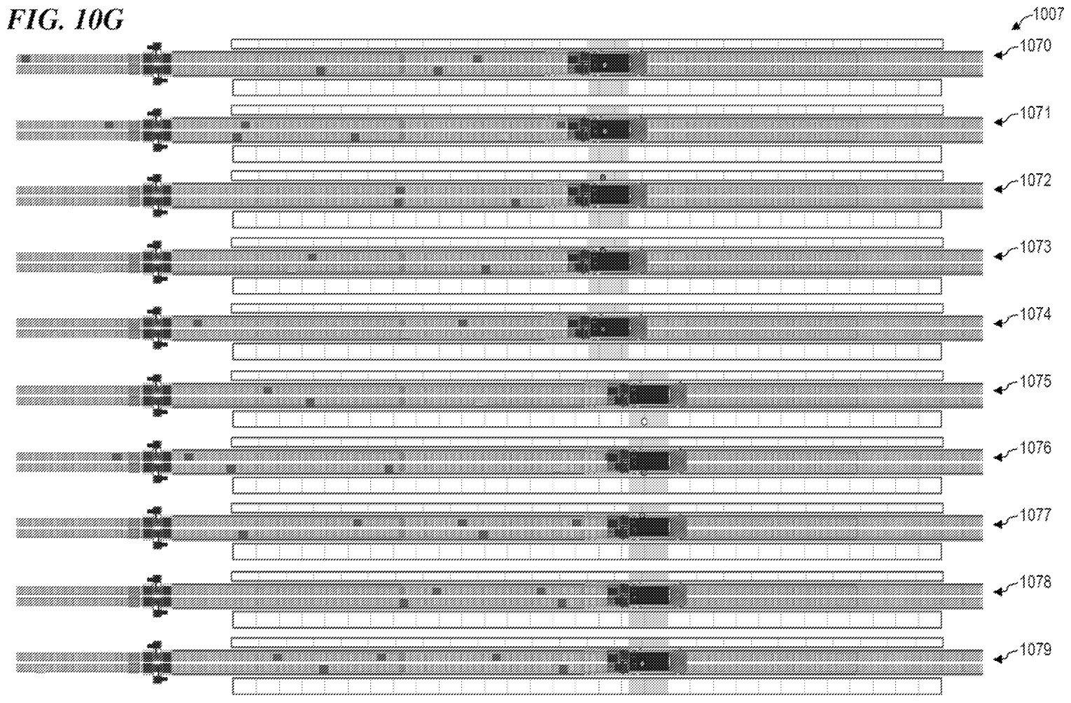

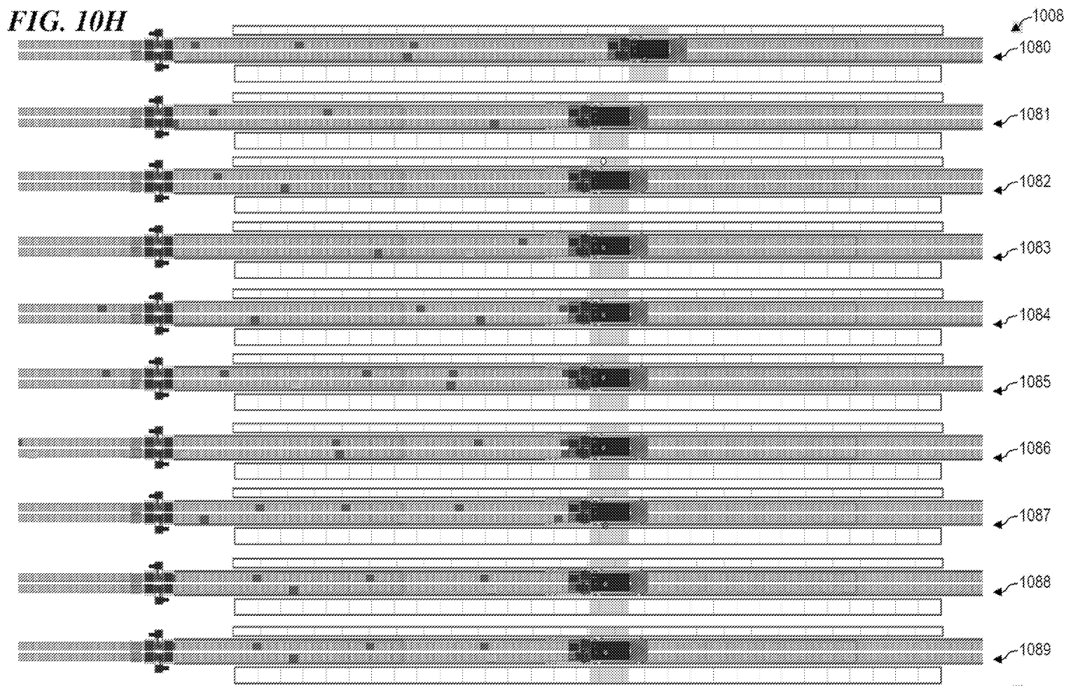

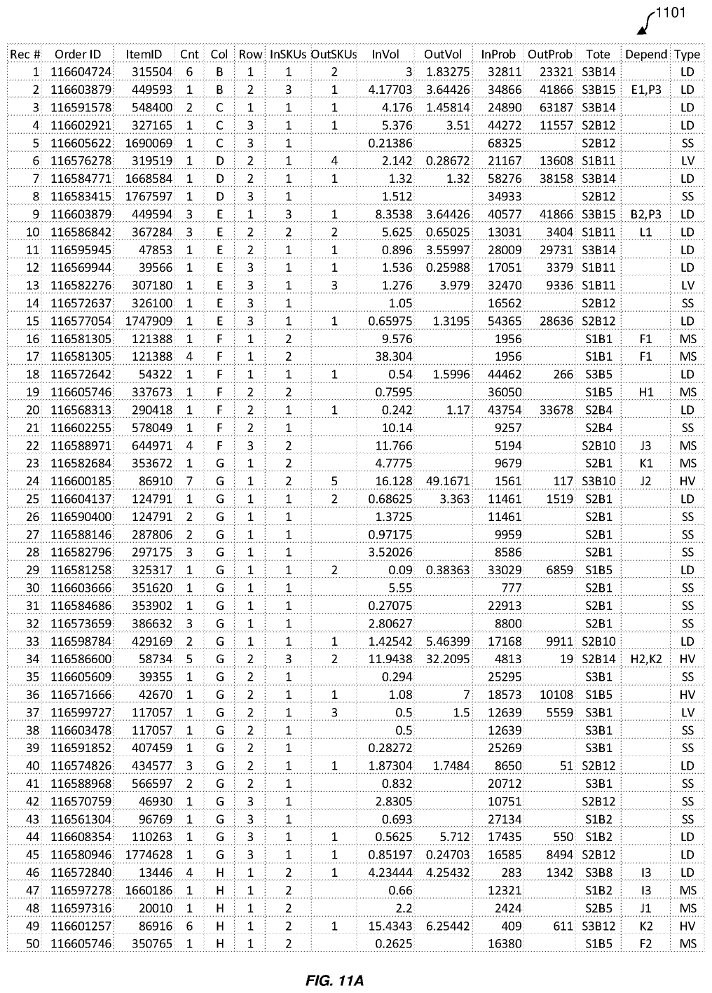

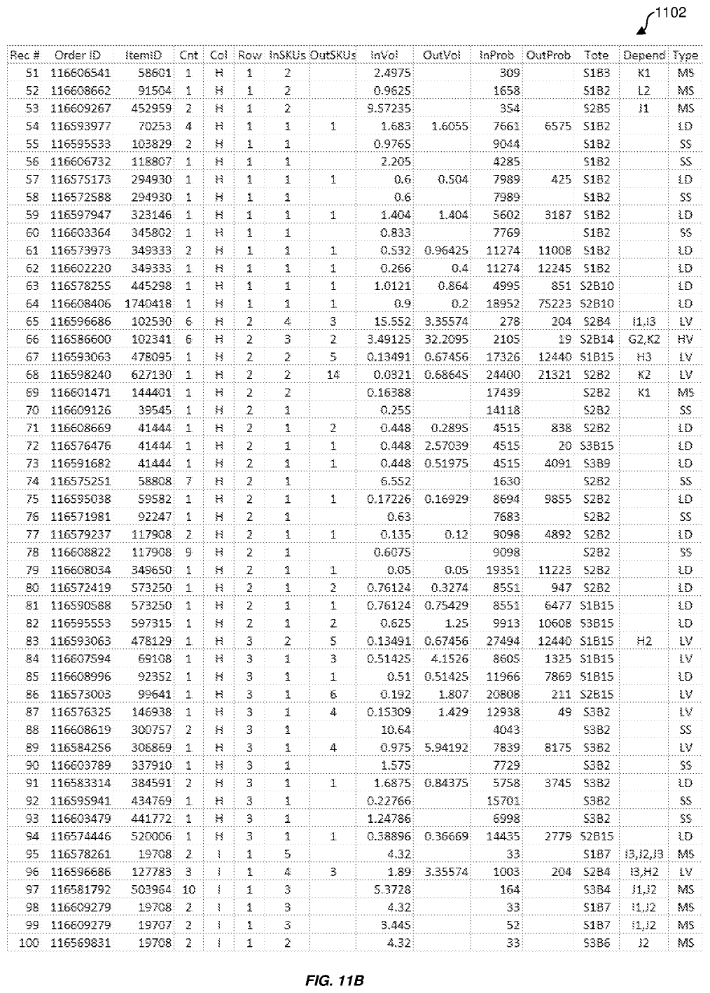

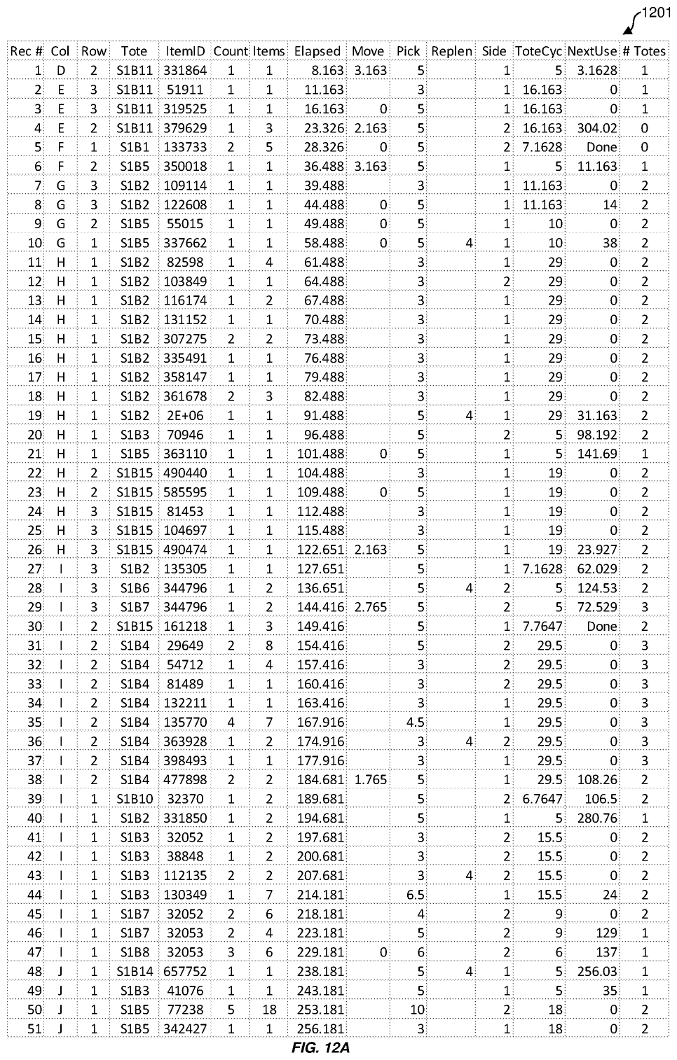

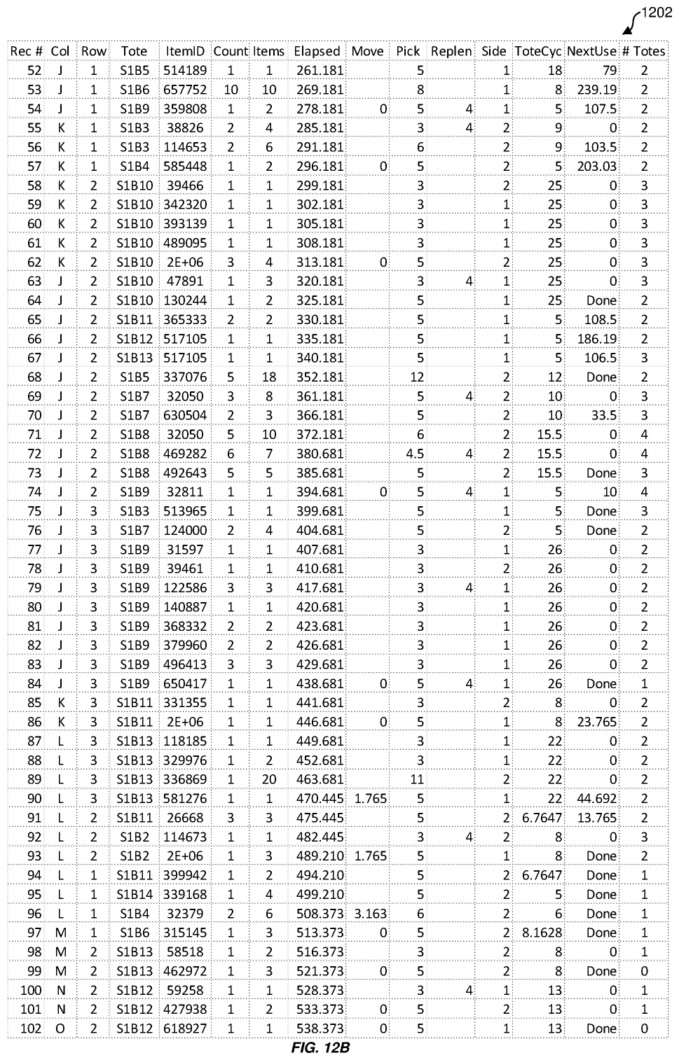

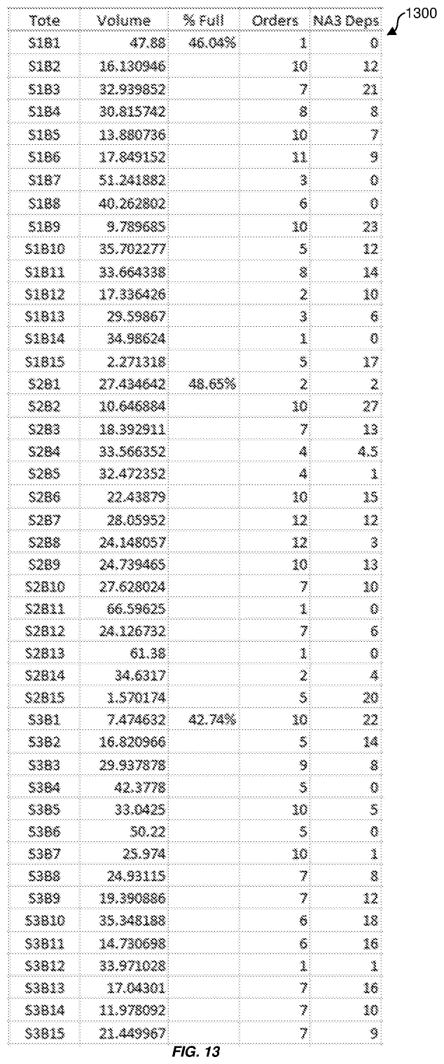

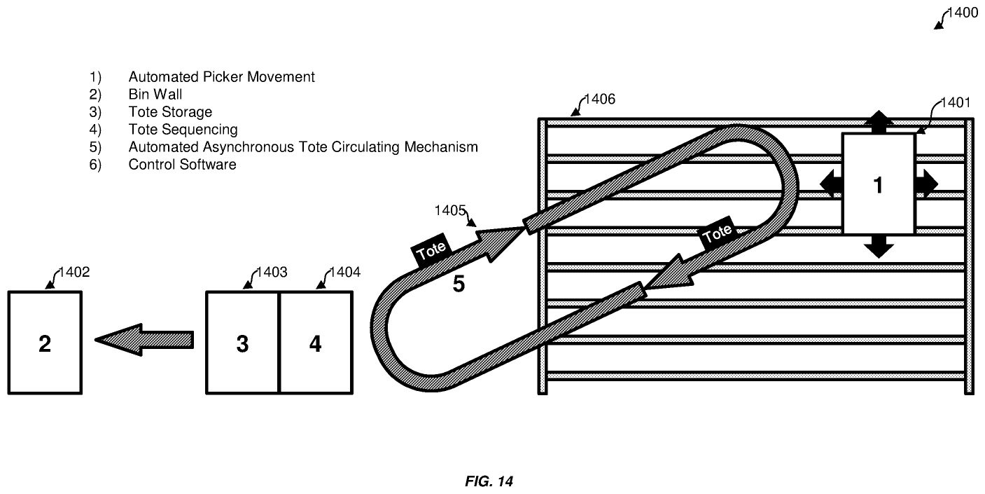

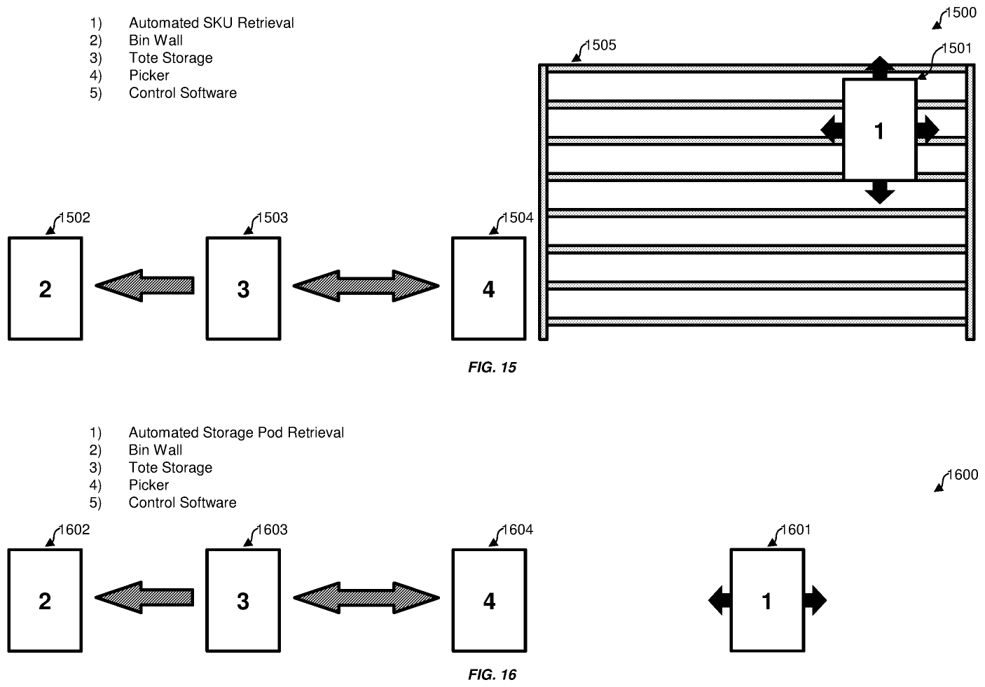

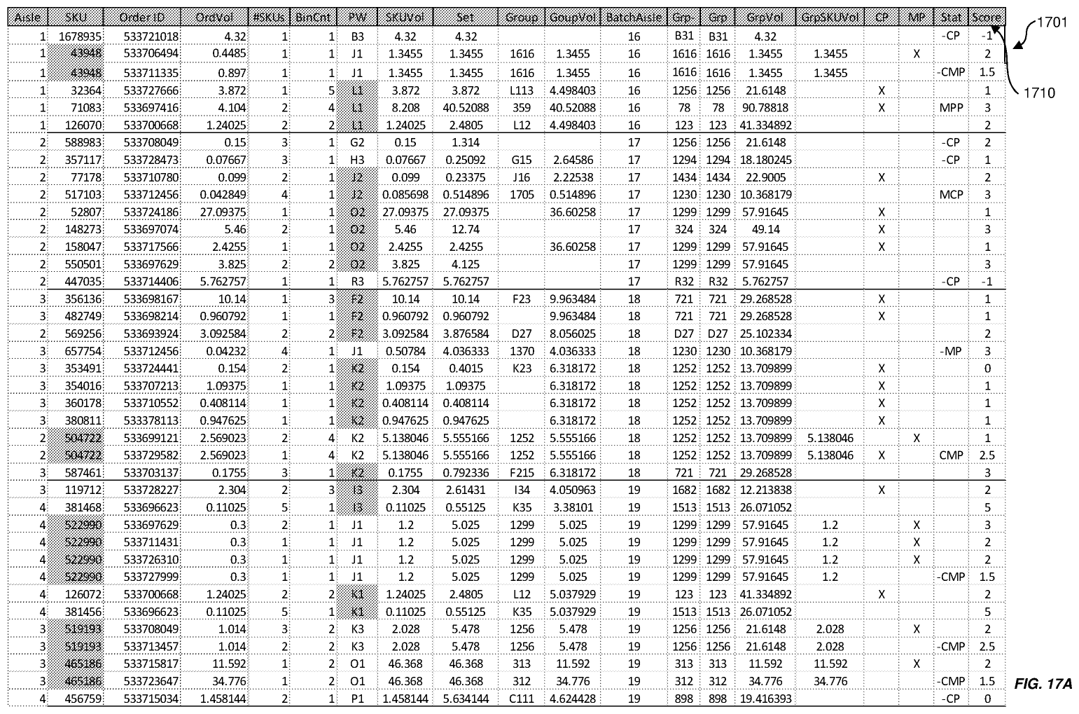

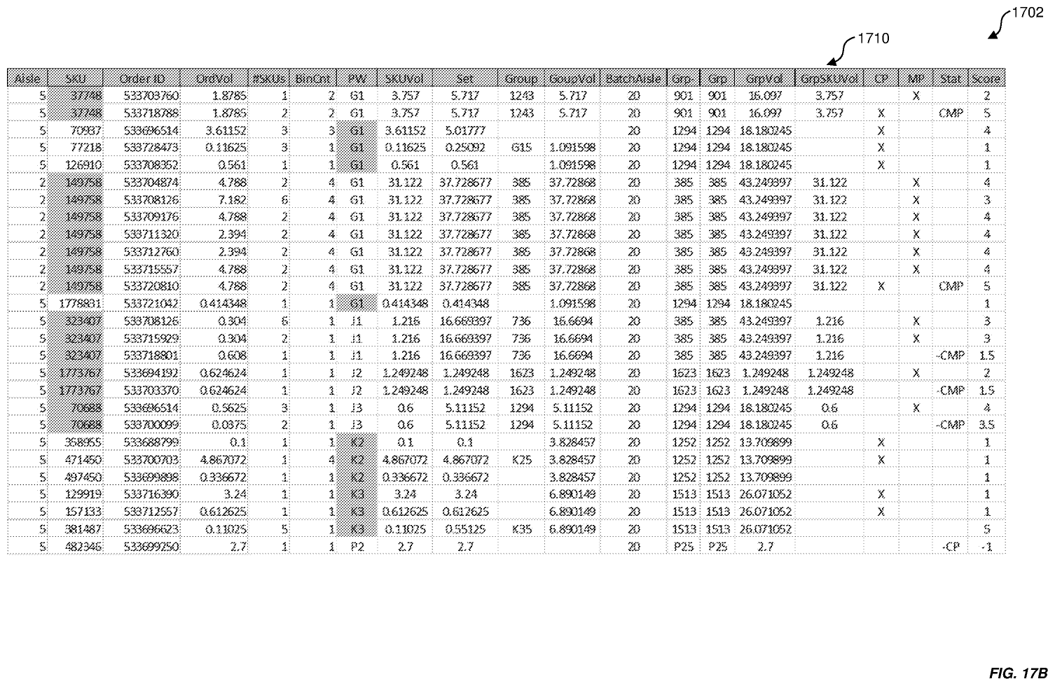

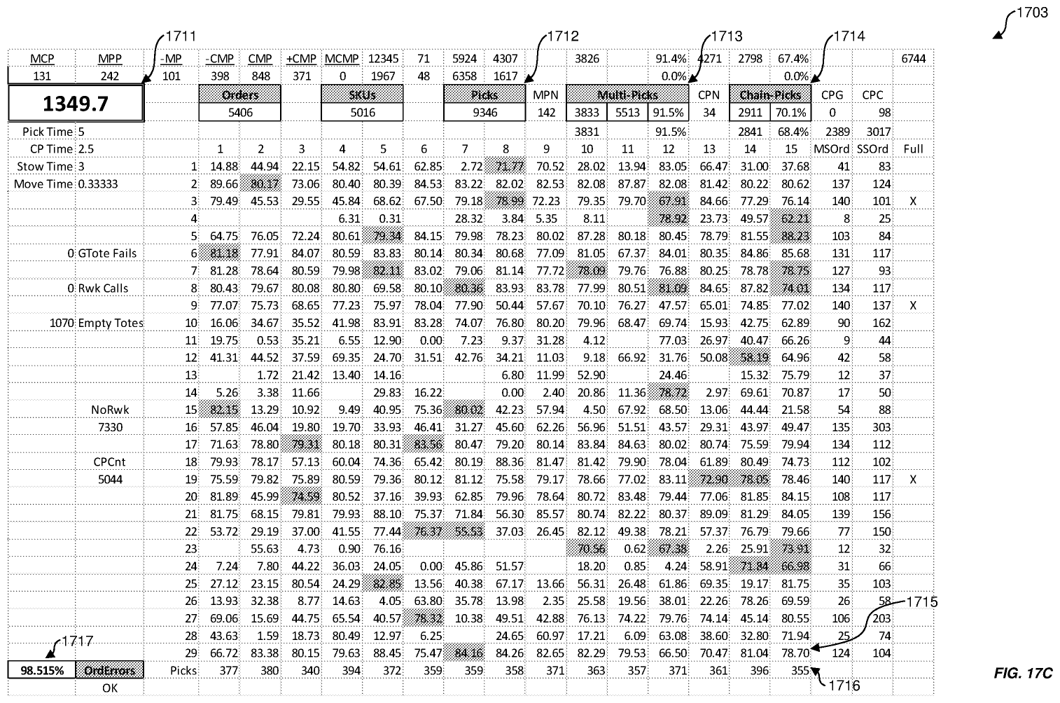

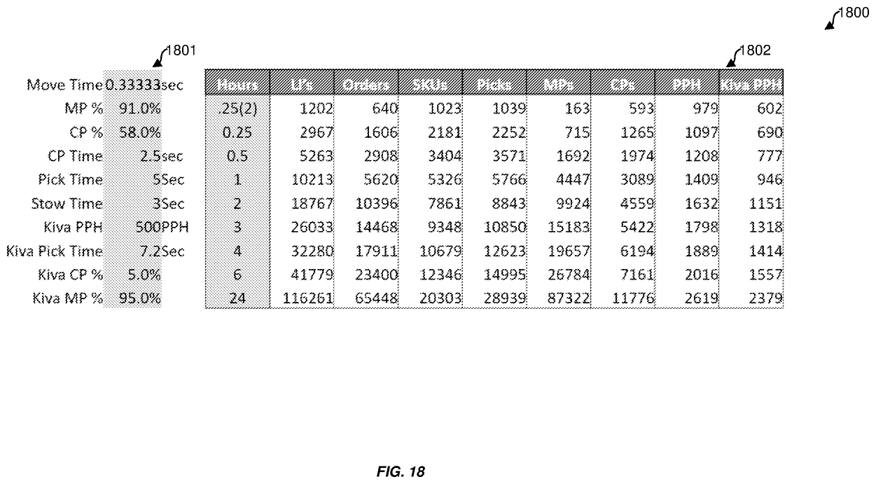

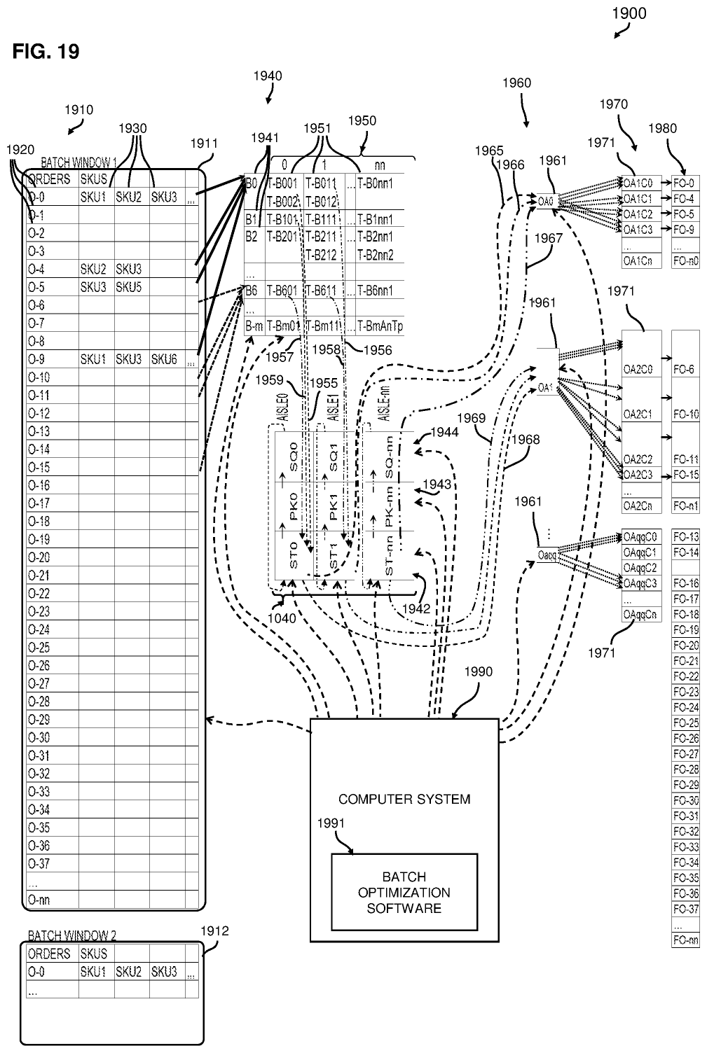

FIG. 10D is a top view of a simulation 1004 of system 1002 at ten successive time periods 1040-1049 performing the tote movements and item picks, according to some embodiments of the present invention.

FIG. 10E is a top view of a simulation 1005 of system 1002 at ten successive time periods 1050-1059 performing the tote movements and item picks, according to some embodiments of the present invention.

FIG. 10F is a top view of a simulation 1006 of system 1002 at ten successive time periods 1060-1069 performing the tote movements and item picks, according to some embodiments of the present invention.

FIG. 10G is a top view of a simulation 1007 of system 1002 at ten successive time periods 1070-1079 performing the tote movements and item picks, according to some embodiments of the present invention.

FIG. 10H is a top view of a simulation 1008 of system 1002 at ten successive time periods 1080-1089 performing the tote movements and item picks, according to some embodiments of the present invention.

FIG. 11A is a listing of the first 50 Line Items 1101 and their key characteristics required for the software for the 405 orders that comprise the Batch Window example provided in this document.

FIG. 11B is a listing of the next 50 Line Items 1102 and their key characteristics required for the software for the 405 orders that comprise the Batch Window example provided in this document. It is assumed 100 data records of the 405 are sufficient to demonstrate the results of the Batch Optimization.

FIG. 12A is the first part of the Pick List 1201 for the first Segment in the Batch Window example provided in this document and includes the pertinent data for each Pick.

FIG. 12B is the last part of the Pick List 1202 for the first Segment in the Batch Window example provided in this document and includes the pertinent data for each Pick. Again, it is assumed the example of the Pick List for just the first Segment out of the three Segments is sufficient to demonstrate the results of the Batch Optimization.

FIG. 13 is a volume and Order summary 1300 for all the Totes in the example.

FIG. 14 is a block diagram of an FCA type system. It includes 6 key elements besides the warehouse shelving 1406. These 6 key elements are: a mechanism to automate Picker movement 1401 in the directions shown, a Bin Wall 1402 to segregate Batched Orders, a mechanism 1403 to temporarily Store Totes while they are being processed, a mechanism 1404 to Sequence the totes into the correct order for presentation to the Picker (a single system is often used to both Store and Sequence the Totes), a mechanism 1405 to asynchronously transport Totes to/from the Picker in an automated fashion, and the FCA-Control Software.

FIG. 15 is a block diagram of a Multi-Shuttle type AWS 1500 utilizing Batch Optimization. It includes 5 key elements besides its own precision shelving 1505. These 5 key elements are: an automated carriage 1501 to retrieve SKU's in the directions shown, a Bin Wall 1502 to segregate batched orders, a mechanism 1503 to temporarily Store Totes while they are being processed, a Picker 1504 and its own system control software.

FIG. 16 is a block diagram of a Kiva-type AWS 1600 utilizing Batch Optimization. It includes 4 key elements. These 4 key elements are: an AGV 1601 which cycles SKU storage pods between their warehouse storage positions and a Picker 1604. In some embodiments, the AGV's cannot move vertically, only horizontally along two axes. In some embodiments, the Kiva-type AWS 1600 also requires a Bin Wall 1602 to segregate batched orders, a mechanism 1603 to temporarily Store Totes while they are being processed, and its own system-control software.

FIGS. 17A, 17B, and 17C show representative results 1701,1702, & 1703 of the Batch Optimization algorithm of the present invention. They consist of a sampling of the first records in the database 1710, the simulated Pick Rate 1711 for the algorithm, the number of Picks required 1712 in the Batch Window, the resulting Multi-Picks 1713, the resulting Chain Picks 1714, the BatchMap 1715, the Picker totals 1716, and the efficiency 1717 of the algorithm.

FIG. 18 shows comparative representative results 1800 for different length Batch Windows for both the FCA and a Kiva type AWS. These differing Pick Rates being dependent on the length of the Batch Window provide the Programmable Capacity feature of the algorithm. The parameters used for the simulation 1801 provide the results 1802 shown in the table.

FIG. 19 is a block diagram of a system 1900 that implements flow and control according to some embodiments of present invention.

### SUMMARY OF THE FIRST PART OF THE INVENTION

The First Part of the Invention primarily addresses the use of optimized Batching to significantly increase the performance of the FCA. Batching refers to the practice of collecting several orders at one time in the process of fulfilling commercial Orders. This is typically done by placing Items into some type of container, such as a Tote. Today, these orders generally refer to eCommerce. Batching has historically been used to improve the performance of Pickers in a manual system where they traverse a warehouse and access its Shelving Units to collect the Items for an Order.

In some embodiments, a computerized system and method uses optimization after aggregation of orders over a Batch Window period of time to increase Pick Performance in the Fulfillment Center Automation (FCA) system that automates taking the picker to the goods; or an Automated Warehouse System (AWS) that automates the presentation of goods to a stationary picker. A Batch Optimization algorithm improves pick performance for the FCA or AWS using a closed-form algorithm, combinatorial optimization, or OOP to perform the Batch Optimization. Some embodiments adapt to Picker Performance by automatically shifting certain orders to different aisles while stocking a plurality of identical-SKU items in each of a plurality of aisles. Programmable Capacity is optionally provided to allow the Fulfillment Center to easily adapt to varying order loads. Some embodiments selectively place orders from a given Batch Window period of time into selected Batches in order to maximize multi-picks of identical-SKU items at one time and maximize chain-picks of different-SKU items in sequential picks from a single pick window location at a pick wall.

By collecting the items for numerous Orders at one time, the present invention reduces the overall distance required to be travelled by the Picker, thus resulting in an overall cost savings as opposed to just collecting the Items for one Order at a time. When the Orders are collected in such a manner, they still need to be segregated into individual Orders when the Batch arrives at shipping. However, that time is generally far less than the time that would otherwise have been required if the Orders were collected individually.

To the inventor's knowledge, Batching has generally not been utilized with AWS's since the Picker remains stationary in those systems. Therefore, there is no walking distance to be saved. However, the inventor has discovered that Batching determined by software, combined with the necessary hardware and the associated processes can be utilized to also improve Pick Performance in these automated systems, particularly for the FCA.

The First Part of the Invention focuses on software, associated hardware, and associated processes which will significantly enhance the performance of picker-to-parts systems such as the FCA.

However, aspects of the First Part of the Invention can improve the performance of any AWS. This document also demonstrates those benefits to the AWSs that are most prevalent in the eCommerce Industry outside of Amazon. There are several types of AWS systems available in the industry today, many with their own unique aspect that is covered by their own intellectual property. This type of system generally has precision mechanical Shelving Units containing Bins holding commercial Items that can be retrieved and returned by small mobile robots. The shelving system typically contains a multitude of these robots such that the static Picker can remain motionless while these robots present the requested commercial Items to the Picker for inclusion in an order.

Pick-performance improvement is done by aggregating several Orders in what is referred to as a Batch Window. These Orders are then strategically combined into certain groupings or Batches prior to the Items being retrieved from the FCA or other competitive AWS's. Assuming the Orders are collected into Totes, by then utilizing strategic Tote Storage combined with high speed automated Conveyors, much of the wasted time surrounding the Order fulfillment process can be eliminated.

Depending on the AWS, this time savings involves picking numerous Items at one time, reducing/eliminating the time penalty associated with the mechanical system movement, and minimizing wasted Picker motion involved in the picking and Replenishment processes. The software, hardware, and associated processes to achieve this are set forth in this First Part of the Invention. Many of them are novel and result in significant Pick Performance improvement. A detailed example is provided to assist in the clarity of understanding.

### Description of First Part of the Invention

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The embodiments shown in the Figures and described here may include features that are not included in all specific embodiments. A particular embodiment may include only a subset of all of the features described, or a particular embodiment may include all of the features described.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

When Batches are utilized in the Order fulfillment process, a multitude of the SKUs constituting those Orders arrive at shipping in containers of some type. For purposes going forward we will assume those containers are Totes. Ignoring the possibility of partitioned Totes, the SKUs in those Totes will need to be segregated from the Totes and aggregated back into individual Orders, so they can each be placed in their respective shipping boxes and sent on to their final destinations.

This segregation can be accomplished with the use of a Bin Wall 100.

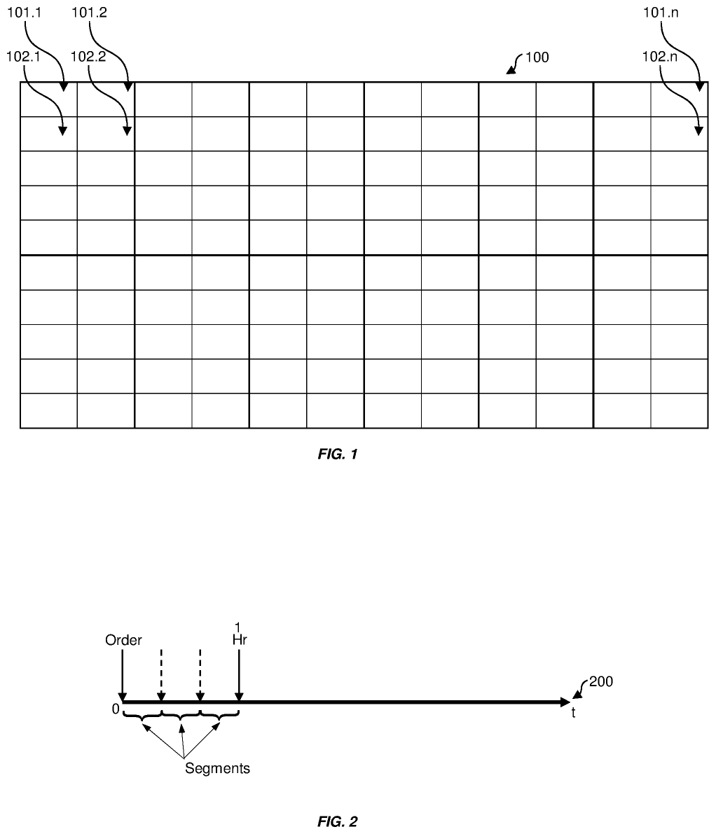

FIG. 1 shows a front-view representation example of a Bin Wall 100. A Bin Wall 100 includes a multitude of small compartments 101.1, 101.2 . . . 101.n, 102.1, 102.2 . . . 102.n, etc., where individual Orders are assembled as the Batch Items are segregated from the Totes. When that segregation is finished, a complete individual Order is aggregated and exists in each of the small compartments (such as order-aggregation containers 1971 of FIG. 19 described below) utilized. In some embodiments, someone from shipping then retrieves each individual Order for placement into a shipping box.

There are many different forms of Bin Walls, sometimes known as Put Walls in the industry. In some cases, the compartments might be on a mobile unit where that entire unit can be delivered to shipping when all the compartments are filled. In other cases, the compartments may be simply an array of box-shaped compartments with both ends open as shown in FIG. 1. To facilitate performance, each one of these compartments can be identified to the Picker with its own lit light when it is time to place an Item in said compartment. This follows identification of the Item by a bar code scanner and its link to a specific Order.

However, it is not the purpose of this description to belabor with specifics on Bin Walls, suffice it to say that one or more of the available permutations of Bin Walls are used by some embodiments of the invention, the number of which is fully dependent on the size and scope of the Fulfillment Center that will be utilizing it (them).

FIG. 2 is a timeline 200 representation of a 1-hour Batch Window and the corresponding Segments for that Batch Window. At the core of this invention is the aggregation of Orders over a Batch Window 200 as shown in FIG. 2. The duration of a Batch Window can be set to any convenient value or can be variable. In the case shown and in the ensuing example provided, Orders are collected over a one-hour-period Batch Window. In some embodiments, the Batch Window will then need to be subdivided into smaller increments called Segments as also shown in FIG. 2. The number and length/duration of the Segments is totally dependent on the variables surrounding the system which will be fully described in Section 4. The number and length/duration will also generally be variable dependent on the nature of the Orders involved.

Once the Orders are identified that will comprise a Batch Window, software is employed which will optimize the assignment of a specific Order with a specific Batch and with a specific Tote. It will also need to be processed with the hardware described in this invention in such a manner to greatly reduce and/or eliminate the wasted time involved with current pick processes. Finding these optimal combinations of orders is a classic problem for the use of Combinatorial Optimization. In this case, it also requires the use of constraints. Combinatorial optimization is one preferred embodiment for this invention.

### Section 1—Combinatorial Optimization with Constraints

Optimization problems deal with the minimization or maximization of a function of many variables subject to a set of constraints. These problems arise in an enormous variety of areas such as industry, logistics, finance, transportation, configuration, etc. Since the 1960s, linear and mixed-integer programming technologies have been employed with tremendous success for solving hundreds of problem types. Combinatorial Optimization Problems (COPs) deal with optimization problems where some or all variables are constrained to be integer. This class of problems is both extremely important and difficult to solve. A simple example is shown below assuming COP=<X,D,C,f> where:
X={x₁, . . . , xₙ} is the set of variables;
D={D(x₁), . . . , D(xₙ)} is the set of domains of variables, D(Xₙ) is the domain of Xₙ;
C={C₁, . . . , Cₖ} is the set of constraints over variables;
f is the objective function to be optimized.
   Example: Given a COP=<X,D,C,f> where:
X={x1, x2};
D(x1)={0,1,2,3}, D(x2)={0,1,2,3,4,5};
C1: 3×1+x2≤11, C2: −x1+2×2≤5;
f: maximize 6×1+5×2.
   Answer: The assignment x₁=3, x₂=2 is an optimal solution to the COP.

The Operations Research (OR) approach for solving hard Combinatorial Optimization problems is like this and was the only one used for a long time. It is based on a mathematical representation of the problem, which is typically modeled as an integer linear program where (integer) variables are linked by linear equalities and inequalities.

Currently, approaches for solving COPs are divided into two categories: complete (or exact) methods and incomplete (or approximate) methods. The aim of the complete methods is to find an optimal solution with the proof of its optimality. Generally, the time complexity of these methods is exponential. Examples include Branch-and-Bound and Dynamic Programming.

The incomplete methods aim at finding a high-quality solution in a reasonable time but without information on the quality of the solution. These include Greedy Algorithms, Approximation Algorithms, Local Search, Metaheuristic methods like Tabu Search, Simulated Annealing, Large Neighborhood Search, Very Large-Scale Neighborhood Search, Genetic Algorithms, Ant Colony Optimization, etc.

The nature-inspired approaches are an interesting area of research within the approximate methods which explore the search space by imitating some behavior from nature to find optimal or near-optimal solutions. Nature-inspired meta-heuristics can be classified in two main branches, the bio-inspired and physics-inspired techniques. One of the most representative methods from the bio-inspired techniques is Genetic Algorithms (GAs) which was used in the original FCA concept to optimize routes for the Picker Platform on the PAV.

These meta-heuristic algorithms are iterative problems. In other words, from the initialization point of the associated program, the process is repeated based on the selected algorithm and asymptotically approaches a solution. The question becomes the time required for the convergence and the relative error of the asymptotic limit from the true optimal solution. The speed and accuracy of the convergence is a function of the specific type of problem, the selected algorithm, and the population size. Both the speed and accuracy can vary dramatically based on those combinations. Each algorithm has its own set of parameters that require fine tuning to achieve the best results.

While the use of a meta-heuristic algorithm traditionally simplifies the algorithm and ensuing software combined with also providing greater efficiency and flexibility, the requirement to contend with system constraints adds back additional complexity. That complexity is a function of the particular constraints, the number of constraints, and the selected algorithm.

A constrained problem consists of a set of constraints involving a number of variables restricted to have values in a set of (possibly different) finite domains. A constraint is basically a relation maintained between the entities (e.g., objects or variables) of a problem, and constraints are used to model the behavior of systems in the real world by capturing an idealized view of the interaction between the variables involved.

Solving a constrained problem means finding a possible assignment (of values in the computation domains) for the constrained variables that satisfies all the constraints. Solving this kind of problem can be done by using different techniques ranging from traditional techniques to modern ones. These approaches to solve the problem can be in operational research (OR), genetic algorithms, artificial intelligence (AI) techniques, rule-based computations, conventional programs and constraint-based approaches amongst others.

Usually, the solving is understood as the task of searching for a single solution to the problem, although sometimes it is required to find the set of all solutions. Also, in certain cases, because of the cost of finding all solutions, the aim is just to find the best solution or an approximate solution within fixed resource bounds (e.g., in a reasonable time). That is the case surrounding the nature of this invention. There is no need to have “the optimal solution”, only a highly optimized one, and that is what this invention delivers.

### Section 2—Three-Tier Optimization

In the original FCA, the system relied solely on route optimization in the use of the Genetic Algorithm (GA). The computer execution time required for the GA to converge that was used in the initial FCA concept caused significant system-dependency issues relative to available CPU time. This was due to the system being reactive and continuously reoptimizing in each Aisle based on the most recent Orders. The current invention breaks this requirement for reactiveness, and instead relies on planning in a Three-Tier Optimization approach. While the Three-Tier approach still uses route optimization, the dependency on its reactive use has been eliminated as part of this invention. This approach greatly reduces the requirement on CPU time and overall system speed.

The Three-Tier Optimization approach begins with SKU placement optimization in the Pick Faces of the warehouse Aisles.

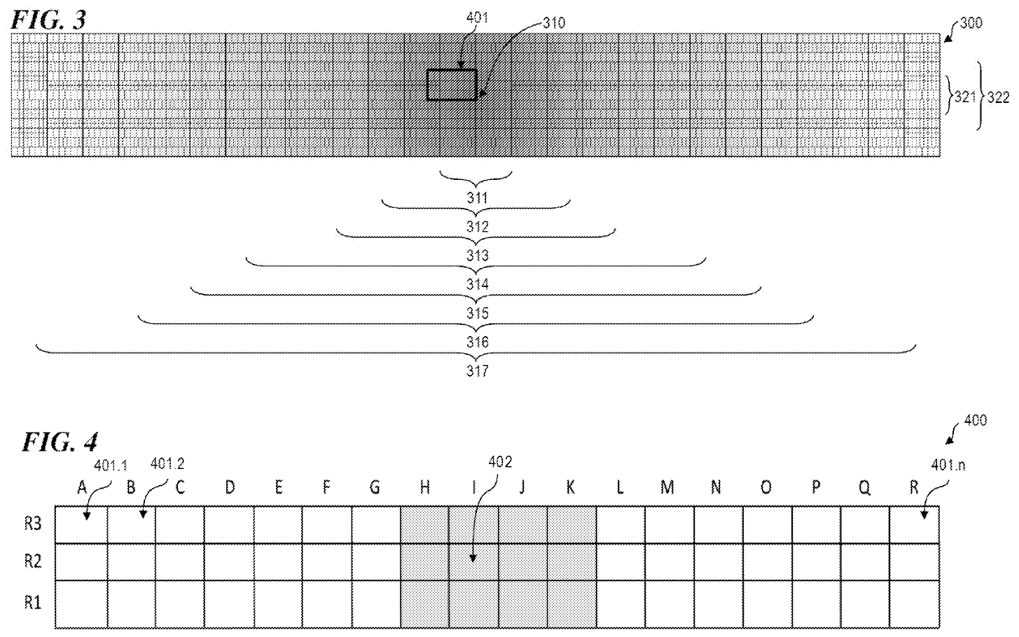

FIG. 3 shows an optimized Pick Face 300 with the highest Velocity SKUs concentrated in the center (e.g., center “columns” 311 and “rows” 321 around the center 310) of the Pick Face and radiating outward to include successively more horizontally distant columns (those columns in ranges 312, 313, 314, 315, 316, 317 that are outside of the smaller-numbered ranges) and more vertically distant rows (those in row range 322 but outside row range 321), with progressively slower moving SKUs at further distances (in some embodiments, both vertically and horizontally) from the center. This results in all the best-selling stock to be located as near as possible to the next-best-selling stock in the Pick Face. This ultimately results in statistically minimized route travel in a Picker's efforts to fulfill the Orders in any given Batch. This benefit will be quantified in the forthcoming example. An example Pick Window 401 (described in more detail below) is shown where the thick-lined rectangle shows the edge of the exemplary Pick Window 401.

Besides locating high Velocity SKUs next to one another, there is also a requirement to stock the highest moving SKUs in multiple Aisles as part of the SKU placement optimization. Besides other benefits that will be divulged, having multiple locations for the highest Velocity SKUs allows the system to continuously adapt to differing picking speeds by the Pickers in the different Aisles. The extent to which SKUs are stored in multiple locations is a function of the specific warehouse and its inventory Velocity patterns. Each application will be slightly different.

The initial optimization of SKU placement takes place when the warehouse is initially stocked or an FCA system is installed in an existing warehouse. The overall optimization does not occur real time. However, the FCA Control Software monitors the ongoing Velocities of the SKUs. As the Velocities change over time due to changes in customer demand, seasonality, and/or other issues, the FCA Control Software will periodically reposition SKU locations to keep the overall placement optimized. This is known as Dynamic Slotting.

Following the optimization of SKU placement, comes Batch optimization. Batch optimization is performed once every Batch Window cycle by the FCA Control Software, which takes the Orders aggregated in the Batch Window, identifies which Totes to group together into their respective Batches across the aisles of the Fulfillment Center, assigns all the Orders to specific Totes in those Batches, and then controls the FCA system to deliver those Totes in the correct sequence to the Pickers in the Aisle in order to achieve four goals:
1) Minimize the wasted time of Picker motion in picking one Line Item at a time.
2) Minimize the wasted time of Picker motion in shuttling between an Aisle Bin and a Tote between every pick
3) Minimize the wasted time surrounding stock replenishment in the Aisles.
4) Minimize the wasted time due to mechanical movements in the overall FCA system.

Every SKU in an Order is referenced by a record that includes quantity and a reference to which Order it belongs. A pick is considered the retrieval of one Line Item in one Order. An order requires as many Picks as it has Line Items. In the event of multiples of the same SKU, that is still considered a single Line Item. Goal #1 is then achieved by picking multiples of a single SKU at one time to fulfill multiple Line Items on multiple Orders at one time. These achievements will be known as Multi-Picks going forward.

Goal #2 is achieved using another new concept within this invention called Pick Windows.

FIG. 4 shows a Pick Face 400 segregated into individual Pick Windows (PWs) 401.1, 401.2, . . . 401.n (shown here with column designations A through R and row designations R1, R2, and R3). In some embodiments, each Pick Window 401 is the width of the Picker Platform with the height being determined as being those Bins that are serviceable by the Picker on that Picker Platform when at a given horizontal and vertical position. By assigning Orders to one Tote that all have SKUs whose placement locations are in a given common Pick Window 401, another new concept called Chain Picking can be achieved.

Normally, a Picker in the FCA system or any AWS will pick a SKU from some type of container and then turn to carry it over to another container that is being used to acquire all the Line Items in the Order(s) assigned to that container (Tote). This is generally wasted motion. By having Orders assigned to the Tote the FCA Picker is servicing that all have SKUs in a common Pick Window, the Picker can eliminate much of the wasted motion just identified.

In some embodiments of these instances, as opposed to continually returning to the Tote with picked Line Items, the Picker utilizes a small basket appended to their front (i.e. strap around neck). This allows the Picker to proceed from Bin to Bin in the PW acquiring all those common SKUs until such time that the Tote they are servicing has its requirement fulfilled from that Pick Window. Another new concept, called Pick-to-X (described more in Section 3), will automatically direct the Picker to the next SKU location within a Pick Window and some type of mobile communication device will be used to convey the required multiple to pick. These are either Multi-Picks and/or Orders with multiples of the same SKU.

Goal #3 is achieved by utilizing modular storage Bins for the SKU's that can rapidly be swapped by the Picker. In some embodiments, the FCA Control Software as part of the Batch optimization will also only do a Replenishment action for any given SKU when it is accompanied by an associated pick action. This will then only require an incremental motion to restock a Bin as opposed to a dedicated set of actions usually accompanying a stand-alone Replenishment.

Goal #4 is achieved in a number of combined ways. By reducing the total number of overall picks using Multi-Picks the requirement to continually return to a given pick location is minimized. With another two new concepts called Auto-Move and Auto-Drift, further wasted motion can also be eliminated. These two concepts are addressed in Section 3.

The final way Goal #4 is achieved is done with the final step of the Three-Tier Optimization. That is by route optimization as the Picker progresses from one Pick Window to another. Through the Batch optimization process, the distance required to be moved is minimized by ensuring the next series of picks is done in an adjacent Pick Window if possible. The best way to demonstrate how this is achieved is through the example utilized in Section 5 as opposed to covering details here.

With this Three-Tiered Optimization process, it will be demonstrated that Pick Performance (PPH) can be significantly increased. To that end, Pick Performance is the sole variable that this invention is trying to optimize. It just happens to be a function of the four goals addressed.

While the three elements of the process are completely applicable to the FCA, some elements are also applicable to other AWS's, specifically the Batch optimization element. Going forward, the Multi-Robot Systems will be used as a comparison to the FCA relative to demonstrating and/or comparing potential increased performance using elements of this invention.

### Section 3—Pick-to-X

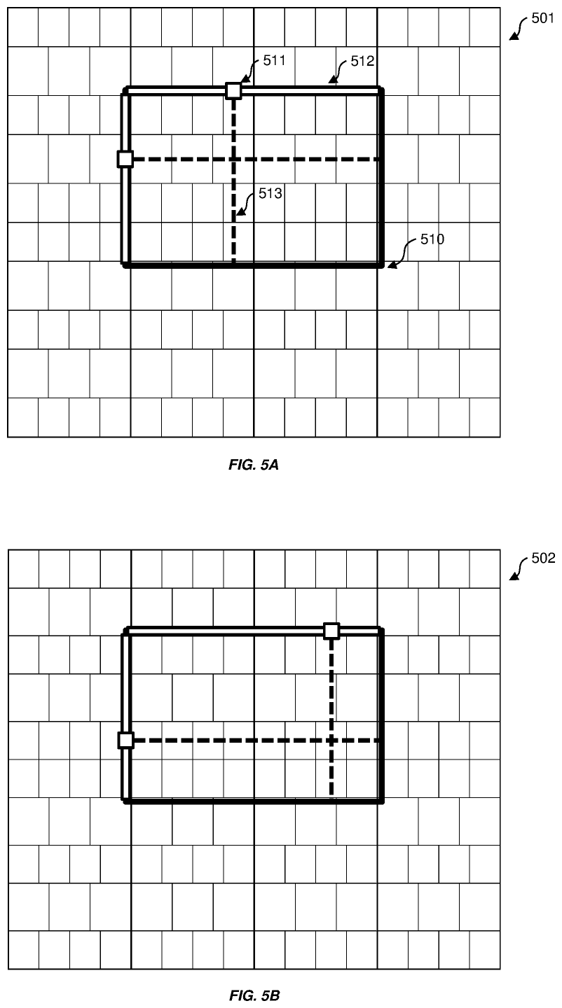

A key element in this invention is what is referred to as Pick-to-X. FIG. 5A shows a Picker Platform on a Pick Face 501. The Picker Platform 510 is attached to the PAV and can move both horizontally and vertically across the Pick Face to facilitate the Picker retrieving SKU's from the associated Bins to fulfill Orders. Attached to the Picker Platform are two Linear Actuators 512, one placed horizontally, and one placed vertically.

On these actuators are mounted two Line Lasers 511 that project laser lines 513 across the Pick Face. The intersection of the two resulting laser lines is used to designate the Bin the Picker is to make the next pick from. Also mounted on the Picker Platform are two Light Curtains on either side of the platform in front of the two Pick Faces in any given Aisle.

These Light Curtains have a two-fold purpose. First is when the Picker reaches for the designated Bin at the intersection of the laser lines, their hand breaks the Light Curtain beam. This triggers the FCA Control Software to move the two actuated Laser Lines where their intersection can designate the next Bin for the Picker to use. This is shown in FIG. 5B.

FIG. 5B is a front view of a pick window and a representation of two laser lines that, at their intersection, indicate for the picker where (from which bin) the next pick item is to be retrieved.

In combination with the moving Line Lasers, the Picker will also have a mobile communication device that will inform them of the number of Items that need to be picked from the current Bin. This device might be a head set, a heads-up display in their glasses or the like.

The second purpose of the Light Curtains is for their standard use and that is safety. This invention uses that for two additional new concepts. One is called Auto-Move and the other Auto-Drift. As discussed in Section 2, the Batch optimization process attempts to schedule Totes such that the next series of picks is in an adjacent Pick Window. This opens the opportunity for the Picker Platform to begin its movement to the next Pick Window as soon as the Picker is safe inside the Light Curtain following their last pick in that Pick Window. In addition to providing the trigger to begin a move, the Light Curtain will also be used for safety in the event the Picker happens to break the Light Curtain while it is moving. In that instance, it will trigger an immediate stop.

The self-initiating move can then be done in one of two ways. The first is as the name suggests (Auto-Move), by moving completely into the next Pick Window, which will most likely be adjacent. In this case, the only time savings that is achieved is the time it takes the Picker to return to the most recent Tote and either insert their last picked SKU or to empty the small basket used in the latest Chain Pick, but savings are savings. Following that, the Picker can grasp the PAV controls or just wait.

The biggest time savings occur in what is herein referred to as Auto-Drift. In FIG. 4, there is a shaded area in the center of the Pick Face, referred to as the Prime Area. Assuming an optimized SKU placement in the Shelving Units, the SKU's located in that area can account for 90% or more of the SKU's that make up daily Orders. Provided the Totes are sequenced in an optimal manner, it means there is a strong statistical likelihood that the Picker could reach their next Bin location by moving only partially into the adjacent Pick Window.

In that scenario, once the Picker has completed inserting SKU's into the most recent Tote, they can potentially begin to start picking again immediately as opposed to grasping the PAV controls or just waiting. This assumes the Pick Platform has just moved incrementally enough to expose the next Bin to be picked from. Therefore, it becomes feasible, particularly in the Prime Area, the Picker could just “drift” around the Prime Area picking SKU's that has had their pick sequence optimized by the Batch Picking algorithm.

The extent to which Auto-Drift is possible depends on the nature of the Orders and the SKU placement in the Pick Face. However, in the work already done on this invention, it is known it can be effective at least part of the time. Therefore, it warrants a claim as a time saving optimization.

### Section 4—System Variables

This system used in the FCA has a very high number of variables that need to be optimized and/or can affect system performance. This section will explain these variables and their impact in the system. This is done to provide a deeper insight into how the FCA system and its control software performs. In so doing, the variables will be broken up into two different type categories, Static and Dynamic. Static Variables are those that are established when the physical system is constructed. They are defined at that time and can subsequently limit system performance as the business grows. However, they can be modified with differing degrees of difficulty as required.

The second type of variable are the Dynamic Variables. These are the ones that can change from day to day and/or Batch Window to Batch Window. They include the 4 Goals addressed under Three Tier Optimization plus others that can be highly variable and/or those that can be set at the start of a Batch Window to best optimize performance.

These variables also apply to other AWS's depending on their overall design. The FCA can best leverage these variables to increase Pick Performance more than any of the other AWS's due to its design considerations. To contrast the FCA to the Multi-Robot System and later compare performance, each variable will be identified by an “F” if it applies to the FCA and an “M” if it applies to the Multi-Robot System, and FM if it applies to both. The variables are (The items numbered #1 to #4 are the goals):
Aisle Tote Storage (Long-Term—Static) (FM)—Tote Storage determines the number of Batches an Aisle can process within one Segment. The more Batches that can be realistically processed, the better the overall Pick Performance. Long-term Storage means the storage of totes that will not be required short-term by the Picker. Storage is split into long and short term to reduce costs by having multiple aisles multiplex their Tote Storage in one mechanism. This will be explained in detail in Section 5.
Shuttle Cart Tote Storage (Short Term—Static) (FM)—Depending on the sequence of Totes required to perform the Batch optimization it may be required that the Picker will require access to the same Tote in a time that is shorter than the time the Tote could be sent to long-term Storage. In these cases, the Tote must be stored on the Shuttle Cart. The time dependency is a function of where the PAV is in the Aisle and its distance from long-term Storage. In the case of the Multi-Robot Systems a Shuttle Care is not employed, this Storage is just in near proximity to the Picker.
# of Bins in Bin Wall (Static) (FM)—This determines how many orders can be placed in any one Batch. Depending on the number of Aisles assigned to the Totes in a Batch, this may end up limiting Pick Performance gains.
Size of Pick Window (Static) (F)—The current Pick Window is 8′ long and as high as a Picker can reasonably service at one time. The size of the Pick Window is thus directly tied to the size of the Picker Platform and how far a Picker may be required to walk during a stop at any Pick Window. It is currently believed 8′ provides a reasonable tradeoff between required Picker motion and the need for the Picker Platform to be physically moved. A true optimum size is a function of the PAV speed (horizontal and vertical), the average walking speed for a contingent of Pickers, and other factors. More work is required to determine that optimum.
Tote Volume (Static) (FM)—The volume of the Tote determines how many Orders it can carry on the average. The larger the number of Orders combined, the higher the probability for increased Pick Performance. The current Tote size is the industry standard which all the equipment is sized around. The tradeoff of using a larger Tote and the resulting likely increase in the cost of equipment is yet to be analyzed, but an opportunity exists there to further increase Pick Performance.
PAV and Vertical Elevator Speed (Static—Secondary Consideration) (F)—In the versions of the FCA set forth in U.S. patent application Ser. No. 16/339,473, PAV and Vertical Elevator speed (horizontal and vertical) were critical since the system was reactive to any new order and was continuously moving from one Pick Face location to another. In some embodiments of the current invention, the system remains in one location a much longer time on average. As such, the need for speed has been greatly reduced resulting in system cost savings due to the ability to use standard hardware.

(#1) Multi-Picks (Dynamic) (FM)—This and the next three items are the Four Goals already discussed. Optimizing these four variables results in the best Pick Performance possible. While Goal #1 was identified as minimizing the wasted time of Picker motion in picking one Line Item at a time, this is the same as maximizing Multi-Picks. Multi-Picks are realized by assigning Orders with a common SKU to one aisle without violating the system constraints that exist.

(#2) Chain Picks (Dynamic) (F)—As above, Goal #2 was identified as minimizing the wasted time of Picker motion in shuttling between an Aisle Bin and a Tote between every pick. This is the same as maximizing Chain Picks. Chain Picks are realized by assigning Orders with SKU's in a common Pick Window to one tote without violating the system constraints that exist.

(#3) Move Time (Dynamic) (F)—This variable can be minimized by maximizing Multi-Picks and utilizing Auto-Move/Auto Drift as much as possible.

(#4) Replenishment Time (Dynamic) (F)—The only way the system can minimize this time is to synchronize the Replenishment of any given SKU at the same time (there are multiple Tote holders on the Picker Platform) an Order pick is required for that same SKU. This is done with the Batch optimization software.
Inter-Aisle Dependencies (Dynamic) (FM)—This variable limits Batch optimization. Dependencies are due to the more Aisles that are involved, the more problematic that Order becomes for the Batch optimization software. When as Order's SKU requirements span more than one Aisle, it is possible or even likely (dependent on SKU Velocity) the Batch optimization software may want to combine SKU's from more than one Aisle into two different Multi-Picks. That is only possible if they happen to be in the same Batch, which is typically not likely. As such, one or more of the SKU's need to be left out of a Multi-Pick, thus sub-optimizing the overall results.
Inter-Pick Window Dependencies (Dynamic) (F)—This is a similar situation to the Inter-Aisle Dependencies except this is when an Order requires SKU's from more than one Pick Window. Unlike Inter-Aisle Dependencies where it may be possible to have Order SKU's from more than one Aisle involved in Multi-Picks provided they are in the same Batch, if two SKU's in an Order are in different Pick Windows one of them cannot be involved in a Multi-Pick. All this will become clearer following the example in Section 5.
Line Item Types (Dynamic) (FM)—It is important to remember in all this the Batch optimization software assigns a Line Item to a Tote and an Order to a Batch. All the line items that comprise the Orders have been identified to be one of six types. Each type needs to be handled differently by the Batch optimization software. Their abbreviations are shown below in parentheses:
   High Volume (HV)—High Dependencies (>2) (FM)—A Line Item that is part of an Order that has a large volume relative to the capacity of a Tote is very problematic. The high number of dependencies (>2) indicates the likelihood of several sub-optimized SKU's and the high volume indicates less capability to combine Orders with the HV Order and remain within the limits of the combined volume of the Batch and/or its individual Totes (all this will become clearer after the example in Section 5). Therefore, the Batch optimization software attempts to place these types of Line Items first and then optimize around them.
   Low Volume (LV)—High Dependencies (>2) (FM)—Even though Line Items may be associated with Orders with high dependencies, if those Orders have relatively low overall volume individually, they are considerably easier to handle. In these cases, the Batch optimization software tends to place these types of Line Items last into the remaining available Tote volumes of the Batches after all other Line Items have been optimized, attempting to create Multi-Picks or Chain Picks where possible.
   Anomaly (A) (FM)—On occasion an Order has one or more very-large-volume SKU(s) as a Line Item(s) to the point one Line Item almost fills the volume of a Tote. When this happens, it causes the Batch optimization software to assign an additional Tote to the Segment Totes within an Aisle (example in Section 5).
   Low Dependencies (LD) (<3) (FM)—These are the most common Line Items with Aisle dependencies (<3) and the easiest to handle, although not problem free. In these cases, the Batch optimization software attempts to assign the Order to a Batch attempting to maximize the number of Multi-Picks and/or Chain Picks. This is done by pulling in other Orders to the same Batch with SKU's common to those in the Order while at the same time maintaining constraints of # of Orders per Batch, Volume per Tote, and Totes per Segment. The problem arises when an Order is pulled into the Batch that has Line Items and those could also potentially be combined into Multi-Picks in a different Batch. At that point sub-optimization occurs. The goal is then to find the combinations that provide the most chances for optimization and the fewest for sub-optimization. This is what combinatorial optimization is intended for.
   Multi SKU (Same Aisle) (MS) (F)—These are Line Items that require SKU's from the same Aisle in their Order and are totally analogous to the LD Line Items except the Batch is replaced with the Tote. In other words, the Batch optimization software attempts to assign the Order to a Tote attempting to maximize the number of Multi-Picks and/or Chain Picks. This is done by pulling in other Orders to the same Tote with SKU's common to those in the Order while at the same time maintaining constraints of # of Orders per Batch, Volume per Tote, and Totes per Segment. The problem arises when an Order is pulled into the Tote and those could also potentially be combined into Multi-Picks in a different Pick Window. At that point sub-optimization occurs. The goal is then to find the combinations that provide the most chances for optimization and the fewest for sub-optimization. Again, this is what combinatorial optimization is intended for.
   Single SKU (SS) (FM)—These line items have complete liberty to be used however they can to best maximize Multi-Picks and Chain Picks. They can be assigned to any Batch or any Tote if system constraints are not violated. The good news is Single SKU orders seem to be increasing with the free shipping eCommerce companies offer (i.e. Prime membership at Amazon). Customers now tend to just order an Item when they need it as opposed to grouping Items to minimize shipping costs. In the data that was used to generate the example in Section 5, 56% of the orders were Single SKU Orders.
Length of Batch Window (Dynamic) (FM)—The length of the Batch Window is determined prior to running the Batch optimization but is a profound variable in its own right. As will be shown in Section 5, lengthening of the Batch Window offers a proportional increase in Pick Performance. This is another new concept referred to as Programmable Capacity and its implications can be profound for the eCommerce industry.
# of Totes per Batch (Dynamic) (FM)—This will be determined in the first steps of Batch optimization (outside CO) based on the total SKU volume in the Batch and the usable volume in the Totes.
SKU Aisle Assignment (Dynamic) (FM)—Once the total number of Totes for the entire Batch Window is determined, this will be done (also outside CO). This variable has a two-fold purpose. First for the highest Velocity SKU's, there needs to be multiple SKU placement locations in multiple Aisles. This provides additional flexibility. With this, when an Order has a Line Item that has multiple Aisle locations, the first consideration needs to be Aisle balance. In other words, some Pickers work faster than others. As such, some Pickers will complete their assigned Orders in a Batch Window faster than others. Therefore, when the next Batch Window is determined, the FCA Control Software needs to first consider Picker Performance and assign more Line Items to the faster Pickers to ensure ongoing Aisle balance. By doing this, balanced Aisle performance can continue indefinitely. Second, a Line Item can then be reassigned to a different Aisle if that will help the Batch optimization software to better maximize Multi-Picks. That would be possible if there was an MS Line Item with sub-optimization and by pulling it into the same Batch (across Aisles), optimization could then be achieved. Once the SKU Aisle assignment is complete, the number of Totes per Aisle within the Batch Window will be known.
# of Segments per Batch Window (Dynamic) (FM)—Once the number of Totes per Aisle is defined, the number of Segments will be determined by the long-term and short-term Storage available for Totes in each Aisle (also outside CO).
# of Totes per Segment (Dynamic) (FM)—This is a constraint, but also a potential optimizing variable. There is a fixed limit on the number of Totes per Segment that must be kept due to Storage limitations, however having more than one Tote in a Batch in one Aisle provides more flexibility for optimization. At the same time, the fewer aisles in a Batch, the less opportunity for sub-optimization due to Aisle dependencies. Therefore, the general rule is to have fewer Totes per Batch if possible but leverage the number of Totes per Segment where possible. This is resolved as part of the Combinatorial Optimization of the Batch optimization software.
# of Orders per Batch (Dynamic) (FM)—This is a system constraint whose cap is determined by the number of Bins in the Bin Wall and generally the desire is to have as many Orders in the Batch as possible without violating the established constraint. This cap can be significantly increased by not using the Bins in the Bin Wall for Single SKU orders. If the Single SKU Orders are left batched in single container, they can be readily segregated by just putting one SKU at a time into a box for shipping.
Volume per Tote (Dynamic) (FM)—This is a system constraint whose cap is determined by the size chosen for the Tote and the associated automation hardware available to process Totes of that size. The general rule is to use as much Tote volume as possible without violating the established constraints. While weight of the Tote is also a safety issue, this invention will assume Tote volume to be synonymous with Tote weight for this discussion.
Aisle Storage Locations (Dynamic) (F)—While these are initially established when the warehouse is set up, they are kept optimized with Dynamic Slotting which is ultimately a function of the Batch optimization software.
Aisle SKU Multiple Locations (Dynamic) (FM)—Just like the Aisle Storage Locations, these are also initially established with the warehouse is set up. They also need to be maintained as part of Dynamic Slotting.

This is a very difficult problem given all the variables to optimize and with others as constraints and/or limitations. It also quickly becomes obvious that it is impossible to realize all the available opportunities for Multi-Picks and Chain Picks. However, it will be shown there is sufficient opportunity to significantly enhance the Picker Performance, particularly for the FCA and even other AWS's.

From an overall perspective, the Batch optimization software will tie down variables in the system constrained by system limitations like Storage and then proceed to optimize the assignment of Orders to Batches while abiding by the three constraints identified. The assignment of Orders to Batches defines the Aisle assignments and the SKU's in the Order define the Tote assignments (i.e. once an Order is assigned to a Batch, the software also needs to assign the SKU's in that Batch to the Totes involved). In general, it also assumes the typical usage of one Tote per Aisle to one Batch, barring anomaly assignments. To the extent multiple Totes are assigned to one Batch within one Aisle, more opportunity arises to optimize assignments, but complexity arises as well.

### Section 5—Main Algorithm with Example

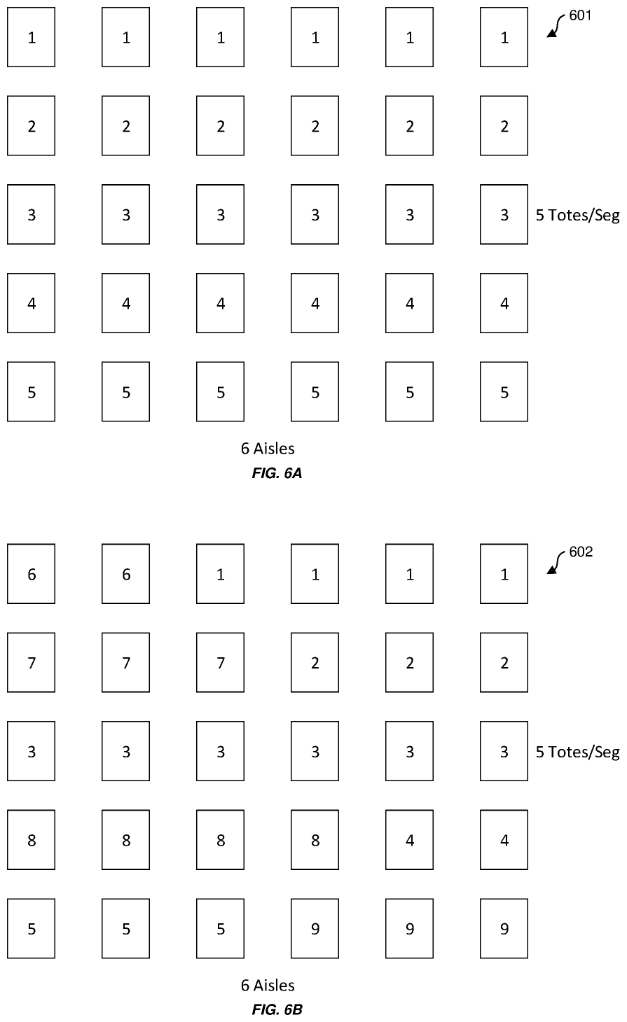

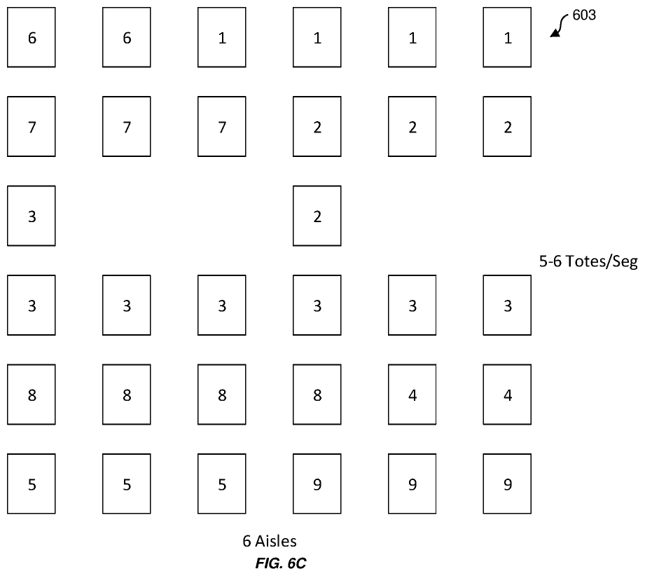

The primary purpose of the software is to optimize Batches for the FCA. FIG. 6A shows one example of the most basic Batch assignment 601. In this case there are a total of 5 Batches in six Aisles. Each Batch consists of one Tote per Aisle. As a result, there are 5 Segment Totes in each Aisle. Having one Tote from every Aisle in theory allows the Batch optimization software to handle any type of Aisle dependency since every Aisle is represented. In some cases, one or two of the Totes in any given Batch may not have their volumes optimally utilized, but this configuration is key since it demonstrates that no Batch assignment is impossible because this type of arrangement is always available.

FIG. 6B then shows what may end up being a more typical configuration 602 where there are still 5 Segment Totes in each of the 6 Aisles but there is a total of 9 Batches with each one ranging in size from 2-6 Totes. This would be a more standard scenario where the number of Segment Totes within each Aisle are kept be around the same number.

FIG. 6C then shows the most likely scenario 603. This is when there are still 9 Batches across the 6 Aisles, but some Aisles have more Segment Totes, in this case the 1^{st} and 4^{th} Aisles. These additional Totes could be a result of an Anomaly or a Batch that required an additional Tote in each Aisle. While there are certainly other scenarios, these three demonstrate the basic nature of Batches optimized by the software for the FCA and/or other AWS's.

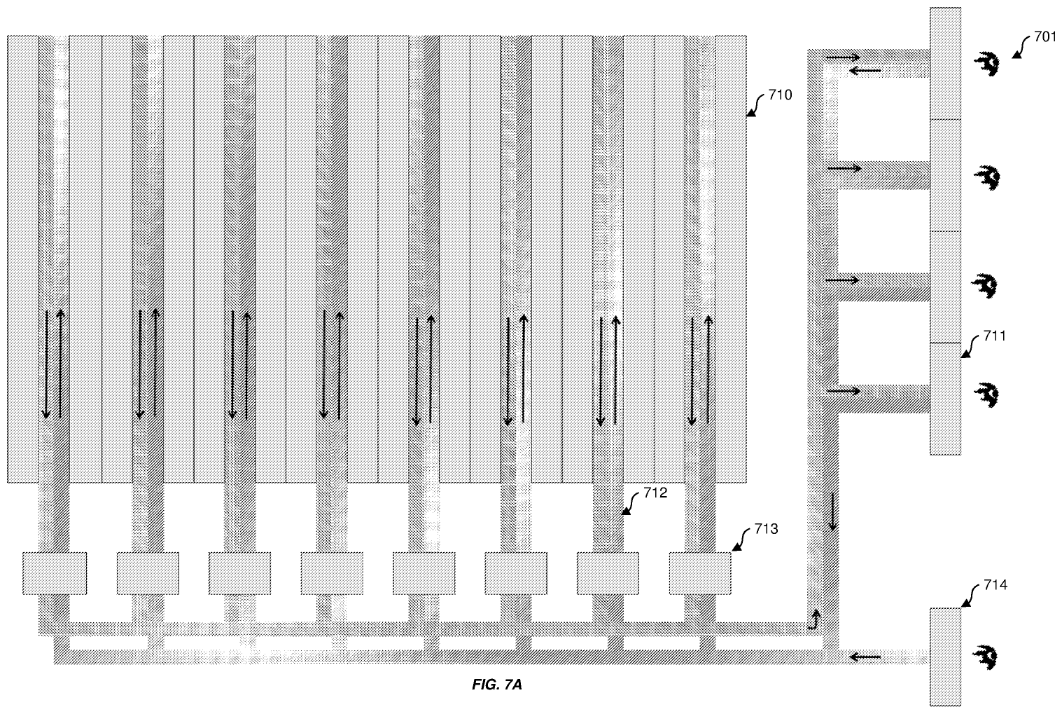

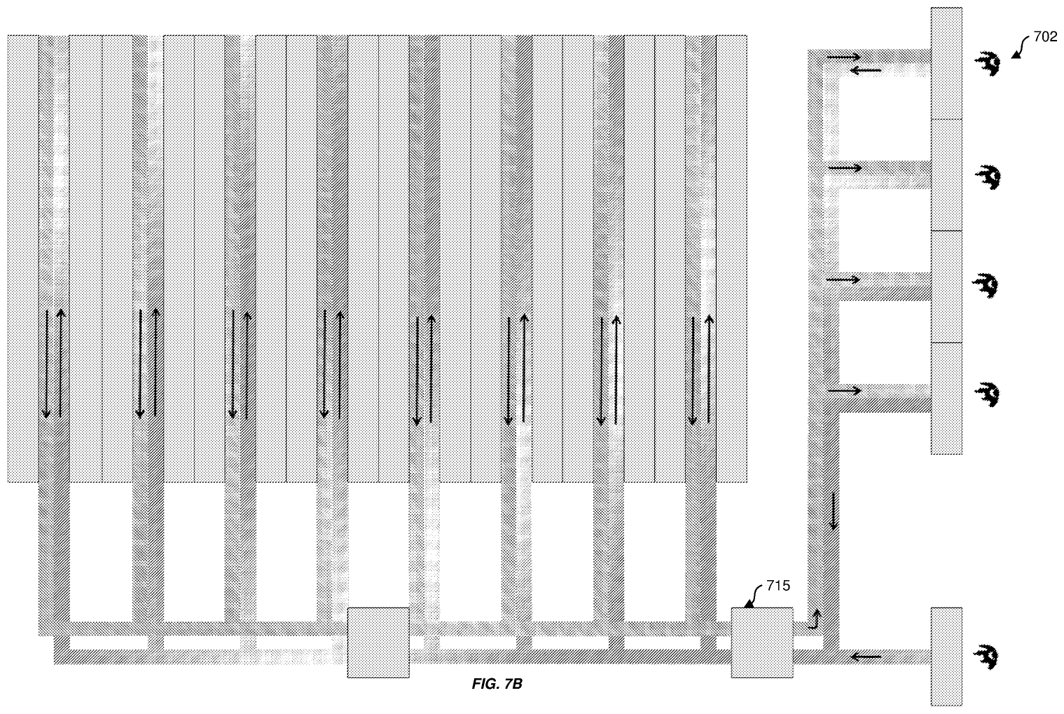

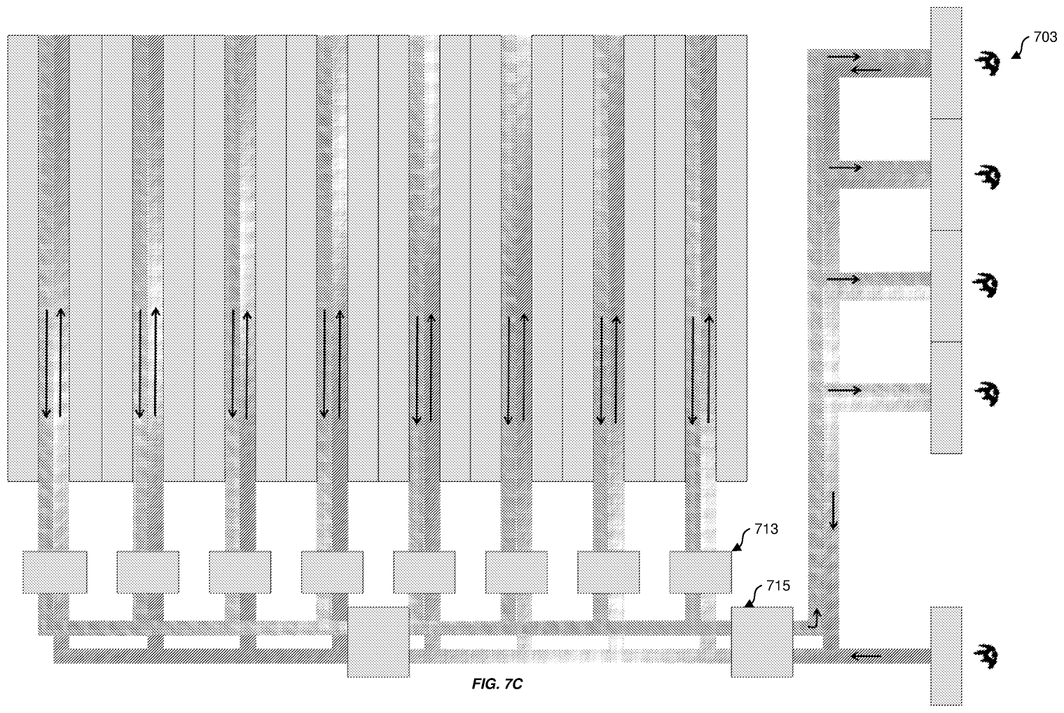

As described previously, the Batch optimization algorithm cannot be accomplished alone, it requires Tote Storage, a multiplicity of Totes, automated Conveyors, and the associated control software. FIG. 7A shows the preferred embodiment 701 for the FCA. It consists of the warehouse Aisles 710, the associated bidirectional Conveyors 712, the Bin Walls 711, and the Mini-ASRS's acting as long-term Storage for that embodiment. The PAV and the Shuttle Cart which it tows, and which provides the short-term Storage, are not shown in the diagram since they are mobile devices that constantly traverse the Aisles. Their details are shown in FIG. 10B and described below in this section.

FIG. 7B shows a cost-reduced configuration 702 for the FCA. In this scenario the mini-ASRS's that provide long-term Tote Storage to the Aisles are replaced with larger units 714 that consolidate the Storage and serve multiple Aisles at a time to reduce cost. FIG. 7C shows the configuration that would be required for the Multi-Robot Systems. In these instances, the Picker resides at the end of each automated Aisle 715 and is serviced by some type of short-term Storage module 716. While that device could also provide long-term Storage, the cost-reduced consolidated versions 717 are shown.

The example to demonstrate the results of the algorithm is based on a simulation using data modeled from an actual Fulfillment Center. Therefore, the example has a solid foundation in reality. The example aggregates Orders over a one-hour period (the Batch Window). This results in 405 orders with 527 Line Items for the Aisle that will be simulated in the example and a corresponding 498 Line Items from the other Aisles those 405 Orders are dependent on. Only the results from one Aisle are shown to make the results significant (one-hour Batch Window with a high number of required picks) enough to demonstrate viability, yet small enough to publish in this document and understand. The results from the entire warehouse model are just not tractable for this purpose.

There are 4314 Bins in the Aisle with 6452 different SKU's, 1394 of which also have placements in other Aisles. In the one hour, there were 119 Single SKU Orders, a 29.4% result. This is well below the overall data average of 56.1%. This data was intentionally chosen to provide a scenario that was the most challenging by minimizing Single SKU Orders which have no challenge in their Batch assignments. In addition, 48.6% of the orders have dependencies from other Aisles while the overall data average is only 41.1%. Again, this was done to make the example the most challenging, yet realistic.

As discussed, the algorithm is intended to be one utilizing Combinatorial Optimization but can also be optimized using standard structured programming. A 23-step algorithm is used to guide that type of programming. A plurality of different types of Combinatorial Optimization (C)O) algorithms can be used to provide optimized results. The specific algorithm that provides the most optimal results is still being investigated. However, the results from any of the CO algorithms and even the structured programming provide results that demonstrate startling improvement in Pick Performance.

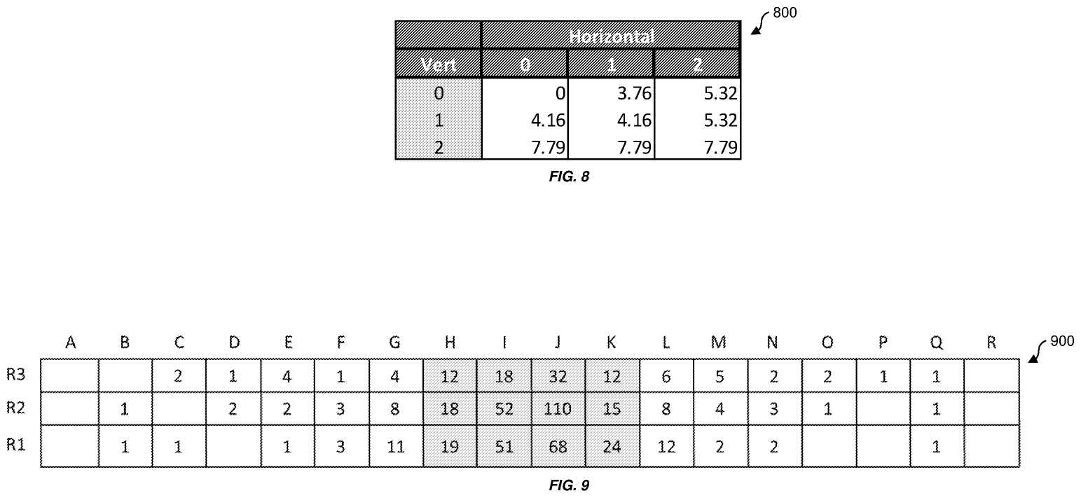

FIG. 8 shows a table 800 with the move times that are required to do the simulation for the example. FIG. 9 shows the Pick Windows in the Pick Faces of the Aisle whose data was simulated. Relative to the table showing the move times, it should be noted that no moves of the Picker Platform are required that move more than 2 columns and 1 row. FIG. 9 also shows the Prime Area of the Pick Face. It also shows how the 527 Line Items that constitute the example in this document are distributed over the Pick Face, recalling there is a Pick Window on each side of the Aisle. Therefore, the numbers represent two Pick Windows simultaneously accessible by the Picker.

FIG. 10A show the routes 1000 the Picker Platform must follow in each of the 3 Segments for the Batch Window example provided in this document.

While the Batch Window for the example has a duration of 1 hour, it was broken up into 3 Segments. Those three Segments are shown in FIG. 10A combined with the route 1000 the Picker Platform follows in the example. When the Three Tier Optimization process was discussed, it was noted the intent of the final step was to absolutely minimize the travel from one Pick Window to the next. In FIG. 10A, it can be seen the route for the example starts in position D2 (Column-Row) and ends in N2. There are 81 total moves, 71 adjacent, 9 diagonals, and only one where a move more than one row and one column is required.

FIG. 10B is a perspective view of an FCA system 1002 that is usable with some embodiments of the present invention. In some embodiments, the pick items are placed in bins 1027 located across pick face 1028 of bin shelves 1020 along the side of aisle 1041. A picker 1021 (e.g., in some embodiments, a human picker) is supported on pick platform 1022 that is moved horizontally and vertically by mobile picker platform mechanism 1023. In some embodiments, horizontal conveyors 1024 move totes 1030 to and from tote-buffer automated storage and retrieval system (ASRS) 1026 that includes one or more elevators 1029 (vertical conveyors) that lift totes 1030 off horizontal conveyors 1024 and then return the appropriate totes 1030 back to horizontal conveyors 1024 in the appropriate sequence order, which then move totes 1030 to and from vertical conveyors 1025 that then convey totes 1030 to and from the picker 1021. The boundary of pick window 401 at this point in time is shown in dashed lines and represents those bins that picker 1021 can easily reach with pick platform 1022 at its present position. The boundary of pick window 401 moves with pick platform 1022 and continues to represent those bins that picker 1021 can easily reach with pick platform 1022 any point in time. The shading on diagram 300 represents the velocity (rate of product turnover) of the pick items (products) located in the various bins 1027, wherein the darker shading near the center represents higher-velocity pick items (higher turnover) and light shading near the center represents lower-velocity pick items (lower turnover).

FIG. 10C is a top view of a simulation 1003 of system 1002 at ten successive time periods 1030-1039 performing the tote movements and item picks, according to some embodiments of the present invention.

FIG. 10D is a top view of a simulation 1004 of system 1002 at ten successive time periods 1040-1049 performing the tote movements and item picks, according to some embodiments of the present invention.

FIG. 10E is a top view of a simulation 1005 of system 1002 at ten successive time periods 1050-1059 performing the tote movements and item picks, according to some embodiments of the present invention.

FIG. 10F is a top view of a simulation 1006 of system 1002 at ten successive time periods 1060-1069 performing the tote movements and item picks, according to some embodiments of the present invention.

FIG. 10G is a top view of a simulation 1007 of system 1002 at ten successive time periods 1070-1079 performing the tote movements and item picks, according to some embodiments of the present invention.

FIG. 10H is a top view of a simulation 1008 of system 1002 at ten successive time periods 1080-1089 performing the tote movements and item picks, according to some embodiments of the present invention.

Outline 1 below shows a summary of the software used in the example for the Combinatorial Optimization algorithm. Since a plurality of the different standard Combinatorial Optimization algorithms (such as the already-mentioned Greedy Algorithms, Approximation Algorithms, Local Search, Metaheuristic methods like Tabu Search, Simulated Annealing, Large Neighborhood Search, Very Large-Scale Neighborhood Search, Genetic Algorithms, Ant Colony Optimization, etc.) can be used in the solution for the example, the generic form of the pseudocode is shown. Persons of skill in the art will readily implement this generic form of the pseudocode using any of the standard Combinatorial Optimization algorithms for the present invention.

Outline 1

| | |
|---|---|
| 1. | Outline 3 Start (FM) |
| 2. | Obtain BW of orders (FM) |
| 3. | Assess total volume (FM) |
| 4. | Determine # of totes per batch (FM) |
| 5. | Allocate orders (SKUs) to each aisle, considering picker |
| | performance (FM) |
| 6. | Determine # segments based on storage & bin wall capacity (FM) |
| 7. | Repeat using CO* algorithm of choice with constraints until |
| | termination criteria met (FM) |
| | Assign high aisle dependency orders with nesting (FM) |
| | Assign high volume orders and determine if anomaly totes needed (FM) |
| | Assign low dependency orders (start with orders with SKUs with high multi- |
| | picks working down) (FM) |
| | Assign single aisle orders with multiple SKUs from that aisle (F) |
| | Assign single SKU orders (SS0) (FM) |
| | Assign high aisle dependency orders with low volume as fill-ins (FM) |
| 8. | Take the best solution as output (FM) |
| 9. | Minimize route using selected CO algorithm (F) |
| 10. | End (FM) |

*Combinatorial Optimization

Outline 2
Constraints

| | |
|---|---|
| 1. | Maximize Multi-Picks per tote (FM) |
| 2. | Minimize # of PW′s per tote (Max CP′s) (F) |
| 3. | Minimize move time (Min route) (F) |
| 4. | Maintain totes per segment limit (FM) |
| 5. | Maintain batch order limit (FM) |
| 6. | Maintain acceptable tote volume (FM) |

Outline 1 and Outline 2 shown above were used as guidelines for the software that implements the Batch Window example provided in this document. The pseudocode in Outline 1 assumes certain high-level steps and the implementation of a constrained Combinatorial optimization algorithm using the identified constraints in Outline 2.

Much information was already provided about the functioning of the software in the discussion of the variables. However, that information will be reiterated below now in the proper sequence combined with additional steps to provide sufficient information to understand the pseudocode in Outline 1. The software proceeds as such:
Determine Length of Batch Window—The length of the Batch Window is determined prior to running the Batch Combinatorial Optimization (CO). It is generally a function of the order rate and determined by the staff of the Fulfillment Center. For the example the Batch Window is one hour.
Assess Total Volume—Once the Batch Window is set, the total volume of all the aggregated Orders is calculated. For the example the total volume of the 405 Orders in the Aisle is 1236.87 dm³.
Determine # of Totes per Batch—This will be determined outside the CO based on the total SKU volume in the Batch and the usable volume in the Totes. For the example there are 45 Totes for the 405 Orders in the Aisle where each Tote will average 45.8% full. This percentage takes into consideration that the SKU's will be jumbled in the Tote.
SKU Aisle Assignment—Since the example only consists of one Aisle, the SKU assignment was predetermined in preparation to create the example. The methodology applied was discussed in Section 4.
Determine # of Segments per Batch Window—Once the number of Totes per Aisle is defined, the number of Segments will be determined by the long-term and short-term Storage available for Totes in each Aisle outside the CO. For the example there are 3 Segments.
Perform the Batch Optimization Using CO Algorithm of Choice—The function of the CO algorithm is to optimize the assignment of Orders to Batches while abiding by the constraints Outline 2 identified. The assignment of Orders to Batches defines the Aisle assignments and the SKU's in the Order define the Tote assignments (i.e., once an Order is assigned to a Batch, the algorithm also assigns the SKU's in that Batch to the Totes involved). The algorithm proceeds in the following order, repeating the cycle until a satisfactory termination criterion is met. This could be a percentage of the potential Multi-Picks achieved, a percentage of the potential Chain Picks achieved, some time limit, or a combination of any of them. The order is:
   High Volume (HV)—High Dependencies (>2)—The Batch optimization software attempts to place Orders with these types of Line Items first and then optimize around them.
   Anomaly (A)—On occasion an Order has a very large volume SKU(s) as a Line Item(s) to the point one Line Item almost fills the volume of a Tote. When this happens, it causes the Batch optimization software to assign an additional Tote to the Segment Totes within an Aisle.
   Low Dependencies (LD) (<3)—The Batch optimization software attempts to assign Orders with these types of Line Items to a Batch attempting to maximize the number of Multi-Picks and/or Chain Picks. This is done by pulling in other Orders to the same Batch with SKU's common to those in the Order while at the same time maintaining constraints of # of Orders per Batch, Volume per Tote, and Totes per Segment. The problem arises when an Order is pulled into the Batch that has Line Items and those could also potentially be combined into Multi-Picks in a different Batch. At that point sub-optimization occurs. The goal is then to find the combinations that provide the most chances for optimization and the fewest for sub-optimization.
   Multi SKU (Same Aisle) (MS)—These are Orders with Line Items that require SKU's from the same Aisle in their Order and are totally analogous to the LD Line Items except the Batch is replaced with the Tote. In other words, the Batch optimization software attempts to assign the Order to a Tote attempting to maximize the number of Multi-Picks and/or Chain Picks. This is done by pulling in other Orders to the same Tote with SKU's common to those in the Order while at the same time maintaining constraints of # of Orders per Batch, Volume per Tote, and Totes per Segment. The problem arises when an Order is pulled into the Tote and those could also potentially be combined into Multi-Picks in a different Pick Window. At that point sub-optimization occurs. The goal is then to find the combinations that provide the most chances for optimization and the fewest for sub-optimization.
   Single SKU (SS)—Orders with these line items have complete liberty to be used however they can to best maximize Multi-Picks and Chain Picks. They can be assigned to any Batch or any Tote if system constraints are not violated.
   Low Volume (LV)—High Dependencies (>2)—The Batch optimization software tends to place these types of Line Items last into the remaining available Tote volumes of the Batches after all other Line Items have been optimized, attempting to create Multi-Picks or Chain Picks where possible.
Take the Best Solution at Output—Following the use of the CO, all the Orders have been highly optimized in their assignment to a Batch and its Totes as shown in the representative Tables of FIGS. 11A-11B. Details of this output will be discussed below.
Minimize the Route Using Selected CO Algorithm—This optimization becomes trivial as was shown in FIG. 10. Any number of CO algorithms can readily obtain that result. The representative result for the first Segment is shown in FIGS. 12A-12B and will be discussed below.

FIGS. 11A-11B are tables 1101-1102 with representative data that was used in the Batch optimization process and the results of the process. That data is:
Column 1 (Record Number)—This is just a reference for the 527 records in the table, one for every Line Item in the 405 Orders in the Batch Window.
Column 2 (Order ID)—This is the identifier for the 405 unique Orders in the Batch Window.
Column 3 (Item ID)—This is an identifier for the SKU that comprises the Line Item. There are 310 unique SKU's.
Column 4 (Count)—This is the number required of the SKU specified in Column 3 to fulfill the Line Item associated with that record.
Column 5 (Column)—This is the column of the Pick Window in the Pick Face where the SKU is located.
Column 6 (Row)—This is the row of the Pick Window in the Pick Face where the SKU is located.
Column 7 (In Aisle SKU's)—This is the number of additional SKU's in the same Aisle as the SKU of the Line Item that are required to fulfill the Order associated with that Line Item. This value determines possible Pick Window dependencies (some of the other SKU's might be in the same Pick Window).
Column 8 (Out Aisle SKU's)—This is the number of additional SKU's outside of the Aisle as the SKU of the Line Item that are required to fulfill the Order associated with that Line Item. This value determines Aisle dependencies.
Column 9 (In Volume)—This is the volume of all the SKU's in the same Aisle as the Line Item SKU required to fulfill the Order associated with the Line Item.
Column 10 (Out Volume)—This is the volume of all the SKU's outside of the Aisle of the Line Item SKU required to fulfill the Order associated with the Line Item.
Column 11 (In Probability)—This is the ranking of the Velocity of the SKU identified with the Line Item with 1 being the highest Velocity SKU in the Fulfillment Center. This value can be used in deciding priority of SKU groupings in Batches.
Column 12 (Out Probability)—This is the ranking of the highest Velocity of the SKU's outside of the Aisle identified with the Line Item with 1 being the highest Velocity SKU in the Fulfillment Center. This value can be used in deciding priority of SKU groupings in Batches.
Column 12 (Tote)—This is Tote the SKU associated with the Line Item has been assigned to. The number following the “S” identifies the Segment the Tote is in and the number following the “B” identifies the Batch within that Segment recalling there are 3 Segments and 15 Totes per Segment. In this case, there is only one Batch associated with every Tote, resulting in 15 Batches in every Segment. This value is the result of the optimization process.
Column 14 (Dependencies)—This identifies all the Pick Windows in the same Aisle the Order associated with the Line Item has dependencies on. This value combined with the value in Column 7 is used to determine the number of Pick Window dependencies.
Column 15 (Type)—This identifies the type of the Line Item record consistent with the type descriptions provided in Section 4. The type definitions provided in Section 4 can be referred to combined with the values in the columns to better understand those specific definitions.

With the Tote assignments identified in the representative Tables of FIGS. 11A-11B, the route optimization was done which subsequently combined all the Multi-Picks, identified all the Chain Picks, and did the routing shown in FIG. 10. This resulted in the representative Pick List for the first Segment shown in FIGS. 12A-12B. These are the specific instructions to the PAV on where to move the Picker Platform and when, as well as the specific instructions to the Picker on which SKU's to pick in each Pick Window.

The FCA Control Software will then control the system to present the Totes to the Picker in the right sequence. Besides the representative Pick List information, FIGS. 12A-12B provide additional data from the simulation done for the example. These additional values will reinforce all the elements previously discussed in this document. It should also be noted that each figure represents data for the first Segment only. The values in those tables are:
Column 1 (Record Number)—This is just a reference for the 359 records in the table, one for every pick required for 405 Orders in the Batch Window.
Column 2 (Column)—This is the column of the Pick Window in the Pick Face where the SKU is located.
Column 3 (Row)—This is the row of the Pick Window in the Pick Face where the SKU is located.
Column 4 (Tote)—This is Tote the SKU associated with the Line Item has been assigned to. The number following the “S” identifies the Segment the Tote is in and the number following the “B” identifies the Batch within that Segment recalling there are 3 Segments and 15 Totes per Segment.
Column 5 (Item ID)—This is an identifier for the SKU that comprises the Line Item. There are 310 unique SKU's.
Column 6 (Count)—These are the number of Multi-Picks associated with the associated pick record.
Column 7 (Items)—This is the number required of the SKU's specified in Column 5 required to fulfill the Line Item(s) associated with that record.
Column 8 (Elapsed)—This is the elapsed time for the example simulation. It is the sum of any move time, pick time, and additional replenishment time.
Column 9 (Move Time)—This is the move time associated with that pick record. The example assumed both the use of Auto-Move and Auto-Drift (with 70% effectiveness). This means that Picker Platform started to move immediately after the last pick in that Pick Window. If a move time is shown, it is the remainder of the simultaneous motion of the picker from the move times shown in the table of FIG. 8. If a “0” is shown, that means Auto-Drift was applied, but only 70% of the time.
Column 10 (Pick Time)—This is the pick time associated with the pick record. A standard pick time of 4 seconds was used plus any additional motion required to complete the pick. A pick time of 3 seconds was used for the Chain Picks. If a large number of Items needed to be picked to fulfill all the Orders associated with the pick, additional time was added.
Column 11 (Replenishment Time)—This is the amount of additional time required for a Replenishment recalling that an associated pick of the same SKU is performed in sequence with the Replenishment action resulting in less wasted time. It should also be noted that there are multiple Totes available to the picker on the Picker Platform to facilitate these actions, in this case 4 as compared to the 2 in the original FCA concept.
Column 12 (Aisle Side)—This identifies which side of the Aisle the Bin associated with the SKU is located.
Column 13 (Total Cycle Time)—This is the total time that specific Tote is serviced. Examining this column, the reduced dependency on system speed becomes evident. The picker can spend much more time in one position than in the previous version of the FCA.
Column 14 (Next Tote Use)—This column identifies the time of the next use for a Tote following its service completion by the picker on the Picker Platform. It can be seen many Totes are not needed again for a considerable time. When the position of the PAV is considered, a Tote can take from 5 to 53 seconds to reach the Tote Storage that is shown in FIG. 7A. As such, it becomes obvious that some Totes cannot be allowed to depart the PAV (i.e. short-term storage) before their next use while others can safely return to long-term Storage at the end of the Aisle. This is a key element of the invention and that is the need for short-term Storage near the picker. Looking down the data, several 0's can be seen. These are all the Chain Pick opportunities.
Column 15 (# of Totes)—This is the number of Totes that are required to be in short-term Storage at that specific moment. Per the data, 4 Totes are required in Segment 1, 7 Totes in Segment 2, and 6 Totes in Segment 3. It is assumed the Batch optimization process can be further improved to help reduce these peak numbers, but some short-term Tote Storage will be required regardless. That means the Tote Shuttle of the FCA will need to be modified to add some additional Storage. That modification is outside the scope of this invention but is simply done.

While the representative data in tables 12A-12B was obtained in simulation, it might be assumed the numbers could be fabricated. On the contrary, it is possible to take all the Tote assignments in those tables, generate an Order list for every Tote, then manually calculate the pick and move times (using table in FIG. 8) and obtain the same results. The point is, these results absolutely demonstrate the results which can be expected from the algorithm.

The table 1300 in FIG. 13 is a summary of the volume of SKU's in each Tote for the 45 Totes and the total number of Orders in each for the Batch Window used in the example. This data could be verified by doing the respective sums of the corresponding data in the representative tables from FIGS. 12A-12B. There were what appeared to be two anomalies relative to the volume and they are Totes S2B11 and S2B13, both of which have volumes in excess of 60 dm³. These are both individual Orders one of 12 SKU's and the other 15 SKU's. Additional Totes could have been added to the Segment, but it was opted to keep all the Segment Totes at 15 for simplicity.

### First Part of the Invention Summary & Conclusions

This First Part of the Invention represents the opportunity for significant Pick Performance improvement for AWS's but particularly the FCA. In the example cited, 527 Line Items were reduced to 359 picks, 181 Chain Picks were realized, and the overall move time was reduced considerably. This resulted in 85.2 seconds of move time, 1608 seconds of pick time and 208 seconds of additional Replenishment time with a Pick Performance of 998 Picks/Hour. This is almost double the performance of its next best competitor.

In comparison, the system in the initial FCA concept would have required 2311 seconds of move time, 1909 seconds of pick time, and 636 seconds of Replenishment time with a Pick Performance of 391 Picks/Hour. This First Part of the Invention results in at least a 250% improvement in Pick Performance over the original FCA.

It should also be noted that only 168 of 217 Multi-Pick opportunities were achieved for a 77.4% Optimization Efficiency. In the case of Chain Pick, only 181 of 314 possible Chain Picks were realized for a 57.6% Optimization Efficiency. While this is an optimized result, it is not optimal. The anticipation is that a 90% Optimization Efficiency can be reached for both Multi-Picks and Chain Picks, realizing 100% efficiency is not possible. If so, the Pick Performance of the FCA could exceed 1500 Picks/Hour. This is performance unheard of in the industry.

Of significant note in this First Part of the Invention is the use of the Batch Window duration to positively impact Pick Performance. Based on actual Fulfillment Center data for one day, if Orders were aggregated over 10-minute periods, the average maximum Pick Performance improvement based only on pick time savings would be 7.2%. If Orders were aggregated over 1-hour periods, the average maximum Pick Performance improvement based only on pick time savings would be 31.3%. On the other hand, if Orders were aggregated over the entire day, the maximum Pick Performance improvement based only on pick time savings would be 293.5%.

The maximum pick time savings were calculated by determining the number of different SKU's and the associated number of Orders over the respective time periods. For example, for the day there were 5540 Line Items in the Orders for the day comprised of 1408 SKU's. That is a Pick Performance of 230.8 Picks/Hour versus 908.3 Picks/Hour or a 293.5% increase assuming a 100% Optimization Efficiency (the maximum) (i.e. one pick for every SKU type). In the case of the smaller time periods, the maximum Pick Performances for each time period were averaged over that number of time periods in the day (i.e. 24 for hours).

This all opens the possibility of what is called Programmable Capacity. By aggregating Orders over longer periods, the Pick Performance can be made to increase. This obviously causes increasing shipping delays but can be used effectively in times of heavy Orders such as the Holiday Season. In today's processes, if there are more Orders than Fulfillment Center capacity, the Fulfillment Center gets progressively behind. By using Programmable Capacity, the backlog can eventually be erased with less overall delay. There is a limitation however in system resources like available Tote Storage capacity and Bin Wall capacity.

While the improvements defined in this First Part of the Invention work most effectively for the FCA, they can also be used for other AWS's to a lesser degree, dependent on the features of the system. We will use the Multi-Robot System as a comparison. If that system were used for the example provided in this document the time required to complete the Orders would be 1:19:03. This assumes a 400 Picks/Hour over 527 Line Items (picks).

In the case of the Multi-Robot System, it can only benefit from the Multi-Picks, but not the potential improvement coming from Chain Picks or move time improvements. This is due to their design which only presents one container (SKU) at a time to the Picker. As such, there are no opportunities for Chain Picks. Likewise, the mechanical movement in the system cannot be further reduced and is already done in parallel with other Picker motion.

Nonetheless, if one assumes a 90% Optimization Efficiency for the Multi-Picks for the example, the number of picks would be reduced from 527 to 333 picks. This would increase the Pick Performance from 400 Picks/Hour to 633 Picks/Hour, a 58% increase. However, the system would need to be modified to include the Tote Storage and the Conveyors as shown in FIG. 7C. The point is, this invention can also be very impactful to other AWS's, but not as impactful as it is to the FCA.

In some embodiments, the present invention provides an apparatus that includes:

a computer system that includes:

a storage system,

a receiver that receives a first plurality of commercial orders and stores the plurality of orders to the storage system, wherein each respective order of the plurality of commercial orders specifies one or more items to be picked for that respective commercial order,

a batch aggregator that organizes the first plurality of commercial orders into a first plurality of batch windows, wherein a first subset of the first plurality of batch windows is initially associated with a first aisle of a warehouse, and wherein each commercial order specifies one or more pick items,

a path optimizer that generates an ordered sequence of pick-operation specifications associated with each batch window of the first subset of the first plurality of batch windows that is associated with the first aisle in order to optimize a throughput of commercial orders during each of a plurality of sequential time periods, and

a tote sequencer that generates an ordered sequence of tote identifiers corresponding to the sequence of pick-operation specifications associated with each batch window of the first plurality of batch windows that is associated with the first aisle.

Some embodiments of apparatus further include:

a first mobile picker platform that moves a picker to a sequence of pick locations along the first aisle of the warehouse according to the sequence of pick-operation specifications; and

a first tote-delivery system that delivers a first sequence of totes to the mobile picker platform in the first aisle of the warehouse according to the ordered sequence of tote identifiers.

In some embodiments of the apparatus, a second subset of the first plurality of batch windows is initially associated with a second aisle of the warehouse, the path optimizer generates a second ordered sequence of pick-operation specifications associated with each batch window of the second subset of the first plurality of batch windows that is associated with the second aisle, and the tote sequencer generates an ordered sequence of tote identifiers corresponding to the sequence of pick-operation specifications associated with each batch window of the first plurality of batch windows that is associated with the first aisle, and the apparatus further includes:

a first mobile picker platform that moves a picker to a sequence of pick locations along the first aisle of the warehouse according to the sequence of pick-operation specifications;

a first tote-delivery system that delivers a first sequence of totes to the mobile picker platform in the first aisle of the warehouse according to the ordered sequence of tote identifiers;

a second mobile picker platform that moves a picker to a sequence of pick locations along the second aisle of the warehouse according to the second ordered sequence of pick-operation specifications; and

a second tote-delivery system that delivers a second sequence of totes to the mobile picker platform in the second aisle of the warehouse according to the second ordered sequence of tote identifiers.

In some embodiments of the apparatus, a second subset of the first plurality of batch windows is associated with a second aisle of a warehouse, wherein the computer system tracks performance of a picker in the first aisle and tracks performance of a picker in the second aisle, and based on the tracked performance of the picker in the first aisle, automatically shifts some of the first plurality of batch windows initially associated with the first aisle to instead be associated with the second aisle, wherein a plurality of items having the same SKU are stocked in both the first aisle and in the second aisle.

In some embodiments of the apparatus, the batch aggregator and the path optimizer are software routines that use a combinatorial optimization routine.

Some embodiments of apparatus further include:

a first mobile picker platform that moves a picker to a sequence of pick locations along the first aisle of the warehouse according to the sequence of pick-operation specifications; and

a first tote-delivery system that delivers a first sequence of totes to the mobile picker platform in the first aisle of the warehouse according to the ordered sequence of tote identifiers,

wherein the first aisle includes at least a first pick face having a plurality of defined pick windows, wherein each respective pick window has one or more bins that are reachable by the picker when the first mobile picker platform is stopped at a location associated with that respective pick window,

wherein, for a first tier of optimization, those pick items having highest pick velocities of the pick items on the first pick face are located in bins nearest one another in one or more pick windows at a center area of the first pick face and other pick items having successively lower pick velocities are located in bins of pick windows of the first pick face successively more distant from the center area,

wherein, for a second tier of optimization, the computer system specifies to the picker a plurality of bin locations for a plurality of pick items that are to be chain picked for a given tote while the first mobile picker platform is stopped at the location associated with a given pick window, and

wherein, for a third tier of optimization, the computer system determines an optimal route that specifies a sequence of pick windows that minimizes a distance moved by the first mobile picker platform and specifies a sequence of tote delivery times corresponding to the specified sequence of pick windows.

In some embodiments of the apparatus, following the picker's last pick in a current pick window of the plurality of pick windows, the computer system specifies an auto-move movement of the first mobile picker platform from the current pick window to a next pick window as soon as the picker is safe inside a light curtain of the first mobile picker platform.

In some embodiments of the apparatus, the plurality of defined pick windows includes a plurality of partially overlapped pick windows, and wherein the computer system specifies an auto-drift movement of the first mobile picker platform from one of the plurality of partially overlapped pick windows to an adjacent partially overlapped pick window.

In some embodiments of the apparatus, the computer system specifies to the picker a plurality of bin locations for a plurality of pick items that are to be chain picked to a container carried by the picker for a given tote while the first mobile picker platform is stopped at the location associated with a given pick window, in order to minimize back-and-forth motion of the picker between bins of the given pick window and a tote associated with the given pick window.

In some embodiments of the apparatus, the first tote-delivery system includes:

a horizontal conveyor,

a vertical conveyor associated with the first mobile picker platform, and

a tote-buffer automated storage and retrieval system (ASRS) configured to receive a plurality of totes from the horizontal conveyor, temporarily hold, and selectively return totes of plurality of totes,

wherein the horizontal conveyor moves the first sequence of totes from the tote-buffer ASRS to a horizontal location of a vertical conveyor associated with the first mobile picker platform, and wherein the vertical conveyor and the first mobile picker platform together move the first sequence of totes to a sequence of horizontal-vertical locations according to the first ordered sequence of pick-operation specifications.

In some embodiments, the present invention provides a computerized method that includes:

receiving, into a computer system, a first plurality of commercial orders, wherein each respective order of the plurality of commercial orders specifies one or more items to be picked for that respective commercial order;

storing the plurality of orders to a storage system of the computer system;

organizing, in the computer system, the first plurality of commercial orders into a first plurality of batch windows, wherein at least some of the first plurality of batch windows are associated with a first aisle of a warehouse;

generating, in the computer system, an ordered sequence of pick-operation specifications associated with each batch window of the first plurality of batch windows that is associated with the first aisle in order to optimize a throughput of commercial orders during each of a plurality of sequential time periods; and

generating, in the computer system, an ordered sequence of tote identifiers corresponding to the sequence of pick-operation specifications associated with each batch window of the first plurality of batch windows that is associated with the first aisle.

Some embodiments of the method further include:

under control of the computer system, moving a mobile picker platform that supports a picker to a sequence of pick locations according to the sequence of pick-operation specifications; and

under control of the computer system, delivering a first sequence of totes to the mobile picker platform according to the ordered sequence of tote identifiers.

Some embodiments of the method further include:

moving a mobile picker platform that supports a human picker to a sequence of pick locations according to the sequence of pick-operation specifications; and

delivering a first sequence of totes to the mobile picker platform according to the ordered sequence of tote identifiers.

In some embodiments of the method, the throughput optimization of commercial orders of the first plurality of commercial orders is measured across a plurality of days.

In some embodiments of the method, the generating of the ordered sequence of pick-operation specifications is done using a combinatorial optimization routine.

Some embodiments of the method further include:

moving a first mobile picker platform supporting a picker to a sequence of pick locations along the first aisle of the warehouse according to the sequence of pick-operation specifications;

delivering a first sequence of totes to the mobile picker platform in the first aisle of the warehouse according to the ordered sequence of tote identifiers, wherein the first aisle includes at least a first pick face having a plurality of defined pick windows, wherein each respective pick window has one or more bins that are reachable by the picker when the first mobile picker platform is stopped at a location associated with that respective pick window,

locating those pick items having highest pick velocities of the pick items on the first pick face in bins nearest one another in one or more pick windows at a center area of the first pick face and other pick items having successively lower pick velocities are located in bins of pick windows of the first pick face successively more distant from the center area,

specifying, by the computer system to the picker, a plurality of bin locations for a plurality of pick items that are to be chain picked for a given tote while the first mobile picker platform is stopped at the location associated with a given pick window, and

determining, by the computer system, an optimal route specification of a sequence of pick windows that minimizes a distance moved by the first mobile picker platform and a specification of a sequence of tote-delivery times corresponding to the specified sequence of pick windows.

In some embodiments of the method, following the picker's last pick in a current pick window of the plurality of pick windows, specifying, by the computer system, an auto-move movement of the first mobile picker platform from the current pick window to a next pick window as soon as the picker is safe inside a light curtain of the first mobile picker platform.

In some embodiments of the method, the plurality of defined pick windows includes a plurality of partially overlapped pick windows, and the method further includes specifying, by the computer system, an auto-drift movement of the first mobile picker platform from one of the plurality of partially overlapped pick windows to an adjacent partially overlapped pick window.

Some embodiments of the method further include specifying, by the computer system to the picker, a plurality of bin locations for a plurality of pick items that are to be chain picked to a container carried by the picker for a given tote while the first mobile picker platform is stopped at the location associated with a given pick window, in order to minimize back-and-forth motion of the picker between bins of the given pick window and a tote associated with the given pick window.

Some embodiments of the method further include:

under control of the computer system, moving a mobile picker platform that supports a picker to a sequence of pick locations according to the sequence of pick-operation specifications;

under control of the computer system, delivering a first sequence of totes to the mobile picker platform according to the ordered sequence of tote identifiers;

providing a horizontal conveyor,

providing a vertical conveyor associated with the first mobile picker platform,

receiving, into a tote-buffer automated storage and retrieval system (ASRS), a plurality of totes from the horizontal conveyor, temporarily hold, and selectively return totes of plurality of totes, and

using the horizontal conveyor, moving the first sequence of totes from the tote-buffer ASRS to a horizontal location of a vertical conveyor associated with the first mobile picker platform, and together moving the vertical conveyor and the first mobile picker platform and the first sequence of totes to a sequence of horizontal-vertical locations according to the first ordered sequence of pick-operation specifications.

In some embodiments, the present invention provides a computer-readable medium having instructions stored thereon for causing a suitably programmed computer to perform a method that includes:

receiving, into a computer system, a first plurality of commercial orders, wherein each respective order of the plurality of commercial orders specifies one or more items to be picked for that respective commercial order;

storing the plurality of orders to a storage system of the computer system;

organizing, in the computer system, the first plurality of commercial orders into a first plurality of batch windows, wherein at least some of the first plurality of batch windows are associated with a first aisle of a warehouse;

generating, in the computer system, an ordered sequence of pick-operation specifications associated with each batch window of the first plurality of batch windows that is associated with the first aisle in order to optimize a throughput of commercial orders during each of a plurality of sequential time periods; and

generating, in the computer system, an ordered sequence of tote identifiers corresponding to the sequence of pick-operation specifications associated with each batch window of the first plurality of batch windows that is associated with the first aisle.

Some embodiments of the computer-readable medium have further instructions such that the method further include:

under control of the computer system, moving a mobile picker platform that supports a picker to a sequence of pick locations according to the sequence of pick-operation specifications; and

under control of the computer system, delivering a first sequence of totes to the mobile picker platform according to the ordered sequence of tote identifiers.

Some embodiments of the computer-readable medium have further instructions such that the method further include:

moving a mobile picker platform that supports a human picker to a sequence of pick locations according to the sequence of pick-operation specifications; and

delivering a first sequence of totes to the mobile picker platform according to the ordered sequence of tote identifiers.

In some embodiments of the computer-readable medium, the throughput optimization of commercial orders of the first plurality of commercial orders is measured across a plurality of days.

In some embodiments of the computer-readable medium, the generating of the ordered sequence of pick-operation specifications is done using a combinatorial optimization routine.

Some embodiments of the computer-readable medium have further instructions such that the method further include:

moving a first mobile picker platform supporting a picker to a sequence of pick locations along the first aisle of the warehouse according to the sequence of pick-operation specifications;

delivering a first sequence of totes to the mobile picker platform in the first aisle of the warehouse according to the ordered sequence of tote identifiers, wherein the first aisle includes at least a first pick face having a plurality of defined pick windows, wherein each respective pick window has one or more bins that are reachable by the picker when the first mobile picker platform is stopped at a location associated with that respective pick window,

locating those pick items having highest pick velocities of the pick items on the first pick face in bins nearest one another in one or more pick windows at a center area of the first pick face and other pick items having successively lower pick velocities are located in bins of pick windows of the first pick face successively more distant from the center area,

specifying, by the computer system to the picker, a plurality of bin locations for a plurality of pick items that are to be chain picked for a given tote while the first mobile picker platform is stopped at the location associated with a given pick window, and

determining, by the computer system, an optimal route specification of a sequence of pick windows that minimizes a distance moved by the first mobile picker platform and a specification of a sequence of tote-delivery times corresponding to the specified sequence of pick windows.

In some embodiments of the computer-readable medium, following the picker's last pick in a current pick window of the plurality of pick windows, specifying, by the computer system, an auto-move movement of the first mobile picker platform from the current pick window to a next pick window as soon as the picker is safe inside a light curtain of the first mobile picker platform.

In some embodiments of the computer-readable medium, the plurality of defined pick windows includes a plurality of partially overlapped pick windows, and the method further includes specifying, by the computer system, an auto-drift movement of the first mobile picker platform from one of the plurality of partially overlapped pick windows to an adjacent partially overlapped pick window.

Some embodiments of the computer-readable medium have further instructions such that the method further includes: specifying, by the computer system to the picker, a plurality of bin locations for a plurality of pick items that are to be chain picked to a container carried by the picker for a given tote while the first mobile picker platform is stopped at the location associated with a given pick window, in order to minimize back-and-forth motion of the picker between bins of the given pick window and a tote associated with the given pick window.

Some embodiments of the computer-readable medium have further instructions such that the method further includes:

under control of the computer system, moving a mobile picker platform that supports a picker to a sequence of pick locations according to the sequence of pick-operation specifications;

under control of the computer system, delivering a first sequence of totes to the mobile picker platform according to the ordered sequence of tote identifiers using a horizontal conveyor, a vertical conveyor associated with the first mobile picker platform,

receiving, into a tote-buffer automated storage and retrieval system (ASRS), a plurality of totes from the horizontal conveyor, temporarily hold, and selectively return totes of plurality of totes,

using the horizontal conveyor, moving the first sequence of totes from the tote-buffer ASRS to a horizontal location of a vertical conveyor associated with the first mobile picker platform, and together moving the vertical conveyor and the first mobile picker platform and the first sequence of totes to a sequence of horizontal-vertical locations according to the first ordered sequence of pick-operation specifications.

In some embodiments, the present invention provides a computerized method that includes:

specifying into a computer system: a first plurality of commercial orders, wherein each one of the first plurality of orders specifies one or more items to be picked, a first plurality of batch windows, including a first batch window and a second batch window, a specification of a number of subsequent batch windows to be included in a look-ahead process, a set of which item characteristics are to be matched, wherein the set includes at least a plurality to be matched, and a specification of at least one optimization type including labor optimization, throughput optimization, and response-time optimization;

receiving into the computer system a first plurality of commercial orders, wherein each one of the first plurality of orders specifies one or more items to be picked;

aggregating, by the computer system, the first plurality of orders across the plurality of batch windows, wherein at least some of the first plurality of batch windows are associated with a first aisle of a warehouse;

generating, in the computer system, an ordered sequence of pick-operation specifications associated with each batch window of the first plurality of batch windows that is associated with the first aisle in order to optimize a throughput of commercial orders during each of a plurality of sequential time periods; and

generating, in the computer system, an ordered sequence of tote identifiers corresponding to the sequence of pick-operation specifications associated with each batch window of the first plurality of batch windows that is associated with the first aisle.

Some of the Inventive Features of the First Part of the Invention that are Used Alone or in any Combination:

A) Using optimization after aggregation of orders over a Batch Window to increase Pick Performance in the Fulfillment Center Automation (FCA) system that automates taking the Picker to the goods (so-called “picker-to-parts” systems); or an Automated Warehouse System that automates the presentation of goods to a stationary Picker (so-called “parts-to-picker” systems).
B) Use of Batch Optimization to improve Pick Performance for the FCA or an AWS
C) The use of software to facilitate the optimization of Batches for the FCA or an AWS
D) The use of Combinatorial Optimization to perform Batch optimization.
E) Ability to adapt to picker performance by automatically shifting Orders (Batches) to different Aisles. This requires stocking of the same SKU in multiple Aisles.

### F) Programmable Capacity

G) Use of Storage, Bin Wall capacity, automated Conveyors, and Multiple Tote presentation combined with optimization to improve Pick Performance in the FCA or any other AWS
H) Three-Tier Optimization to provide highly optimized FCA Pick Performance. In the case of the FCA, all three elements are necessary to achieve improved Pick Performance.
I) Pick-to-X to facilitate Chain Picking in FCA.
J) Pick-to-X used to facilitate picking in conventional warehouses or AWS's.
K) Auto-Move and Auto-Drift to increase Pick Performance.
L) Use of Segments with a Batch Window to allow beneficial effect of longer aggregation period but yet fit within system constraints.
M) The creation of Chain Picking through Batch optimization.
N) The creation of Multi-Picks through Batch optimization.

### SUMMARY OF THE SECOND PART OF THE INVENTION

The Second Part of the Invention and the First Part of the Invention set forth above both primarily address the use of optimized Batching to significantly increase the performance of the FCA and other AWS's. Batching refers to the practice of collecting several orders at one time in the process of fulfilling commercial Orders. This is typically done by placing Items into some type of container, such as a Tote. Today, these orders generally refer to eCommerce. Batching has historically been used to improve the performance of Pickers in a manual system where the Pickers traverse a warehouse and access its Shelving Units to collect the Items for an Order.

By collecting the items for numerous Orders at one time, the overall distance required to be travelled by the Picker is reduced, thus resulting in an overall cost savings as compared to just collecting the Items for one Order at a time. When the Orders are collected in such a manner, they still need to be segregated into individual Orders when the Batch arrives at shipping. However, that time is generally far less than the time that would otherwise have been required if the Orders were collected individually.

To the inventor's knowledge, Batching has generally not been utilized with AWS's since they have historically been Goods-to-Picker systems where the Picker remains stationary. Therefore, there is no walking distance to be saved. However, the inventor has discovered that Batching augmented by software, combined with the necessary hardware and the associated processes, can be utilized to also improve Pick Performance in these automated systems, particularly for the FCA. The Second Part of the Invention focuses on software, associated hardware, and associated processes which will significantly enhance the performance of automated Picker-to-Goods systems such as the FCA as well as other automated Goods-to-Picker AWS's to a lesser extent.

While the First Part of the Invention focused on the FCA, aspects of the Second Part of the Invention can improve the performance of any AWS. This description of the Second Part of the Invention also demonstrates those benefits to the AWSs that are most prevalent in the eCommerce Industry outside of Amazon. There are several types of AWS's available in the industry today, many with their own unique aspect that is covered by their own intellectual property. This type of system generally has precision mechanical Shelving Units containing Bins holding commercial Items that can be retrieved and returned by small mobile robots. The shelving system typically contains a multitude of these robots such that the static Picker can remain motionless while these robots present the requested commercial Items to the Picker for inclusion in an order.

Having a multitude of these robots allows one of the robots with commercial Items to always be present in front of the Picker while the other robots are traversing the precision shelving, retrieving and returning Storage Bins from/to their respective locations. These will be referred to as Multi-Shuttle systems going forward in this document. Having a multitude of these small robots allows the Pick Performance of these systems to significantly exceed earlier warehouse automation systems like Automated Storage and Retrieval Systems (ASRS's) and Vertical or Horizontal Carousels. The nature of these older-generation systems will not be directly addressed here.

Pick-performance improvement using the Batch Optimization algorithm is done by aggregating several Orders in what is referred to as a Batch Window. These Orders are then strategically combined into certain groupings or Batches prior to the Items being retrieved from the AWS. Assuming the Orders are collected into Totes, by then utilizing strategic Tote Storage combined with high speed automated Conveyors, much of the wasted time surrounding the Order fulfillment process can be eliminated.

Depending on the AWS, this time savings involves picking numerous Items at one time, reducing/eliminating the time penalty associated with the mechanical system movement, and minimizing wasted Picker motion involved in the Picking and Replenishment processes. The software, hardware, and associated processes to achieve this will be described in this Second Part of the Invention. Many of them are novel and result in significant Pick Performance improvement.

In some embodiments of the First Part of the invention, an NP-Hard Combinatorial Optimization (CO) approach was utilized for solving the problem. NP-hardness (non-deterministic polynomial-time hardness), in computational complexity theory, is the defining property of a class of problems that are, informally, “at least as hard as the hardest problems in NP”. A simple example of an NP-hard problem is the subset sum problem. (From website en.wikipedia.org/wiki/NP-hardness.) However, CO algorithms tend to be computationally intensive, asymptotically approaching a solution in what can be a time-consuming process, dependent on the algorithm employed. Originally, it was believed this approach would be required to obtain satisfactory results. However, this Second Part of the Invention will provide a closed-form solution that approximates optimal results sufficiently well to warrant its use. Therefore, all references to the Batch Optimization algorithm set forth below are relative to a closed-form solution of it. As before, a detailed example will be provided to assist in the clarity of understanding.

### Description of Second Part of the Invention Preferred Embodiments

Although the following detailed description contains many specifics for the purpose of illustration, a person of ordinary skill in the art will appreciate that many variations and alterations to the following details are within the scope of the Second Part of the Invention. Specific examples are used to illustrate particular embodiments; however, the invention described in the claims is not intended to be limited to only these examples, but rather includes the full scope of the attached claims.

Accordingly, the following embodiments of the invention are set forth without any loss of generality to, and without imposing limitations upon the claimed invention. Further, in the following detailed description of the embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The embodiments shown in the Figures and described here may include features that are not included in all specific embodiments. A particular embodiment may include only a subset of all of the features described, or a particular embodiment may include all of the features described.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

When Batches are utilized in the Order fulfillment process, a multitude of the SKUs constituting those Orders arrive at shipping in containers of some type. For purposes going forward we will assume those containers are Totes. Ignoring the possibility of partitioned Totes, the SKUs in those Totes will need to be segregated from the Totes and aggregated back into individual Orders, so they can each be placed in their respective shipping boxes and sent on to their final destinations.

This segregation and assembling (aggregating) can be accomplished with the use of a Bin Wall 100. FIG. 1 shows a front-view representation example of a Bin Wall 100. A Bin Wall 100 includes a multitude of small compartments 101.1, 101.2 . . . 101.n, 102.1, 102.2 . . . 102.n, etc., where individual Orders can be assembled as the Batch Items are segregated. When that segregation/aggregation is finished a complete individual Order will exist in each of the small compartments utilized. Someone from shipping can then retrieve each individual Order for placement into a shipping box.

There are many different forms of Bin Walls, sometimes known as Put Walls in the industry. In some cases, the compartments might be on a mobile unit where that entire unit can be delivered to shipping when all the compartments are filled. In other cases, the compartments may be simply an array of box shaped compartments with both ends open as shown in FIG. 1. To facilitate performance, each one of these compartments can be identified to the Picker with its own lit light when it is time to place an Item in said compartment. This follows identification of the Item by a bar code scanner and its link to a specific Order.

Again, FIG. 2 is a timeline 200 representation of a 1-hour Batch Window and the corresponding Segments for that Batch Window. At the core of this invention is the aggregation of Orders over a Batch Window 200 as shown in FIG. 2. The duration of a Batch Window can be set to any convenient value or can be variable. In the case shown and in the ensuing example provided, Orders are collected over a one-hour-period Batch Window. In some embodiments, the Batch Window will then need to be subdivided into smaller increments called Segments as also shown in FIG. 2. The number and length/duration of the Segments is totally dependent on the variables surrounding the system which will be fully described in Section 3. The number and length/duration will also generally be variable dependent on the nature of the Orders involved.

Once the Orders are identified that will comprise a Batch Window, software is employed which will optimize the assignment of a specific Order to a specific Batch and its SKU Items to a specific Tote in that Batch. It will also need to be processed with the hardware described in this invention in such a manner to greatly reduce and/or eliminate the wasted time involved with current pick processes. Finding these optimal combinations of orders is a classic problem for the use of Combinatorial Optimization (CO).

CO was the premise for the algorithms utilized in the First Part of the Invention described above. However, CO algorithms are NP Hard problems and do not have closed-form solutions, resulting in potential significant computer-execution-time penalties to achieve satisfactory results as their solutions asymptotically approach the optimal solution. This Second Part of the Invention addresses closed-form solutions that provide solutions sufficiently close to optimal to warrant their consideration and use.

### Section 1—Three-Tier Optimization

In the First Part of the Invention set forth above, the concept of Three-Tier Optimization was introduced to eliminate the reactiveness of the algorithms and the resulting CPU time utilized in the earliest versions of the FCA. This was due to the system being reactive and continuously reoptimizing data for each Aisle based on the most recent Orders. Three-Tier Optimization breaks the requirement for reactiveness, since it relies on planning even though it still uses route optimization. This Three-Tier Optimization concept continues to be used in this Second Part of the Invention.

The Three-Tier Optimization approach begins with SKU-placement optimization in the Pick Faces of the warehouse Aisles. FIG. 3 shows an optimized Pick Face 300 with the highest Velocity SKUs concentrated in the center (e.g., center “columns” 311 and “rows” 321 around the center 310) of the Pick Face and radiating outward to include successively more horizontally distant columns (those columns in ranges 312, 313, 314, 315, 316, 317 that are outside of the smaller-numbered ranges) and more vertically distant rows (those in row range 322 but outside row range 321), with progressively slower moving SKUs at further from the center. This results in all the best-selling stock being located as near as possible to the next-best-selling stock in the Pick Face. This ultimately results in statistically minimized route travel in a Picker's efforts to fulfill the Orders in any given Batch. This benefit will be quantified in the forthcoming example. The shaded Prime Area 402 in the Pick Face 400 of FIG. 4 corresponds to where these highest Velocity SKU's are stored. In the forthcoming example, almost 90% of the SKU's for the associated Orders are picked from this location.

Besides locating high Velocity SKUs next to one another, there is also a requirement to stock the highest moving SKUs in multiple Aisles as part of the SKU placement optimization. Besides other benefits that will be divulged, having multiple locations for the highest Velocity SKUs allows the system to continuously adapt to differing picking speeds by the Pickers in the different Aisles. The extent to which SKUs are stored in multiple locations is a function of the specific warehouse and its inventory Velocity patterns. Each application will be slightly different.

The initial optimization of SKU placement takes place when the warehouse is initially stocked or an FCA system is installed in an existing warehouse. The FCA Control Software then monitors the ongoing Velocities of the SKUs. As the Velocities change over time due to changes in customer demand, seasonality, and/or other issues, the FCA Control Software will periodically reposition SKU locations to keep the overall placement optimized. This is known as Dynamic Slotting.

Following the optimization of SKU placement, comes Batch Optimization. Batch Optimization is performed once every Batch Window cycle by the FCA Control Software. It takes the Orders aggregated in the Batch Window, assigns all the Orders to specific Batches, and the SKU's within those Orders to specific Totes within the Batch. It then controls the FCA system to deliver those Totes in the correct sequence to the Pickers in the Aisle in order to achieve four goals:
Goal 1: Minimize the wasted time of Picker motion in picking one Line Item at a time.
Goal 2: Minimize the wasted time of Picker motion in shuttling between an Aisle Bin and a Tote between every pick.
Goal 3: Minimize the wasted time surrounding stock replenishment in the Aisles.
Goal 4: Minimize the wasted time due to mechanical movements in the overall FCA system.

Every SKU in an Order is referenced by a record that includes quantity and a reference to which Order it belongs. A Pick is considered the retrieval of one Line Item in one Order. An Order requires as many Picks as it has Line Items. In the event of multiples of the same SKU, that is still considered a single Line Item. Goal #1 is then achieved by picking multiples of a single SKU at one time to fulfill multiple Line Items on multiple Orders at one time. These achievements will be known as Multi-Picks going forward.

Goal #2 is achieved using a concept called Pick Windows. FIG. 4 shows a Pick Face 400 segregated into individual Pick Windows (PWs) 401.1, 401.2, . . . 401.n which, in some embodiments, overlap one another (shown here with column designations A through R and row designations R1, R2, and R3). In other embodiments, each Pick Window is non-overlapped with neighboring pick windows, such that the Bins (SKU storage locations) of each Pick Window are not part of other Pick Windows. In some embodiments, each Pick Window 401 is the width of the Picker Platform, with the height being determined as being those Bins (SKU storage locations) that are serviceable by the Picker on that Picker Platform when it is at a given horizontal and vertical position, wherein “Bins that are serviceable” means that the Picker can retrieve SKU's from those Bins to place in Totes that are at the platform, or can retrieve restock SKU's from a Tote at the platform and place those restock SKU's in the Bins of the Pick Window. By assigning the SKU's of Orders within a Batch to one Tote that all have SKUs whose placement locations are in a common Pick Window (e.g., one of PWs 401.1 through 401.n), the concept called Chain Picking can be achieved.

Normally, a Picker in the FCA system or any AWS will pick a SKU from some type of container and then turn to carry it over to another container that is being used to acquire all the Line Items in the Order(s) assigned to that container (Tote). This is generally wasted motion. By assigning the SKU's of Orders within a Batch to the Tote the FCA Picker is servicing that all have SKUs in a common Pick Window, the Picker can eliminate much of the wasted motion just identified.

In some embodiments of these instances, as opposed to continually returning to the Tote with picked Line Items, the Picker utilizes a small basket appended to their front (i.e. strap around neck). This allows the Picker to proceed from Bin to Bin in the PW acquiring all those common SKUs until such time that the Tote they are servicing has its requirement fulfilled from that Pick Window.

Again, Goal #3 is achieved by utilizing modular storage Bins for the SKU's that can rapidly be swapped by the Picker. That feature will not be covered in detail here. However, the FCA Control Software as part of the Batch Optimization will also, in some embodiments, preferably only do a Replenishment action for any given SKU when it is accompanied by an associated pick action in the same Pick Window. This will then only require an incremental motion to restock a Bin as opposed to a dedicated set of actions usually accompanying a stand-alone Replenishment.

Goal #4 is achieved in several ways. By reducing the total number of overall picks using Multi-Picks the requirement to continually return to a given pick location is minimized. With the concepts called Auto-Move and Auto-Drift, further wasted motion can also be eliminated. These two concepts are addressed in the First Part of the Invention (described above).

The final way Goal #4 is achieved is done with the final step of the Three-Tier Optimization process. That is by route optimization as the Picker progresses from one Pick Window to another. Through the Batch Optimization process, the distance required to be moved is minimized by ensuring the next series of picks is done in an adjacent Pick Window if possible. This was demonstrated as well in the example provided above in the description of the First Part of the Invention and will not be repeated in this description of the Second Part of the Invention since it is not as important to Batch Optimization.

With this Three-Tiered Optimization process, it has been demonstrated (as shown herein) that Pick Performance (PPH) can be significantly increased with a closed-form algorithm solution. To that end, in some embodiments, Pick Performance is the sole variable that this Second Part of the Invention is trying to optimize. It just happens to be a function of the four goals addressed. While the three elements of the Three-Tiered Optimization process are completely applicable to the FCA increasing its Pick Performance significantly, one element can also significantly increase the Pick Performance in other AWS's. That element is Batch Optimization.

### Section 2—Batch Optimization Implementation

As discussed in Section 1, Batch Optimization has 4 goals. Those 4 goals are achieved by first aggregating Orders over a desired duration of Batch Window. The longer the Batch Window, the frequency of any given SKU being Picked only increases, thus increasing the opportunity to improve Pick Performance by grouping orders having that given SKU into a single batch. This results from the potential of satisfying all those needed Picks for that given SKU with only one Pick Action. While it might take slightly more time at that Pick location to perform all the multiple Picks, the time savings from all the other eliminated movement can be extremely significant.

Once the Batch Window size has been determined, the generation of these Multi-Picks is the primary goal of the closed-form algorithm which is the basis of this invention. The secondary goal is to generate Chain Picks which are analogous to Multi-Picks in that additional wasted movement can be eliminated. As opposed to attempting to make many Picks at just one Pick Location like a Multi-Pick, the goal is still to make multiple Picks, but extend the size of the location to a Pick Window. As explained in the previous Section, that eliminates more movement and subsequent time. These are the only two goals of the algorithm and the algorithm is only part of Batch Optimization. It all starts with the structure of the Batch itself.

FIG. 6A shows one example of the most basic Batch structure 600. In this case there are a total of 5 Batches (numbered 1-5) in six Aisles within the Batch Window and only 1 Segment within that Batch Window. Each Batch consists of one Tote per Aisle. As a result, there are 5 Segment Totes in each Aisle. Having one Tote from every Aisle allows the Batch Optimization algorithm to handle any type of Aisle dependency since every Aisle is represented. In some cases, a few of the Totes in any given Batch may not have their volumes optimally utilized, but this configuration is key since it demonstrates that no Batch assignment is impossible because this type of arrangement is always available.

FIG. 6C then shows a more likely scenario 603. This is when there are still 5 Batches across the 6 Aisles, but some Aisles have more Segment Totes, in this case the 1st (furthest left) and 4th Aisles. These additional Totes could be a result of a Batch that required an additional Tote in each Aisle to handle the SKU's from Orders in their respective Batch. While there are certainly other scenarios, these two demonstrate the basic nature of Batches optimized by the algorithm for the FCA and other AWS's.

If the structure of all Batches is assumed to be that shown in FIG. 6A, there is at least one Tote in every Aisle available to accept SKU's for any Batch. The requirement exists that all SKU's within a single Order must reside in the same Batch. With this general structure of a Batch and that guideline (the primary one), the Batch algorithm attempts to assign Orders to Batches and SKU's within those Orders to specific Totes within the Batch all with the primary purpose of generating the maximum number of Multi-Picks (MP's) and Chain Picks (CP's). That will result in the highest Pick Performance. Since more time is saved from an MP than a CP, the generation of MP's takes priority. Section 5 will explain and demonstrate how this maximization is achieved.

Batch Optimization is more than just the algorithm. To deliver the four goals defined in the previous Section it also requires an automation system whether that be an FCA or some other AWS. I will start with the FCA which is the only system capable of offering CP's. As shown in FIG. 14, an FCA 1400 requires automated Picker movement 1401, a Bin Wall 1402, Tote Storage 1403, Tote Sequencing 1404, a multiplicity of Totes with automated Tote circulation 1405, Shelving Units 1406 and the associated control software.

This system synchronizes the delivery of specific Totes within a specific Batch to the Picker when the Picker Platform resides at the Pick Window whose SKU's are required to fulfill the Order SKU (SKU's) assigned to that Tote. The system is then capable of repeating these actions as the Picker moves across the Pick Face until such time as all the Orders are fulfilled within the Batch Window. Further details are described within the FCA patent application. However, the FCA and its embodiments as described in the patent application are themselves only representative embodiments of the system architecture described in FIG. 14. To the inventor's knowledge, this system architecture is truly unique.

A system-wide perspective of the architecture is shown in FIG. 7A, which is the preferred embodiment 701 for the FCA. It consists of the warehouse Aisles 710, the associated bidirectional Conveyors 712, the Bin Walls 711, and the Mini-ASRS's 713 acting as long-term Storage and Sequencer for that embodiment. The PAV and the Shuttle Cart which it tows, and which provides the short-term Storage, are not shown in the diagram since they are mobile devices that constantly traverse the Aisles. Their details are also described within the FCA patent application.

FIG. 15 shows how the implementation of Batch Optimization could be done on a Multi-Shuttle type AWS 1500. That type of system consists of small automated carriages 1501 that traverse precision Shelving Units 1505 to retrieve and restore SKU containers for the Picker 1504 that resides at the end of the system in their effort to fulfill Orders. To implement Batch Optimization then requires the use of a Bin Wall 1502 or Bin Walls dependent on the size of the Fulfillment Center. While the use of Tote Storage 1503 would be optional in this configuration, to attain maximum Pick Performance, it would be required. The use of a Sequencer is not required since the entire Shelving Unit acts as a large singular Pick Window relative to the context of the FCA architecture.

FIG. 16 shows how the implementation of Batch Optimization could be done on a Kiva type AWS 1600. That type of system consists of small AGV's carrying SKU storage pods 1601 that traverse the warehouse to retrieve and restore SKU storage pods for the Picker 1604 that resides at a stand-alone Pick Station. To implement Batch Optimization then requires the use of a Bin Wall 1602 or Bin Walls dependent on the size of the Fulfillment Center. While the use of Tote Storage 1603 would be optional in this configuration, to attain maximum Pick Performance, in some embodiments, it would be used. In some embodiments, the use of a Sequencer is not needed since the entire warehouse holding the storage pods acts as an even larger singular Pick Window relative to the context of the FCA architecture.

### Section 3—System Variables

This system used in the FCA has a very high number of variables that need to be optimized and/or can affect system performance. This section will explain these variables and their impact in the system. This is done to provide a deeper insight into how the FCA system and its control software performs. In so doing, the variables will be broken up into two different type categories, Static and Dynamic. Static Variables are those that are established when the physical system is constructed. They are defined at that time and can subsequently limit system performance as the business grows. However, they can be modified with differing degrees of difficulty as required.

The second type of variable are the Dynamic Variables. These are the ones that can change from day to day and/or Batch Window to Batch Window. They include the 4 Goals addressed under Three Tier Optimization plus others that can be highly variable and/or those that can be set at the start of a Batch Window to best optimize performance.

These variables also apply to other AWS's depending on their overall design. The FCA can best leverage these variables to increase Pick Performance more than any of the other AWS's due to its design considerations. To contrast the FCA to the Multi-Robot System and later compare performance, each variable will be identified by an “F” if it applies to the FCA and an “A” if it applies to other AWS's, and FA if it applies to both. The variables are (The items numbered #1 to #4 are the goals):
Aisle Tote Storage (Long-Term—Static) (FA)—Tote Storage determines the number of Batches an Aisle can process within one Segment. The more Batches that can be realistically processed, the better the overall Pick Performance. Long-term Storage means the storage of totes that will not be required short-term by the Picker. Storage can be split into long and short term to reduce costs by having multiple aisles multiplex their Tote Storage in one mechanism. This was addressed in the description of the First Part of the Invention set forth above.
Shuttle Cart Tote Storage (Short Term—Static) (FA)—Depending on the sequence of Totes required to perform the Batch Optimization it may be required that the Picker will require access to the same Tote in a time that is shorter than the time the Tote could be sent to long-term Storage. In these cases, the Tote must be stored on the Shuttle Cart. The time dependency is a function of where the PAV is in the Aisle and its distance from long-term Storage. In the case of the other AWS's a Shuttle Cart is not employed, this Storage is just in near proximity to the Picker.
# of Bins in Bin Wall (Static) (FA)—This determines how many orders can be placed in any one Batch. Depending on the number of Aisles assigned to the Totes in a Batch, this may end up limiting Pick Performance gains.
Size of Pick Window (Static) (F)—The current Pick Window is 8′ long and as high as a Picker can reasonably service at one time. The size of the Pick Window is thus directly tied to the size of the Picker Platform and how far a Picker may be required to walk during a stop at any Pick Window. It is currently believed 8′ provides a reasonable tradeoff between required Picker motion and the need for Picker Platform to be physically moved. A true optimum size is a function of the PAV speed (horizontal and vertical), the average walking speed for a contingent of Pickers, and other factors. More work is required to determine that optimum.
Tote Volume (Static) (FA)—The volume of the Tote determines how many Orders it can carry on the average. The larger the number of Orders combined, the higher the probability for increased Pick Performance. The current Tote size is the industry standard which all the equipment is sized around. The tradeoff of using a larger Tote and the resulting likely increase in the cost of equipment is yet to be analyzed, but an opportunity exists there to further increase Pick Performance.
PAV and Vertical Elevator Speed (Static—Secondary Consideration) (F)—In versions of the FCA set forth in U.S. patent application Ser. No. 16/339,473, PAV and Vertical Elevator speed (horizontal and vertical) were critical since the system was reactive to any new order and was continuously moving from one Pick Face location to another. In some embodiments of the current invention, the system remains in one location a much longer time on average. As such, the need for speed has been greatly reduced resulting in system cost savings due to the ability to use standard hardware.

(#1) Multi-Picks (Dynamic) (FA)—This and the next three items are the Four Goals already discussed. Optimizing these four variables results in the best Pick Performance possible. While Goal #1 was identified as minimizing the wasted time of Picker motion in picking one Line Item at a time, this is the same as maximizing Multi-Picks. Multi-Picks are realized by assigning Orders with a common SKU to one aisle without violating the system constraints that exist.

(#2) Chain Picks (Dynamic) (F)—As above, Goal #2 was identified as minimizing the wasted time of Picker motion in shuttling between an Aisle Bin and a Tote between every pick. This is the same as maximizing Chain Picks. Chain Picks are realized by assigning Orders with SKU's in a common Pick Window to one tote without violating the system constraints that exist.

(#3) Move Time (Dynamic) (F)—This variable can be minimized by maximizing Multi-Picks and utilizing Auto-Move/Auto Drift as much as possible.

(#4) Replenishment Time (Dynamic) (F)—The only way the system can minimize this time is to synchronize the Replenishment of any given SKU at the same time (there are multiple Tote holders on the Picker Platform) an Order pick is required for that same SKU. This is done with the Batch Optimization software.
Inter-Batch Dependencies (Dynamic) (FA)—This variable limits Batch Optimization. It occurs when the Totes in a Batch start to get filled to their limits. Once that happens, Orders that might be added to that Batch to create either an MP or a CP that have SKU's solely in the Aisles whose Totes are full cannot be added. That then limits the number of MP's and CP's created. This dependency was not noted in the description of the First Part of the Invention set forth above.
Inter-Aisle Dependencies (Dynamic) (FA)—This variable also limits Batch Optimization. Dependencies are due to the more Aisles involved in an Order fulfillment, the more problematic that Order becomes for the Batch Optimization software. When an Order's SKU requirements span more than one Aisle, it is possible or even likely (dependent on SKU Velocity) the Batch Optimization software may want to combine SKU's from more than one Aisle into two different Multi-Picks. That is only possible if they happen to be in the same Batch, which is typically not likely. As such, one or more of the SKU's need to be left out of a Multi-Pick, thus sub-optimizing the overall results.
Inter-Pick Window Dependencies (Dynamic) (F)—This is a similar situation to the Inter-Aisle Dependencies except this is when an Order requires SKU's from more than one Pick Window. Unlike Inter-Aisle Dependencies where it may be possible to have Order SKU's from more than one Aisle involved in Multi-Picks provided they are in the same Batch, if two SKU's in an Order are in different Pick Windows one of them cannot be involved in a Multi-Pick. More clarity of this concept was noted in the description of the First Part of the Invention set forth above.
Line Item Types (Dynamic) (FA)—In the description of the First Part of the Invention set forth above, Line Item Types were used as part of the algorithm. The closed-form solution presented in this Second Part of the Invention no longer requires those variables (total of 6), thus significantly decreasing the number of overall variables and the ensuing complexity.
Length of Batch Window (Dynamic) (FA)—The length of the Batch Window is determined prior to running the Batch Optimization but is a profound variable in its own right. As will be shown in Section 5, lengthening of the Batch Window offers a proportional increase in Pick Performance. This is another new concept, referred to as Programmable Capacity, and its implications can be profound for the eCommerce industry.
# of Allowable Batches (Dynamic) (FA)—This is set prior to the Batch Optimization algorithm being run. The algorithm uses it to spread the Orders across the allowable number of Batches as part of the Batch assignment portion of the algorithm. Once that portion of the algorithm is complete, the algorithm then compresses the Batches into as few of Batches as possible without losing any CP's or MP's.
# of Totes per Batch (Dynamic) (FA)—While there is generally at least one Tote for every Aisle in a Batch, there does not need to be. That possibility will be explored in future iterations of the algorithm. Likewise, as noted in FIG. 6C, the algorithm can assign more than one Tote per Aisle in a Batch as part of its calculations.
Batch Aisle Assignment (Dynamic) (FA)—The optimal assignment of every Order's SKU's into the optimum Tote (Aisle) within the optimum Batch is the primary result of the Batch Optimization algorithm. For the highest Velocity SKU's, some embodiments provide multiple SKU placement locations in multiple Aisles. This provides additional flexibility. With this, when an Order has a Line Item that has multiple Aisle locations, the first consideration needs to be Aisle balance. In other words, some Pickers work faster than others. As such, some Pickers will complete their assigned Orders in a Batch Window faster than others. Therefore, when the next Batch Window is determined, the FCA Control Software needs to first consider Picker Performance and assign more Line Items to the faster Pickers to ensure ongoing Aisle balance. By doing this, balanced Aisle performance can continue indefinitely. Second, a Line Item can then be reassigned to a different Aisle if that will help the Batch Optimization software to better maximize Multi-Picks or Chain Picks.
# of Segments per Batch Window (Dynamic) (FA)—Once the number of Totes per Aisle is defined, the number of Segments will be determined by the long-term and short-term Storage available for Totes in each Aisle (also outside Batch Optimization algorithm).
# of Totes per Segment (Dynamic) (FA)—This is a constraint, but also a potential optimizing variable. There is a fixed limit on the number of Totes per Segment that must be kept due to Storage limitations; however, having more than one Tote in a Batch in one Aisle provides more flexibility for optimization.
# of Picks per Picker (Dynamic) (FA)—These variables need to be tracked to allow the algorithm to compensate for varying Picker Rates in each Aisle.
# of Orders per Batch (Dynamic) (FA)—This is a system constraint whose cap is determined by the number of Bins in the Bin Wall and generally the desire is to have as many Orders in the Batch as possible without violating the established constraint. This cap can be significantly increased by not using the Bins in the Bin Wall for Single SKU orders. If the Single SKU Orders are left batched in single container, they can be readily segregated by just putting one SKU at a time into a box for shipping.
Volume per Tote (Dynamic) (FA)—This is a system constraint whose cap is determined by the size chosen for the Tote and the associated automation hardware available to process Totes of that size. The general rule is to use as much Tote volume as possible without violating the established constraints. While weight of the Tote is also a safety issue, this invention will assume Tote volume to be synonymous with Tote weight for this discussion.
Aisle Storage Locations (Dynamic) (F)—While these are initially established when the warehouse is set up, they are kept optimized with Dynamic Slotting which is ultimately a function of the Batch Optimization software.
Aisle SKU Multiple Locations (Dynamic) (FA)—Just like the Aisle Storage Locations, these are also initially established when the warehouse is set up. They also need to be maintained as part of Dynamic Slotting.

This is a very difficult problem given all the variables to optimize and with others as constraints and/or limitations. It also quickly becomes obvious it is impossible to realize all the available opportunities for Multi-Picks and Chain Picks. However, it will be shown there is sufficient opportunity to significantly enhance the Picker Performance, particularly for the FCA and even other AWS's.

From an overall perspective, the Batch Optimization algorithm will tie down variables in the system constrained by system limitations like Storage and then proceed to optimize the assignment of Orders to Batches while abiding by the three dependencies identified. The assignment of Orders to Batches defines the Aisle assignments and the SKU's in the Order define the Tote assignments (i.e. once an Order is assigned to a Batch, the software also needs to assign the SKU's in that Batch to the Totes involved). In general, it also assumes the typical usage of one Tote per Aisle to one Batch, barring anomaly assignments. To the extent multiple Totes are assigned to one Batch within one Aisle more opportunity arises to optimize assignments, but complexity arises as well.

### Section 4—Database

The chosen embodiment of Batch Optimization for this invention utilizes a database and will be demonstrated in Section 5 with an example. While databases generally imply a procedural programming approach, an effort was made to utilize concepts that could bridge either a procedural approach or an object-oriented approach. In the case of the database, it is a relational database with a primary key consisting of a combination of an Order number, a SKU Identifier number, and an Aisle number. The Aisle number is required because in an FCA warehouse, high velocity SKU's must be stored in multiple Aisles. The unique combination of an Order number/identifier and its individual SKU Identifier's will be designated as an OrderSKU and would be the primary key for the Order data received from the WMS.

In the terms of a Fulfillment Center, while every Order is unique, it can have from 1 . . . n SKU's, where n would likely not have an upper bound and a SKU can be stored in 1 . . . m Aisles, where m is the number of Aisles in the warehouse. In some embodiments, this information in the database is represented using an object-oriented approach, using an Order Class in combination with a SKU Class with the database fields being equivalent to Properties in either Class.

Outline 3 shows key information on the database fields that need to be generated prior to executing Batch Optimization. It includes the Fields within the database described below and the pseudo-code required to generate those field values within the database prior to implementing the Batch Optimization algorithm. The pseudo-code can be viewed as either routines or methods to generate Class properties. The fields in the database originate in one of three ways. They are either information provided by the WMS (designation of an *), are the ones calculated in advance using the pseudo-code (no designation), or are information calculated during the execution of the Batch Optimization algorithm which is used in later algorithm calculations (designation of a **). The fields are:
Aisle Field*—Provides the Aisle number associated with the OrderSKU.
SKU Field*—Provides the SKU Identifier number associated with an Order number.
Order ID Field*—Provides the unique Order number.
OrdSKUVol Field*—Provides the total volume of the SKU within the Order. This is not the volume of a single SKU alone but is the total volume for the full quantity of that SKU in the Order.
#SKUs Field*—Provides the total number of SKU's in the Order.
BinCnt Field*—Provides the total number of Aisles the SKU is stored in.
PW Field*—Provides the Pick Window within the Aisle where the SKU is stored. Currently, a SKU has the same Pick Window in every Aisle it is stored in, but an opportunity remains to slightly increase optimization by varying PW storage locations in each Aisle the SKU is stored in.
Set Field—Every SKU within the Batch Window that has an occurrence within multiple Orders is assigned a Set number. The Set numbers are assigned in sequence starting with the SKU with the largest total volume within the Batch Window.
SetSKUVol Field—Provides the total volume of the SKU within the Batch Window.
Group Field—Many SKU's have a SetSKUVol exceeding the volume capacity of a single tote. In these cases, the Sets are broken into the fewest possible Groups which do not exceed the capacity of a single Tote. The Group numbers are assigned in sequence starting with the smallest Set number (i.e. largest SetSKUVol).
GroupVol Field—Provides the volume of the Group.
Grp Field—Grps are comprised of multiple Groups and/or partial Groups in an effort to get as many MP's within the same Grp as possible. A Grp is assigned to a Batch in the Batch Optimization algorithm. The pseudo-code in Outline 3 to generate this field is shown in the outline below this description of the database Fields. As an example, if an Order contained 3 different SKU's (all with Group #'s) the pseudo-code would attempt to assign all those Groups to the same Grp so an MP would not be lost (i.e. any time two Orders with the same SKU end up in different Batches, an MP is lost), because being in different Grps means they will likely end up in different Batches.
GrpVol Field—Provides the total volume of the Grp.
GrpSKUVol Field—Provides the total volume of the SKU within the Grp.
Grp-Field**—This field is the same as the Grp # but only included in one record for a unique OrderSKU (i.e. only one Aisle). This is done to facilitate final sorting of the database and other calculations.
BatchAisle**Field—This field ultimately contains the Batch and Aisle the OrderSKU got assigned to in the Batch Optimization algorithm. It determines the final Pick List and is formatted as (((Batch #)*(# of Aisles))+(Aisle #)).
CP Field**—This identifies whether an OrderSKU is part of a Chain Pick.
MP Field**—This identifies whether an OrderSKU is part of a Multi-Pick.
Stat Field**—This identifies other status to help generate a total score for any given Order. Examples include a missed MP, a missed CP, MP candidates that were instead a CP, etc.
Score Field**—This contains the calculated Score for an Order indicating how effectively it participated in Chain Picks or Multi-Picks. Based on the Score, remedial action is taken in the Batch Optimization algorithm to improve that effectiveness.

Outline 3

```
Add Set and SetSKUVol Fields
  Sod by SKU #
  Assign Set # to each SKU # with multiple records and calculate total volume
Add Group Field
  Calculate total volume for each Set
  Sort by this total volume, highest first
  Rearrange records within Set to create groups whose combined volume can fit
  within the given tote size, minimizing number of totes
  Assign Group # to each group assignment starting with #1 to largest volume Set
Add GroupVol Field
  Calculate total volume for each Group
Add Grp Field
  Starting with Group #1 add the SKU′s to the Group to complete the orders in the
  initial Group adding a Grp # the same as the Group #) to each SKU now in the
  Group (ao orders consolidated in Grp′s)
  Determine volume for each new Grp and store results (GrpVol)
  Re-sort by Grp # (largest first), then Order #, then SetSKUVol, then SKU #
  For every record with same Group
    Replace all Grp #′s in that Group that are equal to the Group # with the
    Grp # (within that Group) with the smallest GrpVol which is under the
    allowable size for a Grp (application dependent)(i.e. as smaller and
    smaller Group #’s are processed, a Grp # might change multiple
    times)(this attempts to keep orders with similar SKU′s together in the
    same Grp # and maximize MP′s)
  For every record with no Grp #
    Assign a single Grp # (Pick Window & Aisle #) to all the SKU′s in those
    orders with multiple SKUs and/or multiple bin locations based on the SKU
    PW whose distance is furthest from the middle of the pick wall
    Assign a Grp # to all other single-SKU orders with only one storage bin
    comprised of Pick Window & Aisle #
    Reassign all non-numeric Grp # records to numeric Grp # whose Grp has
    the lowest volume and has a SKU within it whose Pick Window and Aisle
    # are equal to the initial non-numeric Grp # (i.e. moving Grp′s to other
    Grp′s to maximize the CP′s) subject to an application dependent volume
    limit
Add GrpVol Field
  Recalculate Grp volumes for all Grp′s based on current reassignments
Add GrpSKU Vol Field
  For all SKUs within a numeric Grp
  that Grp (i.e. the sum of each GrpSKU Vol equals the GrpVol for that Grp)
```

### Section 5—Main Algorithm with Example

As previously disclosed, the Batch Optimization algorithm which is one basis of this invention is a closed-form solution, providing a near optimal solution in an acceptable computing time (2-3 minutes). Outline 4 shows the primary dictionaries utilized in the algorithm. The dictionaries use stored data with key-items pairs. In two of the five dictionaries, the item is another dictionary with additional key-item pairs. This structure provides hierarchical data storage that significantly simplifies the algorithm. The description of those pairs is also provided in Outline 4, which can then be utilized to ascertain their function in the pseudo-code description of the Batch Optimization algorithm what is shown in Outlines 5-8. Those Outlines are shown below:

Outline 4

```
BatchMap Dictionary-Represents individual Totes
  Key: ((Batch #) * 15) + (Aisle #) known as BatchAisle
  Item: Tote Volume
TotePW Dictionary
  Key: BatchAisle #
  Dictionary Item
    Key: PW
    Item: # of Key PW in BatchAisle Tote (# of CP′s)
ToteGrp Dictionary
  Key: BatchAisle #
  Dictionary Item
    Key: SKU #
    Item: # of Key SKU in BatchAisle Tote (# of MP′s)
NewBatch Dictionary (stores assignments to new Batches)
  Key: Batch #
  Item: Batch # when combined with Key Batch # provides the
  highest score or largest volume
Score Dictionary
  Key: Batch #
  Item: Score from NewBatch combination
```

Outline 5

```
BatchAssign
  Sort records by Grp, Order ID, BinCnt, SKU
  For every Order SKU in the order of the sort
    For first SKU in, Grp (GrpSKU), determine if Grp is part of a Set
  GrpBat
    For each Batch (number is application dependent) in BatchMap
      Determine the aisle to be used for the SKU whose Group # = Grp # (the primary SKU
      in the Grp since it will likely provide the opportunity for the most MP′s). If Group is part
      of a Set, no aisle that contains that SKU should be reused until all of them have been
      used prior (stored in SetCollection). The aisle is selected primarily to generate a CP
      and secondarily to minimize the tote volume. Selection is stored in GrpTote.
      For every Order in the Grp
        For every SKU in, the Order (Order Processor)
          Retrieve the Aisle #′s where the SKU is stored and place in
          AisleCollection
          Simulate the addition of the SKU to the selected Batch in BatchMap
          finding the best Aisle in AisleCollection to maximize the number of
          CP′s or MP′s using data in TotePW, ToteGrp, the SKU database,
          and/or other data dependent on the algorithmic approach.
          Secondarily to CP′s or MP′s, select the Aisle whose Tote has the
          most capacity. The maximum number of orders (application
          dependent) that will fit in the bin wall must not be exceeded for any
          Batch nor the maximum Tote volume.
          Establish score based on number of CP′s and MP′s achieved
          (Scoring algorithm is application dependent)
    Set the Batch for the Grp based on the best score. If two Batches have the same score,
    randomly select the choice.
    Recall the GrpTote for the Batch selected
    For every Order in the Grp
      For every SKU in the Order (Order Processor)
        Retrieve the Aisle #′s where the SKU is stored and place in AisleCollection
        If SKU = GrpSKU then
          SKUAisle = GrpTote
          Store SKUAisle being used in SetCollection
```

Outline 6

```
BatchAssign (cont).
    Else
        PWTest
      If Rework then
          Reset TotePW for each SKU in Order prior to error
          Reset ToteGrp for each SKU in Order prior to error
          Reset BatchMap for each SKU in Order prior to error
          Reset Rework flag when all SKU′s in Order prior to error have
          been addressed
      For each Aisle in AisleCollection if not Rework
          Using identical algorithm as used in GrpBat, simulate the
          addition of the SKU to the selected Batch in BatchMap
          selecting the best Aisle to maximize the number of CP′s or
          MP′s using data in TotePW, ToteGrp, the SKU database,
          and/or other data dependent on algorithmic approach.
          Secondarily to CP′s or MP′s, select the Aisle whose Tote has
          the most capacity. The maximum number of orders
          (application dependent) that will fit in the bin wall must not be
          exceeded for any Batch nor the maximum Tote volume.
      Set SKUAisle equal to the selected Aisle unless there was a
      placement error in which case set it to zero.
    If SKUAise < > 0 then
      Update TotePW with SKU PW and increment PW count (# of CP′s)
      Update ToteGrp with SKU Grp and increment Grp count
      (# of MP′s)
      Store the BatchAisle for the SKU (one entry per Order SKU) and
      replicate Grp field to Grp-
      Add the SKU′s total volume (if multiple) to the BatchAisle Tote in
      BatchMap
      Modify variables, registers, objects, etc. for SKU complete
      dependent on implementation
    Else
      Post error
      Set Rework flag
      Select different Batch
      Return to Order Processor and rerun Order in new Batch
  Increment Order counter for selected Batch
Clear SetCollection if at end of Set
```

Outline 7

```
OrdScore
  Sort records by Batch, Key, SKU to fill in CP, MP, & Stat Fields per the table below for each
  record with a BatchAisle entry
  Sort records by Grp-, Order ID, Stat to fill in Score Field (total score for each Order) per the table
```

| below | | | | |
|---|---|---|---|---|
| | | Field | Points | Description |
| | CP (X) | CP | 1 | Chain Pick |
| | MP (X) | MP | 2 | Multi-Pick |
| | CMP | Stat | 2.5 | MP Pick that was included in a CP |
| | −CMP | Stat | 1.5 | Initial Pick of an MP not utilized in a CP |
| | +CMP | Stat | 2.5 | Initial Pick of an MP that was also initial Pick of a CP |
| | −CP | Stat | −1 | Missed CP |
| | −MP | Stat | −1 | Missed MP |
| | MCP | Stat | 1 | initial Pick on a CP that was an MP candidate |
| | MPP | Stat | 1 | MP candidate that was a CP-i.e. missed MP |

Outline 8

```
BatchCompress
  Sort records by Batch, Key; SKU, Order ID
  z = 0
  Do until z > 2 and Score Dictionary is empty
    Get percent full of each Batch and sort by fullest first
    For i = 1 To BatchNum (on sorted results)
      For k = i + 1 To BatchNum (on sorted results)
        Test if Batch i and be combined with Batch k without exceeding the maximum
        volume in each Tote and the maximum number of Orders in the Batch
        (application dependent)
        Test for CP′s and MP′s created by combining Batch i with Batch k and
        establish score based on number of CP′s and MP′s, achieved (scoring
        algorithm is application dependent)
      For Batch i save the Batch # that achieves the best score of if no score, the largest
      combined volume in NewBatch Dictionary.
      For Batch i save the score in Score Dictionary.
    If there are redundant assignments in NewBatch, only keep the one with the highest score
    followed by highest volume
    Do for every key-item pair in NewBatch
      If there is a circular references then
        Delete the key-item pair whose item has the largest volume else
      Else
        Delete key-item pair with the lowest score
      If the new Batch resulting from the key-item Batch combination exceeds the
      maximum number of order for the bin wall then delete the key-item pair
    Move volumes in BatchMap from the assigned Batch (all associated BatchAisle keys) to the
    new Batch (all associated BatchAisle keys) for every key-item pair in NewBatch, update the
    affected Order counters for each Batch, and delete all the reassigned key-item pairs in
    BatchMap
    Change all the database records whose BatchAisle field changed with the new assignments
    Change all the TotePW and ToteGrp keys and items that changed as a result of the new
    assignments,
    z = z + 1
CleanUp
  Sort records by Grp, Order ID, BinCnt, SKU
  For each Order with Score less than X (application dependent)
    For every Batch in BatchMap
      Determine if Order can fit in Batch and number of CP′s it generates
      Determine if number of CP′s is greater than previous Batches and store Batch # and
      Aisles for each of its SKU′s
    If Order is not involved in an MP and can raise the Order Score then
      Add Order to new Batch in BatchMap and subtract from old
      Modify TotePW and ToteGrp for affected BatchAisles
      Modify Order counters for affected BatchAisles
```

The structure of the Batch used in the Batch Optimization algorithm is as shown in FIGS. 6A and 6C where there is at least one Tote available in every Aisle for every Batch. Outlines 5-8 show the Batch Optimization algorithm itself. It consists of 6 primary routines or methods if OOP is used. They are:
BatchAssign—This is the primary routine or method of the algorithm. It acts on every unique OrderSKU in the database starting with the smallest numbered Grp. It will first determine the best Batch for the Grp that will generate the most MP's and CP's. With the Batch assignment, it will then assign every SKU in the Grp to the Tote within that Batch that again generates the most MP's and CP's. If it runs into an error such as having too many orders within a Batch or not being able to find a Tote with sufficient capacity remaining, it will generate an error and select a different Batch until it is successful. This process is repeated until the final OrderSKU is processed.
GrpBat—This routine or method systematically simulates the addition of the Grp to every existing Batch attempting to find the Batch assignment that generates the most MP's and CP's with the MP's taking priority. The information stored in the BatchMap, TotePW, and ToteGrp dictionaries combined with the calculated fields (properties) in the database (objects) are used for the simulation. All the SKU's in the same Group must be assigned to the same Tote to ensure the number of MP's are maximized. The maximum capacity of a Tote must not be exceeded, nor the maximum number of Orders allowed in a Batch. While the pseudo-code in Outlines 5 & 6 shows the simulation being done one SKU at time within one Order at a time, some embodiments do it one complete Order at a time, or all identical SKU Identifier #'s at one time, or even the entire Grp to the Batch at one time. This routine or method also ensures if a SKU is part of a Set, that every SKU Group is assigned to a different Aisle if that SKU happens to be stored in multiple Aisles. This helps to ensure no one Aisle exhausts its inventory of that SKU prior to another Aisle. This is done using the GrpTote variable shown in the pseudo-code in Outlines 5 & 6.
PWTest—Once a Batch has been determined for a Grp, then the actual assignments of all the SKU's within the Grp to their respective Totes in the Batch must occur. This routine or method performs that action. Some embodiments forego this routine or method by storing the results of every simulation performed in GrpBat and then taking the results of the best simulation to do the actual SKU assignments. That option was subjectively deemed to be too storage intensive. Therefore, this routine or method performs the exact simulation again that was used in GrpBat but only on the Batch that was deemed to provide the best results (maximum MP's & CP's). In conjunction with BatchAssign, the pseudo-code in Outlines 5 & 6 show that PWTest performs the simulation one SKU at a time with an Order at a time. Again, some embodiments do it one complete Order at a time, or all identical SKU Identifier #'s at one time, or even the entire Grp to the Batch at one time. It should be noted that for SKU's that are part of a Set, this routine or method is skipped as shown in the pseudo-code in Outlines 5 & 6. The same constraints hold for this simulation as in GrpBat.
OrdScore—Once BatchAssign is complete, all SKU's in all Orders have been assigned to Totes within Batches (see FIGS. 6A & 6C) to maximize the number of MP's first and the number of CP's second. However, there is still room for improvement in two areas. First, even though the simulations were relatively exhaustive, every combination of two Grp's was not achieved as might be better approximated with a Combinatorial Optimization approach with the ensuing time penalty. As such, there are still Chain Picks and Multi-Picks that might be achieved by moving single orders into more optimal Batches. Second, the Batch assignments that were achieved were limited by an arbitrary maximum number of Batches allowed which is generally application dependent. The larger that limiting number is, the more spread out the Batch assignments resulting from BatchAssign become. In other words, many or most of the Batch assignments have partially filled or empty Totes. Therefore, it is possible to compress the Batches and, in the process, generate even more MP's and CP's. The first step in doing these two things is to score all Orders relative to how well their SKU's participated in a Chain Pick or Multi-Pick. This routine or method performs that scoring per the pseudo-code and guidelines shown in Outline 7. This scoring could be performed in several different embodiments, dependent on a programmer's preferences.
BatchCompress—This routine or method shown in Outline 8 combines the resulting Batches from BatchAssign to maximize the volume in every Tote without compromising any existing MP's or CP's and ideally creating additional MP's and CP's as the number of overall Batches is reduced.
CleanUp—This routine or method also shown in Outline 8 utilizes the scores developed in OrdScore and focuses on those orders with the lowest scores to reassign those orders to create more CP's if possible. Any Order already involved in an MP is bypassed since an MP reduces roughly twice the process time a CP does. The score where the effort ceases is flexible and application dependent.

It will be demonstrated in the example below that this Batch Optimization is very efficient in generating MP's and CP's in the effort to increase Pick Performance even though it does not perform the exhaustive number of combinations or permutations a CO algorithm might. It should also be noted the pseudo-code listed in Outlines 5-8 only focuses on the primary function of the algorithm. All the less important dictionaries, variables, constants, etc. are not listed nor are the other minor error recovery procedures such as error log printouts. It is assumed those are part of standard programming procedure and will vary dependent on the programmer. All the occurrences that identify “application dependent” generally refer to adjustable limits that can be modified to slightly affect a specific implementation of the algorithm and are unique to that implementation.

The example to demonstrate the results of the Batch Optimization algorithm is based on a simulation using data modeled from an actual Fulfillment Center as it was in the description of the First Part of the Invention set forth above. Therefore, the example has a solid foundation in reality. While the example in the description of the First Part of the Invention set forth above only focused on data from one Aisle, this example utilizes data for the entire warehouse. In this case, that constitutes 15 Aisles where this example again aggregates Orders over one of the busiest one-hour periods (the Batch Window) in 6 months of warehouse data. This results in 5406 orders with 9346 Line Items and 5016 unique SKU's. That means there are 9346-5016 or 4330 possibilities to create Multi-Picks. In the 15 Aisles, there are 101255 Bins in the Aisles with 65534 different SKU's. In the one-hour time period chosen, the Batch Optimization algorithm has 31049 possible bins to choose from in its effort to optimize the Pick Performance for the 5406 orders.

It should also be noted this invention focuses only on the closed-form solution for the second step (the Batch Optimization algorithm) of the Three Tier Process. It does not focus on either the first or third steps, including the menial effort of identifying the chosen Segments from the optimized Pick List. All of those were covered adequately in the description of the First Part of the Invention set forth above. FIGS. 17A, 17B, and 17C show the final data 1701, 1702, and 1703 from the algorithm placed into a spreadsheet. Key information within that spreadsheet includes:
Database Fields 1710—This shows a limited set of the information in the database fields. Each record is for one OrderSKU. If you look at the BatchAisle field, it contains the Batch and Aisle assignment data for the first five Totes in the first Batch in its defined number format (((Batch #)*15)+(Aisle #)). The values in that field is the information required for the Pick List, the ultimate output of the Batch Optimization algorithm. The horizontal lines separate the individual Tote data. The shaded cells in the SKU and PW Fields show OrderSKUs involved in MP's (same SKU Identifier # in the same Tote) and CP's (same PW in the same Tote) respectively. Of note, it can be seen that almost every OrderSKU participates in either an MP or CP, thus showing the overall efficiency of the algorithm. The Score field shows the score calculated for each respective Order by the OrdScore routine or method. The score shown is the score following the CleanUp routine or method.
Pick Performance 1711—This cell shows the overall Pick Performance in Picks per Hour achieved by the Batch Optimization algorithm.
Number of Picks 1712—This cell shows the number of Picks required for all the Orders in the Batch Window if the Batch Optimization was not done.
Number of Multi-Picks 1713—These three cells show respectively the number of Multi-Picks achieved by the algorithm, the resulting number of Picks remaining, and the percentage of the “possible” MP's achieved. Since there are 4330 “theoretical” opportunities for MP's, having achieved 3833 of them results only in a percentage of 88.5% not the 91.5% shown. The difference is because there are a number of those 4330 possibilities that cannot be realized due to system limitations and are therefore not counted in the percentage calculation. For instance, for every SKU Group of a Set that goes in a different Tote, an MP possibility is lost and there is nothing that can be done to prevent that.
Number of Chain Picks 1714—These two cells show the number of Chain Picks achieved by the algorithm and a “relative” percentage indicator. Unlike Multi-Picks where it is possible to easily calculate a theoretical maximum, the same is not true for Chain Picks. Therefore, to provide a “relative” measurement, the percentage is only based on the number of SKU's minus the readily known system limitations. These limitations include eliminating a possible CP for every Tote that is used in the Batch Window amongst others. The percentage shown is then the CP's achieved divided by the total number of SKU's minus these readily known limitations.
BatchMap 1715—The BatchMap is the array of 29 rows and 15 columns that is shown. Each row represents a Batch (1-29) and each column represents an Aisle (1-15) with each spreadsheet cell being representative of the Tote used for that Batch in that Aisle. The value shown in a cell is the volume of the SKU's that Tote holds. The column to the right of the BatchMap shows the multiple-SKU Orders in the Batch and the next column shows the single-SKU Orders in the Batch. There is a 140 multiple-SKU Order limit which is application dependent. It can be seen there are not too many empty Totes in the Batches. This results from starting from 80 original Batches that were very loosely populated. The BatchCompress routine or method compressed the number down to the 29 generating 5 additional MP's and 43 CP's. By comparison, the CleanUp routine or method then generated 2 more MP's and 70 more CP's.
Picker Totals 1716—The row at the bottom of the BatchMap shows the number of Picks for the Picker in each Aisle. It can be seen that while the numbers are similar, they all vary by some amount. As discussed in Section 3, the algorithm can “tune” an Aisle to its Picker's speed within an FCA type system. In other words, if one Picker is slower than another, the algorithm will allocate fewer Picks to the slow Picker to balance their respective times it takes them to complete a Batch Window. This is known as Picker Performance Adaptability. While this requires the stocking of higher Velocity SKU's in several Aisles, there is almost no penalty for that action, unlike other AWS's where shelf space is at a premium.
Batch Optimization Algorithm Efficiency 1717—This cell shows the overall efficiency of the algorithm. As shown, it indicates that 98.5% of the OrderSKU's were involved in either an MP or a CP. While that number appears to conflict with the smaller percentages above, it can be reconciled. For instance, approximately 8.5% of the possible Multi-Picks were not realized. However, most of the ones that were not involved in an MP, were instead involved in a CP. Of the 5016 SKU's, 1736 of them had multiple usage resulting in the 4330 “theoretical” opportunities for MP's. However, those original 1736 SKU's, while they participated in an MP, did not help reduce any process time since one SKU in a Multi-Pick must still have the extra movement and process time associated with a standard pick. While some of them were likely involved in a CP, most of them probably were not. Those are only a couple of reasons the calculation of CP's becomes so difficult.

While the 98.5% appears to be a successful indicator, it only measures those OrderSKU's involved in an MP or CP and is not an indicator of optimality. The real indicator needs to involve the percentage (%) of “theoretical” MP's captured. It is clear 100% cannot be achieved, but the actual maximum number is indeterminable at this time. It also needs to involve determination of the maximum number of CP's attainable. However, that would involve determining how many of the 1736 SKU's that are part of an MP should also be part of a CP. That number too is indeterminable without much additional work. Suffice it to say, however, having 98.5% of the SKUOrders involved in an MP or CP combined with a Pick Rate of 1350 Picks per hour appears to be very satisfactory results for a closed-form solution.

While the 1350 Picks per hour is a stellar Pick Performance, it can still be increased significantly by increasing the size of the Batch Window. FIG. 18 shows differing Pick Rates 1800 based on the length of the Batch Window. The table 1802 shows the duration of the Batch Window in the left column. They range from 15 minutes to a full day and are all based off one day's data from the same Fulfillment Center data used in the example. The Pick Rate for an FCA is shown in the second column from the right while the Pick Rate for a Kiva-type AWS is shown in the righthand column. The data used in the calculations is shown in the list to the left of the table.

This opens the possibility of what is called Programmable Capacity. By aggregating Orders over longer time periods, in some embodiments, the Pick Performance is made to increase. This obviously causes increasing shipping delays but can be used effectively in times of heavy Orders such as a Holiday Season. In conventional processes, if there are more Orders than Fulfillment Center capacity, the Fulfillment Center gets progressively behind and shipping delays thus increase. By using Programmable Capacity, the backlog can eventually be erased with less overall delay. There is a limitation, however, in system resources such as available Tote Storage capacity and Bin Wall capacity. This Programmable Capacity approach can also be used in other AWS's like the Kiva type or the Multi-Shuttle type with similar results.

### Second Part of the Invention Summary and Conclusion

In some embodiments, this Second Part of the Invention provides significant Pick Performance improvement for AWS's, but particularly the FCA, as the algorithm is applied on a wider scale to an entire warehouse as shown in the example. It was also shown that a closed-form solution performed with either procedural programming or OOP provides near-optimal results. The 1350 Picks-per-Hour (PPH) Pick Rate demonstrated in the example for the FCA is over 250% greater than the nearest competitor. Even though the other AWS systems can benefit from this Batch Optimization algorithm, the benefit is considerably less as shown in FIG. 18 for the Kiva-type AWS. The difference is even greater for the Multi-Shuttle type AWS that has an estimated Pick Rate of 708 PPH for a 1-hour Batch Window for the data shown in FIG. 18. This is almost half the estimated Pick Rate for the FCA. The reason the two different AWS's perform more poorly is due to wasted mechanical motion (which is even more on the Multi-Shuttle type AWS's) and their inability to benefit from Chain Picks.

In some embodiments, the present invention provides a system for fulfillment of a first plurality of orders at a fulfillment center, wherein the first plurality of orders is received from a plurality of customers, wherein each one of the first plurality of orders includes a plurality of stock-keeping unit (SKU) identifiers, and wherein the system includes: a computer system that has software that executes on the computer system, wherein the software uses a batch-optimization algorithm that assigns/associates each respective one of the first plurality of orders to a respective batch of a first plurality of batches and assigns/associates each SKU identifier of the respective orders' plurality of SKU identifiers to a respective tote of a plurality of totes associated with the respective batch in order to maximize occurrences of two types of events, wherein the two types of events are: a multi-pick type of event wherein a plurality of SKU items specified by different orders but having equivalent SKU identifiers are picked at one time, and a chain-pick type of event wherein plurality of SKU items having different SKU identifiers, and all located within reach in a common pick window are picked consecutively and placed in a single tote, wherein the multi-pick type of event and the chain-pick type of event are both selected in order to provide a maximized pick performance, and wherein pick performance is defined as a number of picks per unit of time in a sequential series of picks performed using an automated warehouse system (AWS).

In some embodiments of the system, the batch-optimization algorithm further controls movement of the plurality of totes of each respective batch of the first plurality of batches to a first order-aggregation operator and presenting information to the first order-aggregation operator to move picked items from the plurality of totes of the respective batch to respective order-aggregation compartments of a plurality of order-aggregation compartments of an order-aggregation structure, wherein all items moved into one of the plurality of order-aggregation compartments are associated with an individual order of the first plurality of orders.

FIG. 19 is a block diagram of a system 1900 that implements the computer-controlled flow and control method according to some embodiments of present invention. In some embodiments, system 1900 is used for fulfillment of a first plurality of orders 1920 at a fulfillment center, wherein the first plurality of orders 1920 (i.e., O-0, O-1, . . . O-nn) is received from a plurality of customers, wherein each one of the first plurality of orders 1920 includes a plurality of stock-keeping unit (SKU) identifiers 1930 (i.e., SKU1, SKU2, SKU3 . . . SKU-n). In some embodiments, system 1900 includes a computer system 1990 that has batch-optimization software 1991 that executes on the computer system 1990, wherein the batch-optimization software 1991 uses a batch-optimization algorithm that assigns/associates each respective one of a first plurality of orders 1920 to a respective batch 1941 of a first plurality of batches 1940 (i.e., B0, B1, . . . B-m) and assigns/associates each SKU identifier 1930 of the respective orders' plurality of SKU identifiers 1930 to a respective tote 1951 of a plurality of totes 1950 associated with each respective batch 1941 in order to maximize occurrences of two types of events, wherein the two types of events are: a multi-pick type of event wherein a plurality of SKU items specified by different orders but having equivalent SKU identifiers are picked at one time (e.g., the SKU3 is specified by orders O-0, O-4 and O-5 can be multi-picked at one time from one bin at a given pick window, similarly the SKU2, which is specified by orders O-0 and O-4 and can be multi-picked at one time from another bin at the same pick window—each of these is a multi-pick, but both together could be done sequentially as a chain pick), and a chain-pick type of event wherein plurality of SKU items having different SKU identifiers, and all located within reach in a common pick window are picked consecutively and placed in a single tote (e.g., the chain of the single occurrence of SKU5, then multi-picks of SKU3 specified by orders O-0, O-4 and O-5 picked at one time from one bin at the given pick window, then the multi-pick of SKU2, which is specified by orders O-0 and O-4 and can be picked at one time from another bin at the pick window—each of these single picks and multi-picks form a chain pick), wherein the multi-pick type of event and the chain-pick type of event are both selected in order to provide a maximized pick performance, and wherein pick performance is defined as a number of picks per unit of time in a sequential series of picks performed.

In some embodiments, a plurality of batch windows 1910 (including a first batch window 1911 and a second later batch window 1912 are defined in computer system 1990. Each batch window includes a plurality of Orders 1920 (labeled O-0, O-1, O-2, . . . O-nn for batch window 1911) that is received during a given batch-window period of time. As a simple example, Orders O-0, O-4, O-6, and O-9 are selected to be put into Batch B0 due to the ability to perform a multi-pick of SKU3 (three identical items among O-0, O-4, O-6, and O-9), multi-pick of SKU2 (two identical items among O-0, O-4, O-6, and O-9) and a chain-pick of these two multi-picks and single-pick SKU5 that could be done at a single pick window.

Still referring to FIG. 19, in some embodiments, the plurality of totes 1950 for each batch 1941 is associated with a set of identifiers that indicate which batch, which aisle 1040 and which tote in that aisle that totes is being used for in this batch window. For example, batch 1941 labeled as B0 is associated with the first tote 1950 labeled T-B001 to indicate that tote is for batch B0 (the second two characters being B0) and aisle 1040 numbered AISLE0 (the fourth character) and that this is the first tote (the fifth character) for aisle A0. Similarly, the second tote 1950 labeled T-B011 to indicate that tote is also for batch B0 (the second two characters being B0) and aisle 1040 numbered AISLE1 (the fourth character) and that this is the first tote (the fifth character) for aisle A1. Likewise, the n^{th} tote 1950 labeled T-B0m1 to indicate that tote is for batch B-m (the second two characters being Bm) and aisle 1040 numbered Ann (the fourth character) and that this is the first tote (the fifth character) for aisle AISLEnn.

The dashed-line arrow 1955 from the first tote 1950 labeled T-B001 (which also applies to move the tote labeled T-B002 as being and additional tote from batch B0 for AISLE0) to the storage unit 1942 labeled ST0 in AISLE0 indicates that the computer system 1990 controls to move the first tote 1950 labeled T-B001 to storage unit 1942 labeled ST0 (in some embodiments, each storage unit 1942 is implemented by a tote-buffer automated storage and retrieval system (ASRS) 1026 as shown in FIG. 10B, with the totes 1951 having reference number 1030 in FIG. 10B and moving along horizontal conveyors 1024 which move totes 1030/1951 to and from tote-buffer ASRS 1026 that includes one or more elevators 1029 (vertical conveyors) that lift totes 1030/1951 off horizontal conveyors 1024 and then return the appropriate totes 1030/1951 back to horizontal conveyors 1024 in the appropriate sequence order, which then move totes 1030/1951 to and from vertical conveyors 1025 that then convey totes 1030/1951 to and from the picker 1021/1943, all under the control of sequencer 1944, as directed by the batch optimization software 1991).

The dashed-line arrow 1959 from the tote 1950 labeled T-B101 to the storage unit 1942 labeled ST0 in AISLE0 indicates that the computer system 1990 controls to move the tote 1950 labeled T-B101 to storage unit 1942 labeled ST0.

The dashed-dot-line arrow 1956 from the tote 1950 labeled T-B011 (which also applies to move the tote labeled T-B012 as being and additional tote from batch B0 for AISLE1) to the storage unit 1942 labeled ST1 in AISLE1 indicates that the computer system 1990 controls to move the first tote 1950 labeled T-B011 to storage unit 1942 labeled ST1.

The dashed-dot-dot-line arrow 1957 from the tote 1950 labeled T-B601 to the storage unit 1942 labeled ST0 in AISLE0 indicates that the computer system 1990 controls the respective sequencer 1944 to move the tote 1950 of batch B6 labeled T-B601 to storage unit 1942 labeled ST0.

The dashed-dot-dot-line arrow 1958 from the tote 1950 labeled T-B611 to the storage unit 1942 labeled ST1 in AISLE1 indicates that the computer system 1990 controls the respective sequencer 1944 to move the tote 1950 of batch B6 labeled T-B611 to storage unit 1942 labeled ST1 in AISLE1.

Each respective sequencer 1944 (labeled SQ0 for AISLE0, labeled SQ1 for AISLE1, labeled SQ-nn for AISLE-nn) moves a sequence of totes 1951/1030 from respective ones of the plurality of storage modules 1942/1026 to the respective pickers 1943/1021 and then back to the respective ones of the plurality of storage modules 1942/1026.

For another example, batch 1941 labeled as B6 is associated with the first tote 1950 labeled T-B601 to indicate that tote is for batch B6 (the second two characters being B6) and aisle 1040 numbered A0 (the fourth character) and that this is the first tote (the fifth character) for aisle A0. Similarly, the second tote 1950 labeled T-B611 to indicate that tote is for batch B6 (the second two characters being B6) and aisle 1040 numbered A1 (the fourth character) and that this is the first tote (the fifth character) for aisle A1. Likewise, the n^{th} tote 1950 labeled T-B6nn1 to indicate that tote is for batch B6 (the second two characters being B6) and aisle 1040 numbered Ann (the fourth character) and that this is the first tote (the fifth character) for aisle Ann.

When the time comes that all of the picks for first batch window 1911 are complete, all of the totes 1951 from all of the aisles 1040 are moved to a bin wall/order-aggregation structure 1961 (e.g., in some embodiments, one of a plurality of order-aggregation structures 1960). For example, all of the totes 1951 for batch window 1911 would be moved to bin wall/order-aggregation structure 1961 labeled OA0, and the SKU items from all those orders are segregated to selected individual order-aggregation containers 1971 of a plurality of order-aggregation containers 1970, wherein the selected individual order-aggregation containers 1971 each correspond (during this batch-window period of time) to one of the received Orders 1920. For example, OA1C0 corresponds to batch window 1911 order O-0 with three SKU identifiers SKU1, SKU2 and SKU3 and created finished order 1980 labeled FO-0 with three corresponding SKU items; OA1C1 corresponds to batch window 1911 order O-4 with two SKU identifiers SKU2 and SKU3 and created finished order 1980 labeled FO-4 with two corresponding SKU items; OA1C2 corresponds to batch window 1911 order O-5 with two SKU identifiers SKU3 and SKUS and created finished order 1980 labeled FO-5 with two corresponding SKU items; and OA1C3 corresponds to batch window 1911 order O-9 with three SKU identifiers SKU1, SKU3 and SKU6 and created finished order 1980 labeled FO-9 with three corresponding SKU items. As an example, tote 1941 labeled T-B001 is sent to aisle 1040 labeled AISLE0 to single pick SKUS, multi-pick SKU1, multi-pick SKU2 and multi-pick SKU3; tote 1941 labeled T-B011 is sent to aisle 1040 labeled AISLE1 to single-pick SKU6 and perhaps other SKU items.

Still referring to FIG. 19, in some embodiments, each tote 1951 of the respective batches 1941 is associated with a single one of the aisles 1041 of an FCA system 1002 (see FIG. 10B) in a fulfillment center warehouse. In some embodiments, the plurality of totes 1950 for a particular aisle 1040 include whichever tote(s) all of the plurality of batches 1940 are assigned to that aisle. For example, aisle 1040 labeled AISLE0 would have one or more totes from a plurality of batches, such as totes 1030/1951 labeled T-B001, T-B002 from batch B0, tote 1030/1951 labeled T-B102 from batch B1, tote 1030/1951 labeled T-B201 from batch B2, tote 1030/1951 labeled T-B601 from batch B6, and tote 1030/1951 labeled T-BmA1 from batch B-m. A particular tote 1030/1951 of a respective batch 1941 is delivered in a sequence determined by batch-optimization software 1991 and controlled by a respective sequencer 1942 for the respective aisle 1041, wherein the respective sequencer 1942 delivers the sequence of totes 1951 to the respective picker 1943/1021 for that respective aisle 1041 just in time for the picker (who is located at a specific pick window defined at a specified vertical and horizontal location at those bins 1027 located across pick face 1028 of bin shelves 1020 along the side of aisle 1041 that can be reached by picker 1021 (e.g., in some embodiments, a human picker) who is supported on pick platform 1022 that is moved horizontally and vertically by mobile picker platform mechanism 1023) to perform the multi-picks and chain-picks for each sequentially delivered tote 1951 while the mobile picker platform mechanism 1023 is stationary at the single pick-window location (or, in some embodiments, gradually moving across the bins of a moving pick-window). In some embodiments, the partially filled totes (and possibly filled totes), once done at a particular pick window, are moved from the picker 1021 to a respective tote-storage device 1944 (e.g., ASRS 1026 of FIG. 10B) that is used by the respective sequencer 1942 to temporarily hold the totes that are often eventually “resequenced” to be again delivered to the picker 1021 at a later pick window when the pick platform has been moved to the new horizontal and vertical location of that later pick window.

Once some or all of the totes 1950 of a particular batch window 1910 are complete (all of the pick items for that tote have been picked), those totes are delivered under control of computer 1990 to a respective one of a plurality of order aggregators 1960 (e.g., OA0, OA1, . . . , OApp). For example, in some embodiments, all of the totes from ST0 in AISLE0 are moved (as shown by dashed line 1965) to respective bin wall/order aggregator 1961 labeled OA0, all of the totes in AISLE1 are moved (as shown by dash-dot-dashed line 1966) to respective bin wall/order segregator 1961 labeled OA0, and all of the totes in AISLEnn are moved (as shown by dash-dot-dot-dashed line 1967) to respective bin wall/order aggregator 1961 labeled OA0. In some other embodiments, some of the totes from ST0 in AISLE0 are moved (as shown by dashed line 1968) to a second respective bin wall/order aggregator 1961 labeled OA1, some of the totes in AISLE1 are moved (as shown by a dash-dot-dashed line (not labeled)) to respective bin wall/order aggregator 1961 labeled OA1, and some of the totes in AISLE-nn are moved (as shown by dash-dot-dot-dashed line 1969) to respective bin wall/order aggregator 1961 labeled OA1, in order that a plurality of order-aggregator operators at the plurality of order-aggregator structures 1960 operate in parallel (i.e., at the same time) to load the plurality of order-aggregator containers 1070 in a shorter time period than if only a single order-segregator operator were performing the task.

Once the totes from the plurality of aisles have been moved to their respective bin wall/order segregator 1961, an order-aggregator operator (e.g., in some embodiments, a human person not shown here) moves all of the SKU items from the totes to a respective one of a plurality of order-aggregator containers 1970 (e.g., the individual order-aggregator containers 1971 labeled OA1C0, OA1C1, . . . , OA1Cnn for order-aggregator structure OA0, and individual order-aggregator containers 1971 labeled OA2C0, OA2C1, . . . OA2Cnn for order-aggregator structure OA1), wherein once all of the SKU items for each respective order 1920 are moved to the respective order-aggregator container 1971, the contents of the respective order-aggregator container 1971 form (and/or are transferred to a suitable shipping container such as a corrugated cardboard box with a shipping label) of the respective finished order of a plurality of finished orders 1980.

In some embodiments of the system, the fulfillment center includes: a first plurality of aisles, wherein each aisle of the plurality of aisles extends between two pick faces, wherein each of the two pick faces extends vertically and horizontally to present a plurality of bins in each of a plurality of pick windows each defines as having those bins that are reachable by a picker at a fixed horizontal and vertical location; a plurality of mobile pick vehicles, each respective mobile pick vehicle of the plurality of mobile pick vehicles being associated with a respective aisle of the plurality of aisles, wherein each respective mobile pick vehicle of the plurality of mobile pick vehicles moves its respective picker to a sequence of horizontal and vertical locations along the respective aisle of the plurality of aisles, wherein each horizontal and vertical location is selected to allow the respective picker to pick SKU items associated with one pick window of the plurality of pick windows; a plurality of tote storage devices, wherein each respective tote storage device each holds a plurality of totes for its respective mobile pick vehicle of the plurality of mobile pick vehicles; a plurality of tote sequencers, wherein each respective tote sequencer of the plurality of tote sequencers sequentially sends a sequence of totes to its respective mobile pick vehicle of the plurality of mobile pick vehicles; and an order-aggregation structure that receives totes of each respective batch of the first plurality of batches, wherein the order-aggregation structure includes a plurality of order-aggregation compartments (OACs), wherein an operator at the order-aggregation structure moves items from the totes of each respective batch of the first plurality of batches to respective ones of the plurality of order-aggregation compartments such that all items moved into one of the plurality of order-aggregation compartments are associated with an individual order of the first plurality of orders.

In some embodiments of the system of the multi-shuttle type, the fulfillment center includes: a first plurality of shuttles, wherein each shuttle of the plurality of shuttles retrieves SKU items from Shelving Units and presents the retrieved SKU items to a respective picker of a plurality of pickers, wherein the picker moves the retrieved SKU items from respective ones of the first plurality of shuttles to selected ones of the plurality of totes; a plurality of tote storage devices, wherein each respective tote storage device each holds a plurality of totes for its respective picker of the plurality of pickers; and an order-aggregation structure that receives totes from the plurality of tote storage devices for each respective batch of the first plurality of batches, wherein the order-aggregation structure includes a plurality of order-aggregation compartments, wherein an operator at the order-aggregation structure moves items from the totes to the plurality of order-aggregation compartments such that all items moved into one of the plurality of order-aggregation compartments are associated with an individual order of the first plurality of orders.

In some embodiments of the system, the fulfillment center includes: a first plurality of Kiva-type robots, wherein each shuttle of the plurality of Kiva-type robots retrieves bins of SKU items and presents the retrieved bins of SKU items to a respective picker of a plurality of pickers, wherein the picker moves the retrieved bins of SKU items from respective ones of the first plurality of Kiva-type robots to selected ones of the plurality of totes; a plurality of tote storage devices, wherein each respective tote storage device each holds a plurality of totes for its respective picker of the plurality of pickers; and an order-aggregation structure that receives totes from the plurality of tote storage devices for each respective batch of the first plurality of batches, wherein the order-aggregation structure includes a plurality of order-aggregation compartments, wherein an operator at the order-aggregation structure moves items from the totes to the plurality of order-aggregation compartments such that all items moved into one of the plurality of order-aggregation compartments are associated with an individual order of the first plurality of orders.

In some embodiments of the system, the fulfillment center includes: an order-aggregation structure that receives totes for each respective batch of the first plurality of batches, wherein the order-aggregation structure includes a plurality of order-aggregation compartments, wherein an operator at the order-aggregation structure moves items from the totes to the plurality of order-aggregation compartments such that all items moved into one of the plurality of order-aggregation compartments are associated with an individual order of the first plurality of orders.

In some embodiments of the system, the batch-optimization algorithm uses a closed-form algorithm solution performed with procedural programming.

In some embodiments of the system, the batch-optimization algorithm uses a closed-form algorithm solution performed with object-oriented programming (OOP).

In some embodiments of the system, the batch-optimization algorithm uses a combinatorial optimization algorithm.

In some embodiments of the system, the batch-optimization algorithm uses picker-performance adaptability, in which the batch optimization algorithm modifies an amount of order load to any one picker in an aisle to accommodate the picker's personal pick performance and thus optimize overall performance of all pickers in the fulfillment center.

In some embodiments of the system, the batch-optimization algorithm uses programmable capacity in which the batch optimization algorithm changes a duration of each batch window to further increase the pick performance and easily adapt to varying order loads in the fulfillment center.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

1. A system for fulfillment of a first plurality of orders at a fulfillment center having a plurality of bins arranged along an aisle, wherein each of the plurality of bins holds a plurality of goods, wherein goods specified for each of the first plurality of orders are picked from their respective bins along the aisle by a picker on a picker platform and placed into selected ones of a selected sequence of totes, wherein the goods are selectively picked from selected ones of the plurality of bins along the aisle, wherein the first plurality of orders is received from a plurality of customers, wherein each one of the first plurality of orders includes a plurality of stock-keeping unit (SKU) identifiers, and wherein the system comprises:
a computer system operatively coupled to move the picker platform to a sequence of picker locations next to the plurality of bins along the aisle, and to control equipment operated automatically transport the selected sequence of totes into which the goods are placed after being picked,
wherein the goods are identified by respective SKU identifiers, and that has software that executes on the computer system,
wherein the software uses a batch-optimization algorithm that associates each respective one of the first plurality of orders to a respective batch of a first plurality of batches and associates each SKU identifier of the respective orders' plurality of SKU identifiers to a respective tote of the plurality of totes associated with the respective batch in order to maximize occurrences of two types of events, wherein the two types of events are:
a multi-pick type of event wherein a plurality of SKU items specified by different orders but having equivalent SKU identifiers are picked at one time, and
a chain-pick type of event wherein plurality of SKU items having different SKU identifiers, and all located within reach in a common pick window are picked consecutively and placed in a single tote,
wherein the computer system selects sequences of goods picking to enhance numbers of the multi-pick type of event and the chain-pick type of event in order to provide a maximized pick performance, and
wherein pick performance is defined as a number of picks per unit of time in a sequential series of picks performed.

2. The system of claim 1, wherein the batch-optimization algorithm further controls movement of the plurality of totes of each respective batch of the first plurality of batches to a first order-aggregation operator and presenting information to the first order-aggregation operator to move picked items from the plurality of totes of the respective batch to respective order-aggregation compartments of a plurality of order-aggregation compartments of an order-aggregation structure, wherein all items moved into one of the plurality of order-aggregation compartments are associated with an individual order of the first plurality of orders.

3. The system of claim 1, wherein the fulfillment center includes:
a first plurality of aisles, wherein each aisle of the plurality of aisles extends between two pick faces, wherein each of the two pick faces extends vertically and horizontally to present a plurality of bins in each of a plurality of pick windows each defines as having those bins that are reachable by a picker at a fixed horizontal and vertical location;
a plurality of mobile pick vehicles, each respective mobile pick vehicle of the plurality of mobile pick vehicles being associated with a respective aisle of the plurality of aisles, wherein each respective mobile pick vehicle of the plurality of mobile pick vehicles moves its respective picker to a sequence of horizontal and vertical locations along the respective aisle of the plurality of aisles, wherein each horizontal and vertical location is selected to allow the respective picker to pick SKU items associated with one pick window of the plurality of pick windows;
a plurality of tote storage devices, wherein each respective tote storage device each holds a plurality of totes for its respective mobile pick vehicle of the plurality of mobile pick vehicles;
a plurality of tote sequencers, wherein each respective tote sequencer of the plurality of tote sequencers sequentially sends a sequence of totes to its respective mobile pick vehicle of the plurality of mobile pick vehicles; and
an order-aggregation structure that receives totes of each respective batch of the first plurality of batches, wherein the order-aggregation structure includes a plurality of order-aggregation compartments, wherein an operator at the order-aggregation structure moves items from the totes of each respective batch of the first plurality of batches to respective ones of the plurality of order-aggregation compartments such that all items moved into one of the plurality of order-aggregation compartments are associated with an individual order of the first plurality of orders.

4. The system of claim 1, wherein the fulfillment center includes:
a bin wall that receives a plurality of totes, wherein each of the plurality of totes has SKU items from a plurality of orders, and wherein each of the plurality of orders indicates to a picker which SKU items go to which shipping container for individual customers;
a first plurality of shuttles, wherein each shuttle of the plurality of shuttles retrieves SKU items from Shelving Units and presents the retrieved SKU items to a respective picker of a plurality of pickers, wherein the picker moves the retrieved SKU items from respective ones of the first plurality of shuttles to selected ones of the plurality of totes;
a plurality of tote storage devices, wherein each respective tote storage device each holds a plurality of totes for its respective picker of a plurality of pickers; and
an order-aggregation structure that receives totes from the plurality of tote storage devices for each respective batch of the first plurality of batches, wherein the order-aggregation structure includes a plurality of order-aggregation compartments, wherein an operator at the order-aggregation structure moves items from the totes to the plurality of order-aggregation compartments such that all items moved into one of the plurality of order-aggregation compartments are associated with an individual order of the first plurality of orders.

5. The system of claim 1, wherein the fulfillment center includes:
a bin wall that receives a plurality of totes, wherein each of the plurality of totes has SKU items from a plurality of orders, and wherein each of the plurality of orders indicates to a picker which SKU items go to which shipping container for individual customers;
a first plurality of Kiva-type robots, wherein each shuttle of the plurality of Kiva-type robots retrieves bins of SKU items and presents the retrieved bins of SKU items to a respective picker of a plurality of pickers, wherein the picker moves the retrieved bins of SKU items from respective ones of the first plurality of Kiva-type robots to selected ones of the plurality of totes;
a plurality of tote storage devices, wherein each respective tote storage device holds a plurality of totes for its respective picker of a plurality of pickers; and
an order-aggregation structure that receives totes from the plurality of tote storage devices for each respective batch of the first plurality of batches, wherein the order-aggregation structure includes a plurality of order-aggregation compartments, wherein an operator at the order-aggregation structure moves items from the totes to the plurality of order-aggregation compartments such that all items moved into one of the plurality of order-aggregation compartments are associated with an individual order of the first plurality of orders.

6. The system claim 1, wherein the fulfillment center includes:
an order-aggregation structure that receives totes for each respective batch of the first plurality of batches, wherein the order-aggregation structure includes a plurality of order-aggregation compartments, wherein an operator at the order-aggregation structure moves items from the totes to the plurality of order-aggregation compartments such that all items moved into one of the plurality of order-aggregation compartments are associated with an individual order of the first plurality of orders.

7-10. (canceled)

11. The system of claim 1, further comprising:
a receiver that receives a first plurality of commercial orders and stores the first plurality of commercial orders to the computer system, wherein each respective order of the plurality of commercial orders specifies one or more pick items to be picked for that respective commercial order,
a batch aggregator that organizes the first plurality of commercial orders into a first plurality of batch windows, wherein the batch aggregator initially associates a first subset of the first plurality of batch windows with a first aisle of a warehouse, wherein each respective batch window of the first plurality of batch windows is associated with a plurality of tote identifiers, and wherein each respective tote identifiers corresponds to a tote into which pick items are to be placed,
a path optimizer that generates an ordered sequence of pick-operation specifications associated with each batch window of the first subset of the first plurality of batch windows that is associated with the first aisle in order to optimize a throughput of commercial orders during each of a plurality of sequential time periods, and
a tote sequencer that generates an ordered sequence of tote identifiers corresponding to the sequence of pick-operation specifications associated with each batch window of the first plurality of batch windows that is associated with the first aisle.

12. The apparatus of claim 11, further comprising:
a bin wall that receives a plurality of totes, wherein each of the plurality of totes has SKU items from a plurality of orders, and wherein each of the plurality of orders indicates to a picker which SKU items go to which shipping container for individual customers;
a fulfillment center automation type automated warehouse system;
a plurality of tote storage devices, wherein each respective tote storage device each holds a plurality of totes for its respective picker of a plurality of pickers;
a first mobile picker platform operatively coupled to the computer system, wherein the computer system controls the first mobile picker platform to move a first picker to a sequence of pick locations along the first aisle of the warehouse according to the sequence of pick-operation specifications associated with each respective batch window of the first subset of the first plurality of batch windows; and
a first tote-delivery system that delivers a first sequence of totes to the mobile picker platform in the first aisle of the warehouse according to the ordered sequence of tote identifiers associated with each respective batch window of the first subset of the first plurality of batch windows.

13. The apparatus of claim 11,
wherein the batch aggregator initially associates a second subset of the first plurality of batch windows with a second aisle of the warehouse,
wherein the path optimizer generates an ordered sequence of pick-operation specifications associated with each batch window of the second subset of the first plurality of batch windows, and
wherein the tote sequencer generates an ordered sequence of tote identifiers corresponding to the sequence of pick-operation specifications associated with each batch window of the second plurality of batch windows that is associated with the second aisle
the apparatus further comprising:
a first mobile picker platform operatively coupled to the computer system, wherein the computer system controls the first mobile picker platform to move a first picker to a sequence of pick locations along the first aisle of the warehouse according to the sequence of pick-operation specifications associated with each respective batch window of the first subset of the first plurality of batch windows; and
a first tote-delivery system that delivers a first sequence of totes to the first mobile picker platform in the first aisle of the warehouse according to the ordered sequence of tote identifier associated with each respective batch window of the first subset of the first plurality of batch windows;
a second mobile picker platform operatively coupled to the computer system, wherein the computer system controls the second mobile picker platform to that moves a second picker to a sequence of pick locations along the second aisle of the warehouse according to the second ordered sequence of pick-operation specifications associated with each respective batch window of the second subset of the first plurality of batch windows; and
a second tote-delivery system that delivers a second sequence of totes to the second mobile picker platform in the second aisle of the warehouse according to the second ordered sequence of tote identifiers associated with each respective batch window of the second subset of the first plurality of batch windows.

14. The apparatus of claim 11, wherein the batch aggregator initially associates a second subset of the first plurality of batch windows with a second aisle of a warehouse, wherein the computer system tracks performance of a first picker in the first aisle and tracks performance of a second picker in the second aisle, and based on the tracked performance of the first picker in the first aisle, automatically shifts some of the first plurality of batch windows initially associated with the first aisle to instead be associated with the second aisle, wherein a plurality of items having the same SKU identifier are stocked in both the first aisle and in the second aisle.

15-20. (canceled)

21. The method of claim 41, further comprising:
receiving, into the computer system, a first plurality of commercial orders, wherein each respective commercial order of the plurality of commercial orders specifies one or more pick items to be picked for that respective commercial order;
storing the first plurality of commercial orders to a storage system of the computer system;
organizing, in the computer system, the first plurality of commercial orders into a first plurality of batch windows, wherein a first subset of the first plurality of batch windows are associated with a first aisle of a warehouse;
generating, in the computer system, an ordered sequence of pick-operation specifications associated with each batch window of the first plurality of batch windows that is associated with the first aisle in order to optimize a throughput of commercial orders during each of a plurality of sequential time periods;
generating, in the computer system, an ordered sequence of tote identifiers corresponding to the sequence of pick-operation specifications associated with each batch window of the first plurality of batch windows that is associated with the first aisle;
moving a first mobile picker platform that supports a first human picker to a sequence of pick locations according to the sequence of pick-operation specifications associated with each respective batch window of the first subset of the first plurality of batch windows; and
delivering a first sequence of totes to the first mobile picker platform according to the ordered sequence of tote identifiers associated with each respective batch window of the first subset of the first plurality of batch windows.

22. The method of claim 21, further comprising:
under control of the computer system, moving a first mobile picker platform that supports a first picker to a sequence of pick locations according to the sequence of pick-operation specifications associated with each respective batch window of the first subset of the first plurality of batch windows; and
under control of the computer system, delivering a first sequence of totes to the first mobile picker platform according to the ordered sequence of tote identifiers associated with each respective batch window of the first subset of the first plurality of batch windows.

23-40. (canceled)

41. A method for fulfillment operatively coupled to control equipment operated automatically to transport totes into which goods are placed after being picked, wherein the goods are identified by respective SKU identifiers of a first plurality of orders at a fulfillment center, wherein the first plurality of orders is received from a plurality of customers, wherein each one of the first plurality of orders includes a plurality of stock-keeping unit (SKU) identifiers, and wherein the method comprises:
receiving, into a computer system, a first plurality of commercial orders during a first batch-window period of time, wherein each respective order of the first plurality of commercial orders specifies one or more pick items to be picked for that respective commercial order;
storing the first plurality of commercial orders to a storage system of the computer system;
organizing, in the computer system, the first plurality of commercial orders into a first plurality of batches, wherein a first subset of the first plurality of batches are associated with a first aisle of a warehouse;
performing, on a computer system, a batch-optimization algorithm that assigns/associates each respective one of the first plurality of orders to a respective batch of a first plurality of batches and assigns/associates each SKU identifier of the respective orders' plurality of SKU identifiers to a respective tote of a plurality of totes associated with the respective batch in order to maximize occurrences of two types of events, wherein the two types of events are:
a multi-pick type of event wherein a plurality of SKU items specified by different orders but having equivalent SKU identifiers are picked at one time, and
a chain-pick type of event wherein plurality of SKU items having different SKU identifiers, and all located within reach in a common pick window are picked consecutively and placed in a single tote,
wherein the multi-pick type of event and the chain-pick type of event are both selected in order to provide a maximized pick performance, and wherein pick performance is defined as a number of picks per unit of time in a sequential series of picks performed.

42. The method of claim 41, wherein the method further comprises:
controlling movement of the plurality of totes of each respective batch of the first plurality of batches to a first order-aggregation operator; and
presenting information to the first order-aggregation operator to move picked items from the plurality of totes of the respective batch to respective order-aggregation compartments of a plurality of order-aggregation compartments of an order-aggregation structure, wherein all items moved into one of the plurality of order-aggregation compartments are associated with an individual order of the first plurality of orders.

43. The method of claim 41, wherein the fulfillment center includes a first plurality of aisles, wherein each aisle of the plurality of aisles extends between two pick faces, wherein each of the two pick faces extends vertically and horizontally to present a plurality of bins in each of a plurality of pick windows each defines as having those bins that are reachable by a picker at a fixed horizontal and vertical location, wherein the fulfillment center further includes a plurality of mobile pick vehicles, each respective mobile pick vehicle of the plurality of mobile pick vehicles being associated with a respective aisle of the plurality of aisles, wherein the method further comprises:
controlling, with the computer system, each respective mobile pick vehicle of the plurality of mobile pick vehicles to move its respective picker to a sequence of horizontal and vertical locations along the respective aisle of the plurality of aisles, wherein each horizontal and vertical location is selected to allow the respective picker to pick SKU items associated with one pick window of the plurality of pick windows;
controlling, with the computer system, movement of a sequence of totes from a respective tote-storage device of a plurality of tote-storage device to each respective mobile pick vehicle of the plurality of mobile pick vehicles, wherein each respective tote storage device each holds a plurality of totes for its respective mobile pick vehicle of the plurality of mobile pick vehicles;
controlling, with the computer system, a plurality of tote sequencers to each sequentially send a sequence of totes to its respective mobile pick vehicle of the plurality of mobile pick vehicles; and
sending order-aggregation instructions to an operator at an order-aggregation structure that receives totes of each respective batch of the first plurality of batches, wherein the order-aggregation structure includes a plurality of order-aggregation compartments, wherein the operator at the order-aggregation structure, based on the order-aggregation instructions, moves items from the totes of each respective batch of the first plurality of batches to respective ones of the plurality of order-aggregation compartments such that all items moved into one of the plurality of order-aggregation compartments are associated with an individual order of the first plurality of orders.

44-50. (canceled)

51. A computer-readable medium operatively coupled to control equipment operated automatically to transport totes into which goods are picked, wherein the goods are identified by respective SKU identifiers having instructions stored thereon for causing a suitably programmed computer to perform a method for fulfillment of a first plurality of orders at a fulfillment center, wherein the first plurality of orders is received from a plurality of customers, wherein each one of the first plurality of orders includes a plurality of stock-keeping unit (SKU) identifiers, and wherein the method comprises:
receiving, into a computer system, a first plurality of commercial orders during a first batch-window period of time, wherein each respective order of the first plurality of commercial orders specifies one or more pick items to be picked for that respective commercial order;
storing the first plurality of commercial orders to a storage system of the computer system;
organizing, in the computer system, the first plurality of commercial orders into a first plurality of batches, wherein a first subset of the first plurality of batches are associated with a first aisle of a warehouse;
performing, on a computer system, a batch-optimization algorithm that assigns/associates each respective one of the first plurality of orders to a respective batch of a first plurality of batches and assigns/associates each SKU identifier of the respective orders' plurality of SKU identifiers to a respective tote of a plurality of totes associated with the respective batch in order to maximize occurrences of two types of events, wherein the two types of events are:
a multi-pick type of event wherein a plurality of SKU items specified by different orders but having equivalent SKU identifiers are picked at one time, and
a chain-pick type of event wherein plurality of SKU items having different SKU identifiers, and all located within reach in a common pick window are picked consecutively and placed in a single tote,
wherein the multi-pick type of event and the chain-pick type of event are both selected in order to provide a maximized pick performance, and wherein pick performance is defined as a number of picks per unit of time in a sequential series of picks performed.

52. The computer-readable medium of claim 51, having further instructions such that the method further comprises:
controlling movement of the plurality of totes of each respective batch of the first plurality of batches to a first order-aggregation operator; and
presenting information to the first order-aggregation operator to move picked items from the plurality of totes of the respective batch to respective order-aggregation compartments of a plurality of order-aggregation compartments of an order-aggregation structure, wherein all items moved into one of the plurality of order-aggregation compartments are associated with an individual order of the first plurality of orders.

53. The computer-readable medium of claim 51, wherein the fulfillment center includes a first plurality of aisles, wherein each aisle of the plurality of aisles extends between two pick faces, wherein each of the two pick faces extends vertically and horizontally to present a plurality of bins in each of a plurality of pick windows each defines as having those bins that are reachable by a picker at a fixed horizontal and vertical location, wherein the fulfillment center further includes a plurality of mobile pick vehicles, each respective mobile pick vehicle of the plurality of mobile pick vehicles being associated with a respective aisle of the plurality of aisles, wherein the computer-readable medium further includes instructions such that the method further comprises:
controlling, with the computer system, each respective mobile pick vehicle of the plurality of mobile pick vehicles to move its respective picker to a sequence of horizontal and vertical locations along the respective aisle of the plurality of aisles, wherein each horizontal and vertical location is selected to allow the respective picker to pick SKU items associated with one pick window of the plurality of pick windows;
controlling, with the computer system, movement of a sequence of totes from a respective tote-storage device of a plurality of tote-storage device to each respective mobile pick vehicle of the plurality of mobile pick vehicles, wherein each respective tote storage device each holds a plurality of totes for its respective mobile pick vehicle of the plurality of mobile pick vehicles;
controlling, with the computer system, a plurality of tote sequencers to each sequentially send a sequence of totes to its respective mobile pick vehicle of the plurality of mobile pick vehicles; and
sending order-aggregation instructions to an operator at an order-aggregation structure that receives totes of each respective batch of the first plurality of batches, wherein the order-aggregation structure includes a plurality of order-aggregation compartments, wherein the operator at the order-aggregation structure, based on the order-aggregation instructions, moves items from the totes of each respective batch of the first plurality of batches to respective ones of the plurality of order-aggregation compartments such that all items moved into one of the plurality of order-aggregation compartments are associated with an individual order of the first plurality of orders.

54. The computer-readable medium of claim 51, wherein the fulfillment center includes a first plurality of shuttles, wherein each shuttle of the plurality of shuttles retrieves SKU items and presents the retrieved SKU items to a respective tote loader of a plurality of tote loaders, wherein the tote loader moves the retrieved SKU items from respective ones of the first plurality of shuttles to selected ones of the plurality of totes, wherein the fulfillment center further includes a plurality of tote storage devices, wherein each respective tote storage device each holds a plurality of totes for its respective tote loader of the plurality of tote loaders, wherein the computer-readable medium further includes instructions such that the method further comprises:
sending order-aggregation instructions to an operator at an order-aggregation structure that receives totes of each respective batch of the first plurality of batches, wherein the order-aggregation structure includes a plurality of order-aggregation compartments, wherein the operator at the order-aggregation structure, based on the order-aggregation instructions, moves items from the totes of each respective batch of the first plurality of batches to respective ones of the plurality of order-aggregation compartments such that all items moved into one of the plurality of order-aggregation compartments are associated with an individual order of the first plurality of orders.

55. The computer-readable medium of claim 51, wherein the fulfillment center includes
a first plurality of Kiva-type robots, wherein each shuttle of the plurality of Kiva-type robots retrieves bins of SKU items and presents the retrieved bins of SKU items to a respective picker of a plurality of pickers, wherein the picker moves the retrieved bins of SKU items from respective ones of the first plurality of Kiva-type robots to selected ones of the plurality of totes, wherein the fulfillment center further includes a plurality of tote storage devices, wherein each respective tote storage device holds a plurality of totes for its respective picker of the plurality of pickers, wherein the computer-readable medium further includes instructions such that the method further comprises:
sending order-aggregation instructions to an operator at an order-aggregation structure that receives totes of each respective batch of the first plurality of batches, wherein the order-aggregation structure includes a plurality of order-aggregation compartments, wherein the operator at the order-aggregation structure, based on the order-aggregation instructions, moves items from the totes of each respective batch of the first plurality of batches to respective ones of the plurality of order-aggregation compartments such that all items moved into one of the plurality of order-aggregation compartments are associated with an individual order of the first plurality of orders.

56-75. (canceled)
